(19) United States
(12) Patent Application Publication
(10) Pub. No.: US 2020/0234380 A1
(43) Pub. Date: Jul. 23, 2020

(54) SYSTEM AND METHOD FOR SMART COMMUNITY

(71) Applicant: Shriniwas Dulori, Cumming, GA (US)

(72) Inventor: Shriniwas Dulori, Cumming, GA (US)

(21) Appl. No.: 16/745,394

(22) Filed: Jan. 17, 2020

Related U.S. Application Data
(60) Provisional application No. 62/793,465, filed on Jan. 17, 2019.

(51) Int. Cl. G06Q 40/08; G06Q 30/02

(52) U.S. Cl. CPC G06Q 40/08; G06Q 30/0283

(57) ABSTRACT

A smart community system designed for a locally based businesses, purchasers, and customers wherein a social media platform is provided that accessible by the users to encourage various connections in the community providing a broad range of applications and services that allow users the ability to share and receive information, often customized to the interests of the needs of the particular user.

### CROSS REFERENCE TO RELATED APPLICATIONS

This application is a non-provisional application which claims priority to U.S. Provisional Application No. 62/793,465 filed on Jan. 17, 2019, which is incorporated by reference in its entirety.

### FIELD OF DISCLOSURE

The overall field of this invention relates generally to the technical fields of communications, social-networking, electronic commerce, real estate transactions, monetization, medical assistance, security and privacy protection. More particularly, the present invention relates to a geo-spatial smart community system allowing users to communicate information with other users whether the users be service providers, companies, homeowners associations, doctors, or emergency personnel whereby the geo-spatial smart community system receives, collects, and transmits data to provide a more ubiquitous and configurable service for a plurality of industries to improve the overall well-being of the various users.

### BACKGROUND

People now more than ever are connected to each other. Over the past centuries humans went from living in remote areas, only interacting with other families or groups intermittently have now formed geographically based communities, living closer together and communicating with one another at a rapid pace. People not only intermingle with others in their geographically based community but also reach out to families, friends, or completely random strangers scattered across the planet through phone calls, message boards, social media, video chat, and texting. This phenomenon has formed multiple communities of people with common interests, activities, occupations and personalities but these comminutes can also diverse, complex and occasionally hard to define. Studies have shown some people even feel more connected to online communities with random strangers than to their local neighborhood. Today's technologically advanced world is altering the role that communities play in everyday people's lives, as well as the roles they play within them.

Currently there are multiple social networking applications for people to interact with different communities using their mobile devices or computers. However, these applications do not solve the problem of having a truly connected social networking system people that provides a way for individuals and businesses to cooperate to achieve common goals or obtain mutually beneficial relationships in an easy and accessible manner. Thus, there still exists a great need for an improved process and system for a smart community.

### SUMMARY

The disclosure presented herein relates to a smart community system comprising, one or more databases coupled via a network, one or more processors coupled to the one or more databases and at least one computing device coupled to the one or more processors and the one or more databases via the network, wherein the one or more processors are configured to, store a plurality of selectable components, each of the selectable components having one or more associated entities defining attributes of the selectable components and one or more values associated with the one or more entities, display to a user a first set of potentially selectable components through a user interface, receive one or more individual selections of the components from the first set by the user to include in a coverage plan, calculate a value of the coverage plan from the one or more values associated with the selectable components selected by the user, calculate a price of the one or more entities with the coverage plan; present a coverage policy to the user based on the entity and the coverage plan, associate the selectable components with one or more monitoring agents, the one or more monitoring agents assigned to monitor the one or more entities based on the coverage plan selected by the user, associate one or more service providers with the one or more monitoring agents to provide services to the user based on the coverage plan of the user, generate a hierarchical payment system between the one or more service providers with the one or more monitoring agents to provide services based on individual subtasks provided by the one or more service providers for a specific task for the coverage plan of the user, transmit a commission to the one or more monitoring agents for the combined income generated from the individual subtasks, generating a rating system for the one or more monitoring agents to provide a rating the one or more service providers associated with the one or more monitoring agents, the rating presented to the user when selecting the one or more service providers for a service request, generate a private marketplace with a first channel, the first channel supporting the one or more service providers associated with the one or more monitoring agents wherein there are preexisting established guarantees between the one or more monitoring agents and the one or more service providers; present the one or more service providers associated with the one or more monitoring agents to the user, generate a second channel in the private marketplace, the second channel associated with one or more users who do not have a coverage plan, the second channel supporting one or more service providers and soliciting bids of any of the one or more service providers with a predetermined maximum distance of the one or more users who do not have a coverage plan, wherein the private marketplace follows a protocol for communication between the supply-side and demand-side platforms for matching bid requests and bid responses on the first and the second channel in order to connect user with a subset of the one or more service providers for a service request, wherein the processors are further configured to, receive information pertaining to a service request of the user inputted by a service provider associated with monitoring agent, the service provider providing service to the user in response to the service request, present received information to one or more other service providers associated with the monitoring agent, the one or more other service providers providing service to the user in relation to the service request, generate a points based system, wherein a point is associated with the account of a first service provider in response to information posted to a second service provider, generate an identification code to the user and the one or more service providers selected for rendering service to the user wherein the user and the one or more service providers authenticate one another through the validation of the identification code, the identification code presented only when the one or more service providers have been selected to provide service to the user, the identification code unchangeable unless manually altered through email by the user or by one or more designated guardians selected by the user, integrate the identification code into a third party platform utilized by the one or more service providers, generate a backing payment system, the backing payment system supporting one or more backers wherein there are established guarantees between the one or more service providers and the one or more backers, the one or more backers receiving commission for providing access to a geographic location where the one or more service providers operate, create a cluster of the one or more entities of one or more users based on the location of the one or more entities of the one or more users, direct goods delivered by the one or more service providers to a single property of a user within a predetermined distance of the one or more entities of one or more users; reduce the price of the goods delivered by the one or more service providers for the one or more users, wherein the location of the single property receiving the goods is determined by a property closest to the average coordinates of the one or more entities of the one or more users in the cluster, wherein the processors are further configured to, retrieve data for the specific geographic area, the data comprising a plurality of entries each for the one or more entities located in the specific geographic area that are listed for sale each entry indicating the price for the one or more entities, and values for each of a plurality of attributes, receive attributes of a plurality of entities in the specific geographic area, generate a score for the specific geographic area at least in part by the values for each of the plurality of attributes, adjust score if the one or more entities had a previous owner purchase a coverage plan through smart community system with the property, present determined score for the specific property in the geographic area to be provided to the user to enable the user to make a determination regarding the property in the specific geographic area, adjust the score if the one or more entities previously had a coverage plan with an selectable component pertaining to an attribute the user has used in their search criteria, wherein the attributes include a commute score based on the estimated time to the work of the user based on traffic, child safety factor, the child safety factored determined by if the amount of vehicles passing over a point within a predetermined distance to the property passes a predetermined amount, the accommodations for religion, the direction windows of the real estate face, the distance from a retention pond, and the distance from one or more service providers associated with one or more monitoring agents, the one or more monitoring agents associated with the selectable components of the coverage plan of the user, wherein the processors are further configured to, receive, at least one communication indicating a first user as having referred a second user to a service provider, establish a referral commission for the referring second user to the service provider, transmit the referral commission to the first user, detect that a specific emergency situation has occurred based on input by the second user, determine if a service provider who has been recommended by the first user provides services for specific emergency situation, transmit communication, in response to the emergency situation, to a service provider who has been recommended by the first user, receive via the user interface, a picture or video of a monitoring area of the one or more entities from the user, verify, in response to the request from the user, that a monitoring agent is within the predetermined maximum allowable distance to be traveled by the monitoring agent providing services; if the monitoring agent is verified to be within the maximum allowable distance to be traveled by the monitoring agent for providing; present monitoring agent to user; if monitoring agent is not verified to be within maximum allowable distance to be traveled by the monitoring agent for providing the one or more services; add a monitoring restriction, wherein the monitoring restriction prohibits the monitoring agent from being presented to user, present a user interface to a first user on a computing device, wherein the user interface comprises at least one list of available monitoring agents, for the one or more areas, receive a request from the first user to accept a monitoring agent; in response to request from the first user, calculate an acceptable price values for characteristics of user based on data for existing customers in similar users, set the fixed price and predetermined coverages and coverage limits for the monitoring agents based on said data, the characteristics selected from a combination of two or more of: monitoring location classification, monitoring location size, monitoring location cost, use the received request, including the time period and one more services to transfer information causing a monitoring contract to be created, collect monitoring data, including a time period of the monitoring, a type of service of the monitoring, and price of service of the monitoring, store, by the monitoring system, the monitoring data, transfer income to the monitoring agent for service provided.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF DRAWINGS

The present invention will be described by way of exemplary embodiments, but not limitations, illustrated in the accompanying drawings in which like references denote similar elements, and in which:

FIG. 1 depicts a block diagram of the various subsystems of smart community system.

FIG. 2 is a block diagram depicting the components of smart community system.

FIG. 4 is a block diagram depicting the various users and computing devices.

FIG. 4 is a flow diagram depicting a method for parking services subsystem.

FIG. 5 is a flow diagram depicting a method for handyman services subsystem.

FIG. 6 is a flow diagram depicting a method for monitoring services subsystem.

FIG. 7 is a flow diagram depicting a method for appliance services subsystem.

FIG. 8 is a flow diagram depicting a method for employee booking subsystem.

FIG. 9 is an illustration of a map of the clusters for the group delivery system.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items,” may indicate the presence of only one item, or may indicate more items. Thus, the term “set” may be equivalent to “one or more” as used herein.

In the following detailed description, numerous specific details are set forth in order to provide a more thorough understanding of the one or more embodiments described herein. However, it will be apparent to one of ordinary skill in the art that the invention may be practiced without these specific details. In other instances, well-known features have not been described in detail to avoid unnecessarily complicating the description.

The present disclosure recognizes the unsolved need for an improved system and method for a smart community system. Particularly the disclosure is for a software application that may assist several kinds of people with interactions in a community whereby the users of the application may come use the application in all aspects of life, much similar to how mobile phones are in the present day. Using the application users may participate in polls, submit requests for approval, report violations, submit work orders, and communicate with other users, homeowners associations, and management while uploading documents and pictures relating to these services and undertakings.

Users may refer local businesses to other users and receive credit or other rewards within a point based system of the software application. Users may request various types of maintenance, goods, and other services from providers whereby the software application provides two-way verification for the person providing the service and the person receiving service to enhance precision and safety. Users may schedule appointments with one another using a booking system, the booking system designed for requesting job shifts in the users residence or at a remote location. Users may verify their well-being and safety as well as alert the authorities or emergency contacts through the software application or an integrated accessory connected over a network. Users may buy and sell homes, real estate, or property as well as have other users monitor the properties and receive appraisals. Users many track how funds they have donated or allocated are being used. Users may select not only which lab, pharmacy, or doctor they may use but also selects procedures and view price details from any medical team anywhere in the world. Users may also compensate other users with smart community system currency from their digital wallets thus minimizing overheard credit card costs for all parties involved in the transaction. There are also many more possible functions for the smart community system and ways users may interact with each other while using the application that will be discussed below using one or more embodiments described herein.

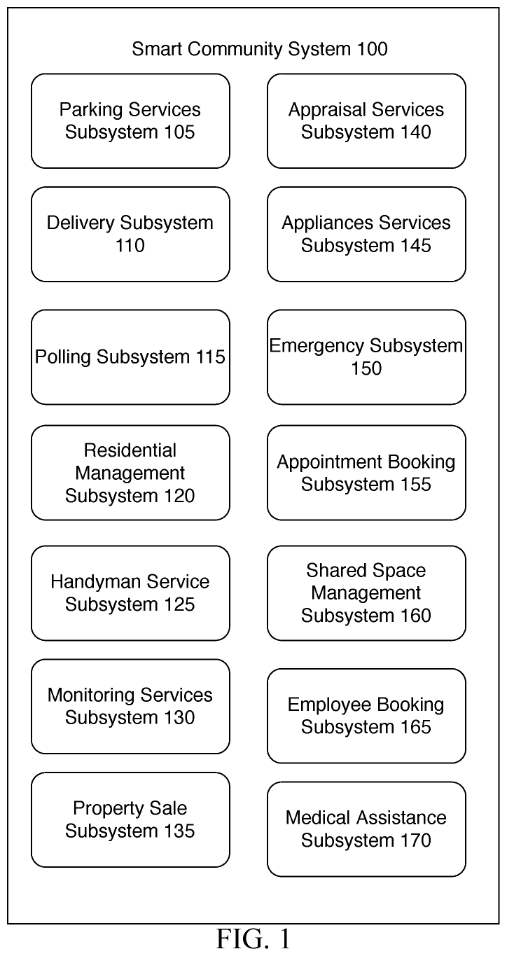

Turning to FIG. 1, FIG. 1 depicts a block diagram of an embodiment of the present invention for smart community system 100 and the main subsystems that make up smart community system 100. Smart community system 100 may include a plurality of different subsystems including a parking services subsystem such as parking services subsystem 105, a delivery subsystem such as delivery subsystem 110, a polling subsystem such as polling subsystem 115, a residential management subsystem such as residential management subsystem 120, a handyman service subsystem such as handyman service subsystem 125, a monitoring services subsystem such as monitoring services subsystem 130, a property sale subsystem such as property sale subsystem 135, an appraisal services subsystem such as appraisal services subsystem 140, an appliance services subsystem such as appliance services subsystem 145, an emergency subsystem such as emergency subsystem 150, an appointment booking subsystem such as appointment booking subsystem 155, a shared space management subsystem such as shared space management subsystem 160, an employee booking subsystem such as employee booking subsystem 165, and a medical assistance subsystem such as medical assistance subsystem 170, that may work in conjunction with each other as well as independently whereby together the different subsystems may improve the quality of life of the various users.

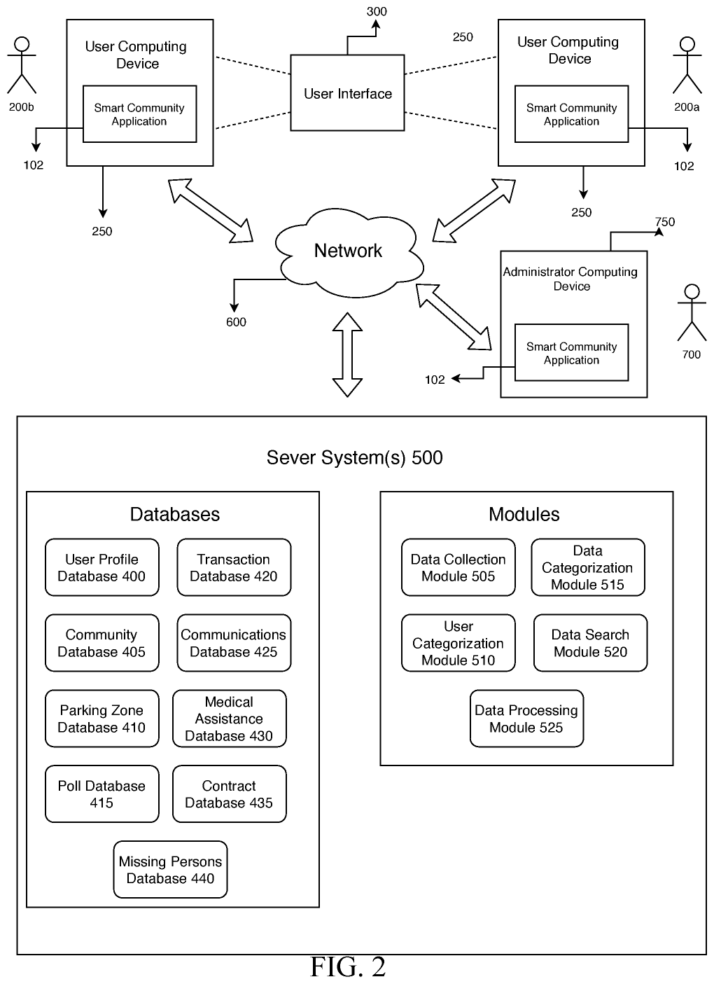

Turning to FIG. 2, FIG. 2 depicts a block diagram of an embodiment of the present invention for smart community system 100. Smart community system 100 may include a plurality of users, such as users 200. Further, users 200 may be located in various geographical locations that are either located apart or are located in proximity to one other. Information exchanged between users 200 (which may include, as illustrate din FIG. 3, users such as vehicle occupant user 201, parking zone provider user 202, valet user 203, driver user 204, property manager user 205, handyman user 206, service provider user 207, customer user 208, monitoring user 209, requesting user 210, manufacturer user 211, guardian user 213, emergency personnel user 214, employer user 215, employee user 216, doctor user 217, lab user 218, patient user 219, and monitoring agent user 220, which are all users 200 but have been place into different categories of users), may be processed by one or more user computing devices such as user computing devices 250 (which, as illustrated in FIG. 3 may include user computing devices such as vehicle occupant user computing device 251, parking zone provider user computing device 252, valet user computing device 253, driver user computing device 254, property manager user computing device 255, handyman user computing device 256, service provider user computing device 257, customer user computing device 258, monitoring user computing device 259, requesting user computing device 260, manufacturer user computing device 261, guardian user computing device 263, emergency personnel user computing device 264, employer user computing device 265, employee user computing device 266, doctor user computing device 267, lab user computing device 268, patient user computing device 269, and monitoring agent computing device 270, appliances 212, and one or more servers such as server 500. The various components listed above may be interconnected via a network such as network 600.

Continuing with smart community system 100, user computing devices 250, and server(s) 500 may all be communicatively connected to network 600. In one or more embodiments, network 600 may include a local area network (LAN), such as a company Intranet, a metropolitan area network (MAN), or a wide area network (WAN), such as the Internet or World Wide Web. Network 600 may be a private network or a public network, or a combination thereof. Network 600 may be any type of network known in the art, including telecommunications network, a wireless network (including Wi-Fi), and a wireline network. Network 600 may include mobile telephone networks utilizing any protocol or protocols used to communicate among mobile digital computing devices (e.g. computing device 104), such as GSM, GPRS, UMTS, AMPS, TDMA, or CDMA. In one or more non-limiting embodiments, different type of data may be transmitted via network 600 via different protocols. In alternative embodiments, user computing devices 250 may act as standalone devices or may be connected directly to other user computing devices 250 whereby user computing devices 250 may operate as peer machine in a peer-to-peer (or distributed) network environment.

Network 600 may further include a system of terminals, gateways, and routers. Network may employ one or more cellular access technologies including 2nd (2G), 3rd (3G), 4th (4G), 5th (5G), LTE, Global System for Mobil communication (GSM), General Packet Radio Services (GPRS), Enhanced Data GSM Environment (EDGE), and other access technologies that may provide for broader coverage between computing devices if for instance they are in a remote location not accessible by other networks.

User computing devices 250 may be any type of computing device known to those of ordinary skill in the art. User computing devices 250 are preferably mobile computing devices such as an iPhone, Android-based phone, or Windows-based phone, however, this is non-limiting and user computing devices 250 may be any computing device in the “internet of things”.

The “internet of things” applies the principle that as the world becomes more and more advanced, technology will evolve, and there will newer and newer devices users 299 can interact with to access smart community system 100. However it should be stated that no matter the changes in user computing device 250 the underlying principles of the present invention would remain the same. The various types of users computing devices 250 may include a tablet, television, desktop computer, laptop computer, video game console, wearable device electronic glasses, contact lenses capable of computer-generated sensory input and displaying data, smart home device, virtual reality system, augmented reality system, web appliance, networked router, networked switch, networked, bridge, or any computing device capable of executing instructions that specify actions to be taken by that computing device and which are able to connect to network 600 as well as send and retrieve data to network 600 and other user computing devices 250.

User computing device 250, in one exemplary embodiment, may include any number of components operatively connected in a computing device, including, without limitation, a processor, a memory, and communication component such as an antenna and communication interface for wireless communications, one or more input and/or output (I/O) components and/or interfaces, and one or more sensors.

It should also be appreciated that embodiments of user computing devices 250 described herein may be comprised of one or more processing units and unique stored program instructions that control the one or more processing units to implement, in conjunction with certain networks and non-processor circuits, some, most, or all of the functions of smart community 100 system and method. The non-processor circuits may include, but are not limited to, wireless transceivers, network communication modules, signal drivers, clock circuits, power source circuits, databases, and user input and computing devices. As such, these functions may be interpreted as steps of a method of smart community system 100. Alternatively, some or all functions could be implemented by a state machine that has no stored program instructions, or in one or more application specific integrated circuits, in which each function or some combinations of certain of the functions are implemented as custom logic. It should be obvious to one of ordinary skill in the art that a combination of the two approaches may be used.

User computing device 250 may include a touchscreen for displaying data to users 200 as well as receiving input from users 200. In one or more other non-limiting embodiments, other types of input entry devices may alternatively or additionally be used including a mouse, keyboard, and/or stylus. In further embodiments, user computing device 250 may include voice recognition capable software that may be used to navigate or issue instructions as well as thumbprint recognition software.

User computing device 250 may have a camera having any type of image capture device for capturing an image. For example, the camera may be a color and depth camera, a webcam, a 3D camera, or any other type of image capture device. The image may be captured and stored as image data. The image data may include photographs and/or videos. The camera may have a communication interface to communicate with user computing device 250 to exchange image data and may transfer the image data to user computing device 250. User computing device 250 may have location tracking capabilities such as Mobile Location Determination System (MLDS) or Global Positioning System (GPS) whereby user computing device 250 may include one or more satellite radios capable of determining the geographical location of computing device. User computing devices 250 may utilize (GPS) system to confirm the validity of location information, for example only some features of smart community system 100 may function if user 200 is within a certain proximity of a location.

A user interface, such as user interface 300, (which may include user interfaces such as vehicle occupant user interface 301, parking zone provider user interface 302, valet user interface 303, driver user interface 304, property manager user interface 305, handyman user interface 306, service provider user interface 307, customer user interface 308, monitoring user interface 309, requesting user interface 310, manufacturer user interface 311, guardian user interface 313, emergency personnel interface 314, employer user interface 315, employee user interface 316, doctor user interface 317, lab user interface 318, patient user interface 319) may be displayed on a smart community application such as smart community application 102.

User interface 300 may be included with smart community application 102. In one or more non-limiting embodiments user interface 300 may be modified to be suitable for presenting on various user computing devices 250 such as electronic glasses, tablet, smart watches, television, laptop, desktop computer, a virtual reality headset, smart windows, etc. Smart community application 102 may be downloadable and installable on user computing devices 250. In one or more non-limiting embodiments, smart community application 102 may be preinstalled on user computing devices 250 by the manufacturer or designer. Further, smart community application 102 may be implemented using a web browser via a browser extension or plugin.

Users 200 may initially start a session by launching smart community application 102 on user computing devices 250. In one or more other non-limiting embodiments, users 200 may initially commence a session by going to a predefined website address or domain name. In one or more other non-limiting embodiments, user computing device 250 may have smart community application 102 already downloaded onto user computing device 250.

Smart community system 100 may operate on one or more servers 500 located at a remote data center, or any other location suitable for providing service to network 600. Server 500 may comprise a database server such as MySQL® or Maria DB® server. Smart community system 100 may be distributed across multiple servers 500 that may be in the same location or different locations in any arrangement. Server 500 comprises a number of modules that provide various functions related to smart community system 100 and the subsystems, discussed above, that make up the components of smart community system 100. Modules may be in the form of software that interacts with the operating system of server 500. Modules may be configured to receive commands or requests from user computing devices 250, server 500, and outside connected devices over network 600.

In one or more non-limiting embodiments, server 500 of smart community system 100 may include a data collection module such as data collection module 505 that collects data transmitted by users 200 on user computing devices 250 or any outside connected devices over network 600 to user profile database 400 of server 500. Data collection module 505 collects information related to a user 200, such as, for example, any data uploaded by a business, reviews that relate to the business, funding and monetization value of the company, as well as calendar scheduling and booking that relate to the business. In one or more non-limiting embodiments, server 500 of smart community system 100 may include user categorization module such as user categorization module 510 that categorizes users, for example, but not limited to type (patient, doctor, customer, homeowner, service provider), as well as name, location, skills, achievement, and rankings, in user profile database 400 of server 500.

In one or more non-limiting embodiments, server 500 of smart community system 100 may include a data categorization module such as data categorization module 515 that categorizes data posted to server 500 by subject, matter, class, subclass, or topic. In one or more non-limiting embodiments, server 500 of smart community system 100 may include a data search module such as data search module 520 that allows users 200 to search all information stored on any of the databases on server 500 using search criteria such as, for example, one or more keywords or key phrases.

In one or more non-limiting embodiments, server 500 of smart community system 100 may include a data processing module such as data processing module 525 that analyze data received by server 500 and determine appropriate responses to the received data. The received data may be about a user's 200 location, activity, biometric data, scheduling and appointment booking, medical services, emergency and rescue, homeowner needs interests, as well as any set of criteria determined by user 200. Data processing module 525 may include communication and transaction patterns, statistical breakdown, and/or natural language processing. In one or more non-limiting embodiments, data processing module 525 may analyze data from other third party devices or websites to obtain information concerning a user 200 or other transaction. Server 500 and the various modules discussed may also interface with third party information systems or operating systems. As explained further below, the modules are used to enable server 500 to perform these functions.

Server 500 may have several databases, including a database for storing data for users' profiles such as user profile database 400, community database such as community database 405, parking zone database such as parking zone database 410, poll database such as poll database 415, transaction database such as transaction database 420, communications database such as communications database 425, medical assistance database such as medical assistance database 430, contract database such as contract database 435, and missing persons database such as missing persons database 440. Server 500 may receive requests from user computing devices 250 and communicate appropriate responses to requesting user computing devices 250. Server 500 may receive one or more requests or other forms of communication initiated by users 200 via user interface 300 on smart community application 102 running on user computing devices 250.

Consistent with some embodiments, when an individual or entity initially registers to become a user 200 of smart community application 102, user 200 may be prompted to provide some personal information through user interface 300, such as his or her name, age (e.g., birth date), gender, interests, contact information, home town, address, school or college attending, current occupation, class, subclass, interests, favorite activities, skills, professional organizations, or relationship status. User 200 may also be required to take a profile test or upload a previous test taken earlier on smart community application 102 or by other means. User 200 may also link their social media accounts to the smart community application 102 when registering, thus information about user 200 may be acquired from linked social media accounts. This information is stored, for example, as profile data in user profile database 400 with a reference number to identify the corresponding user 200. This information may be later altered, modified, added, or deleted by user 200 or by an administrator such as administrator 700.

After registering an account on smart community application 102, a user 200 may invite other users 200, or be invited by other users 200, to connect via smart community system 100. The connection may be mutual where both users 200 consent the connection. In one or more non-limiting embodiments, the connection may be one sided where one user 200 “follows” other user 200, which does not require the other user's 200 consent. When one user 200 has a connection with another user 200, connected user 200 may be able to communicate with other user 200 as well as receive the connected user's 200 messages, picture, videos, and other content in the user's 200 personalized content feed. In one or more non-limiting embodiments smart community system may automatically connect two users 200 such as user 200a and user 200b based on user's 200a specifications and a series of selected criteria as well as user's 200b selected criteria. Settings regarding communications between users 200 may be modified to enable user 200a to prevent the system from automatically connecting user 200a to another user 200 such as user 200b or letting another user 200 follow a user 200a, or letting another user 200 message 200a, as well as other settings commonly known by those of ordinary skill in the art.

Smart community system 100 may provide a broad range of applications and services that allow users 200 the ability to share and receive information, often customized to the interests of user 200. For example, smart community system 100 may include a photo and video sharing service that allows users 200 to upload photos or videos or social media sites or share photos or videos with other users 200. Users 200 of the smart community system 100 may be able to organize themselves into groups, class, occupation, interest groups, as well as organized around a specific neighborhood, university, and occupation. Users 200 may also organize around a subject matter or topic of interest. Users 200 may also be sorted by user categorization module 510 of server 500 and presented with a specific user interface 300 tailored to one or more sorting filters.

In one or more non-limiting embodiments, users 200 may subscribe to or join groups affiliated with one or more companies. For instance users 200 of smart community system 100 may indicate an affiliation with a particular homeowners association that user 200 is a member of, whereby news, events, or emergencies, pertaining to the homeowners association are automatically communicated to user 200 as well as other users 200 in their user interface or personalized activity and content streams.

User 200 may also subscribe or join an affiliated group that user 200 is not an associated member. Membership in a group, a subscription or following relationship with a community, enthusiast group, or a business relationship, are all examples of different types of relationships that may exist between different users 200 that may be analyzed by data processing module 525 then sorted by data categorization module 515 whereby the information is stored in the user profile database 400 of server 500 or shared with other social media sites. In one or more non-limiting embodiments, smart community system 100 may use data search module 520 to enable users 200 to search for and browse other users' 200 profiles.

In one or more non-limiting embodiments, smart community system 100 may include messaging service, such as an email application, an instant messaging application, or some hybrid or variation of the two users 200 may interact with one another whereby communications may be stored in communications database 425. Messages may have one or more parameters, including information to be communicated to a user 200 having images, text, photos, or other information provided by other users 200. User interface 300 may provide users 200 the option to then accept or decline a message. Smart community system 100 may restrict access to the messaging system to only users 200 that are currently in user such as user's 200a vicinity or within a specified distance selected by user 200a.

Smart community system 100 may be configured to determine the location of one or more users 200 using location services on user computing device 250 as well as directly by a variety of sensing components such as optical cameras and infrared (IR) cameras, global positioning system, compass, wireless networks, or Bluetooth. User's 200 location may be determined while user 200 is moving from one physical location to the next physical location. In one or more non-limiting embodiments, one or more sensors or cameras may be used to track the x y z coordinates of user 200. Smart community system 100 may also receive location information via wireless networking, hotspots, Bluetooth, or other means commonly known by those of ordinary skill in the art. Smart community system 100 may utilize mapping applications to provide maps that are viewable through user interface 300 (e.g., Google®, Apple®, etc.)

User interface 300 may provide users 200 with ability to set privacy parameters for Smart community system 100 so that user's 200 profile may not be visible to other users 200, but rather is only visible with a predefined group of other users 200 such as only to friends, family, or a specific community. Other considerations or parameters for displaying user's 200 profile may alternatively, or additionally be implemented as desired by user 200, such as displaying only to a certain age group or a specific gender or only displaying a user's 200 profile at specific time or day. For example, a user's 200 profile may only be shared between 9:00 a.m. and 5:00 p.m. to ensure safety of user 200 who does not want to be visible to other users 200 when it is night out.

Smart community system 100 may provide payment processing between users 200. In one or more non-limiting embodiments, users 200 may purchase digital currency or tokens, with each token representing a certain amount of currency. Users 200 may have a social account and a financial account within smart community system 200. The social account may be a configured account in which a user 200 can establish a credit within smart community system 100. The social account may act as a digital wallet that allows a user 200 to make electronic commerce transactions in smart community system 100. Server 500 may store private keys of users 200 pertaining to their digital wallet, send digital currency to other users 200, generate addresses so that a user 200 may receive digital currency from other users 200, and allow users 200 to view transaction history and current balance through user interface 300.

A user 200 associated with a digital wallet may perform transactions such as sending and/or receiving digital currency for goods and services provided as well any number of things such as gifts, loans, deposits, or donations. Smart community system 100 provides digital wallets as an incentive for users 200 to accept the digital currency because transaction fees will be lower than that typically imposed by credit card processors as well as uniformity, predictability, and quickness when sending or receiving digital currency. In one or more non-limiting embodiments social account may be instead be an application running on the user computing device 250, or a completely separate application.

The financial account may be an institutional financial system account, for example, a bank checking account, a debit card account, or a credit card account that user 200 has linked to their smart community system 100 account. The transactions within smart community system 100 occur using either a financial account or social account as well as normal payment processing. Deficiencies in the social account may also be addressed through the financial accounts that have been linked to the social account. For instance if user 200 only has 30 dollars in their social account and they need to pay for karate sessions, they may either pay 30 dollars from social account and 20 dollars from financial account or may instead pay 50 dollars from financial account. Users 200 may purchase credit for their social account by using a credit card such as VISA®, MasterCard®, Discover®, or American Express® over a secure credit card connection in smart community system 100 or transferring a certain amount from the financial account to the social account. Users 200 may be identified and verified with for example, a checking account history, a credit card score, two-step verification, or any other methods known by those of ordinary skill in the art.

Blockchain may be utilized in many aspects of smart community system 100 as digital ledger for keeping a record of transactions including the social account and financial account. For instance blockchain may be used to record every transaction made by a user 200. The transactions are represented as blocks whereby the blocks may be distributed across network 600 to various user computing devices 250 or other networked devices. A block may be then validated by the network of user computing devices 250 or other networked devices thus updating the chain. With blockchain on smart community system 100, a single ledger of transaction entries that one or more users 200 have access to can simplify the coordination and validation efforts whereby only a single version of records is recorded and viewable to users 200.

For example, smart community system 100 may use blockchain for borrowing monitoring services between users 200 whereby when user such as user 200a borrows money from another user 200 an open transaction may analyze by data processing module 525 then sorted by data categorization module 515 whereby the open transaction is stored on a blockchain of user 200a stored on user profile on user profile database 400 of server 500. Typically a person is able to pay for a loan or credit card by borrowing from multiple other sources such as a friend. The person is then able to receive an additional loan or credit card because the issuer only sees that the person has been paying for debts, but of course this may eventually catch up with the person and they will no longer be able to repay the amount owed. Smart community system 100 solves this problem by keeping a visible record of a borrower's history in the form of digital ledger or block chain.

In this example the payment may be sent through smart community system 100 whereby user 200a requests to borrow money and another user such as user 200b pays them, automatically creating an open transaction. This transaction may also be stored on transaction database 420 of server 500. The payment may also be sent outside of smart community system 100 where user 200b submits a report that user 200a has borrowed an amount of money from user 200b. This may be verified as well by administrator 700. Once the money borrowed has been returned the historical blockchain may be updated, showing user 200a has paid the money owed. Now when borrowing money from a lender, the lender may be presented the blockchain by user 200a or administrator 700 whereby the lender may see the open and closed transactions of user 200a

As another example, smart community system 100 may provider users 200 donation monitoring services whereby when user 200 donates to a charity or other reputable cause user 200 may view what has happened to the money or digital currency they have donated to the charity. A problem today is that there are so many charities and a significant amount of charities are mismanaging the funds allocated to them. Not knowing that their donations are properly being used, people are less likely to donate. Smart community system 100 is able to track donated funds to put user's 200 mind at ease. The payment may be sent through smart community system 100 through the financial account or social account whereby user 200 donates money or digital currency and a second user 200 such as charity accepts the money or digital currency, automatically creating an open transaction. This transaction may also be stored on transaction database 420 of server 500. After donating, user 200 may be presented with information pertaining to transaction history of the amount they sent to the charity as well as the current balance remaining that the charity has left of the amount donated. In one or more non-limiting embodiments user 200 may be presented with more information about the status of the charity and learn more about the particular entities or addresses that charity has allocated the amount sent by user 200.

As discussed smart community system may various subsystems such as parking services subsystem 105, delivery subsystem 110, polling subsystem 115, residential management subsystem 120, handyman service subsystem 125, monitoring services subsystem 130, property sale subsystem 135, appraisal services subsystem 140, appliance services subsystem 145, emergency subsystem 150, appointment booking subsystem 155, shared space management subsystem 160, employee booking subsystem 165, and medical assistance subsystem 170, that are designed for numerous specific situations but are intertwined to provide a holistic approach to connecting users throughout one or more communities in all circumstances and situations. The following will now discuss the features of each individual subsystem but it should appreciate that each subsystem may utilize aspects or functions of other subsystems to accomplish one or more tasks and may be used in other obvious circumstances different than those discussed.

Smart community system 100 may include parking management subsystem 105 for connecting the community together and assisting users 200 when in new and different areas. Suitable parking may be difficult to locate when navigating through a new area or during peak hours at a heavy traffic location. The parking process can also be very confusing and time consuming whereby a person may be worried they are accidently parking in a designated parking spot and their vehicle will be towed or the person ends up spending a substantial amount of money on a parking garage or valet to make sure their vehicle will not be tampered with or towed away. Parking also requires either inserting money into a meter, installing multiple mobile applications that support payment processing for that specific spot, or directly paying a parking garage attendant, landlord, or other designated employee, further complicating and fragmenting the process.

Parking management subsystem 105 improves this process by proving a system for vehicle occupant users to request a valet to pick up their vehicle anywhere and transport the vehicle and store the vehicle at a safe designated location owned by a parking zone provider, or other entity, whereby the user may then be notified of the location of the vehicle and reclaim the vehicle from the designated location when they so desire. During this process the vehicle may be monitored and tracked to determine to appropriate billing rate factoring in how long the vehicle occupies a parking spot as well as any additional service fees.

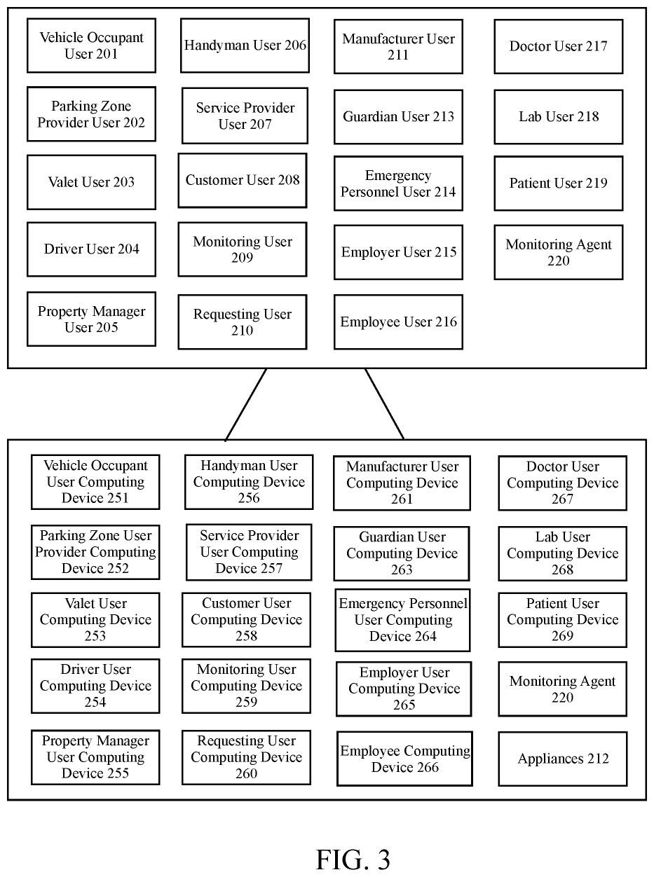

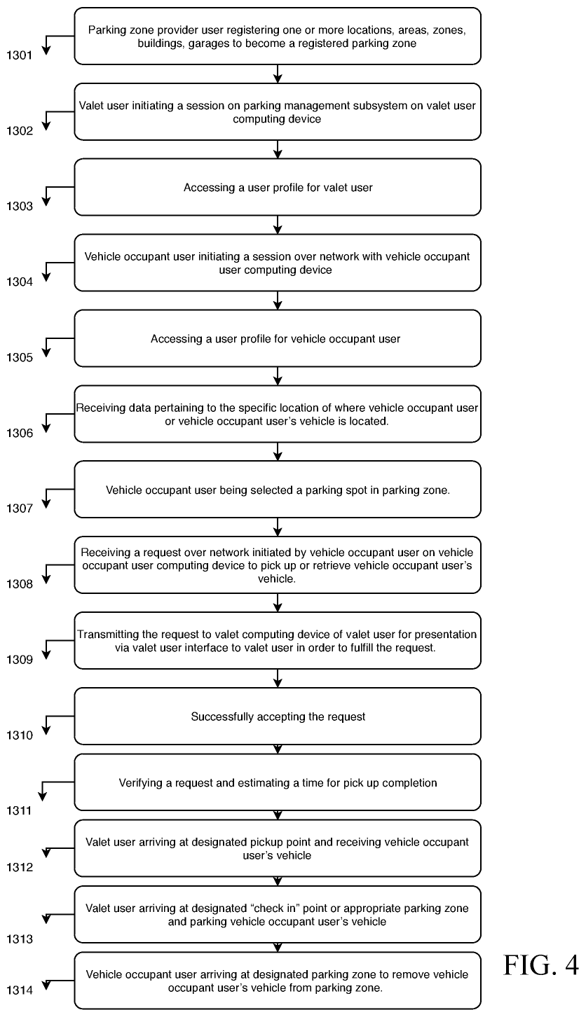

Turning to FIG. 4, FIG. 4 depicts a flow diagram showing an embodiment of an exemplary method for implementing the parking management subsystem 105 of smart community system 100. Parking management subsystem 105 may have one or more components, such as, without limitation, server 500, vehicle occupant user computing devices 251 operated by vehicle occupant user 201, parking zone provider user computing device 252 operated by parking zone provider 202, and valet user computing device 253 and valet user 203. Further, one or more exemplary method steps may be performed by smart community system 100 including server 500, vehicle occupant user computing device 251, parking zone provider user computing device 252, and valet user computing device 253, which may be interconnected via network 600.

At step 1301, a method may include parking zone providers user 202 initially registering one or more locations, areas, zones, buildings, garages to become a registered parking zone associated with parking management subsystem 105, such that the parking zone may be available to vehicle occupant users 201 to order for themselves or for their contacts with access to parking management subsystem 105. Upon initially signing up with parking management subsystem 105, Parking zone providers user 202 may be prompted to provide information along with a requested password. Information may be the hours available for the parking zone, the amount of parking spots in the parking zone, directions or coordinates to the parking zone, promotional content, contact information, corporate structure, and reservations of parking zone. When registering with parking management subsystem 105, parking zone providers user 202 may also be able to log into parking management subsystem 105 using login credentials from other social networking platforms, such as, for example, logging in with a Yelp® profile.

Parking zone provider interface 302, may provide information and options for parking zone providers user 202 to input relevant information associated with their parking zone, including, without limitations, images related to the parking zone, available parking spots, quantity, and/or promotional material that may be viewed by vehicle occupant users 201 and valet users 203. In one or more other non-limiting embodiments, administrator 700 may input a parking zone on behalf outside parties or smart community system 100.

Parking zones may be entered through parking zone provider user interface 302 on parking zone provider user device 252 by a parking zone provider 202. Parking zone provider may be an owner of the parking zone or an agent of the owner. Parking zone may then be analyzed by data processing module 525 then sorted by data categorization module 515 whereby the information pertaining to the parking is stored in the user profile database 400 and parking zone database of server 500. An updated list of parking spots provided by parking zone provider user 202 may be inputted manually through user interface 302 on parking zone provider user computing device 251 may connect to an available parking inventory system to provide information about available parking spots and services. For example, if parking zone provider user 202 provides car washes but only during the afternoon, parking zone provider user 202 may include selections currently available based on the time of day among other inputs such as current parking services inventory to assure that all the necessary equipment is available before allowing the specific services to be uploaded. In one or more non-limiting embodiments, if particular services are available but not a specific component of the services (such as a tire waxing in a car detailing) the services may still be uploaded, however the unavailable component would be detailed to vehicle occupant user 201.

Parking zone may refer to a physical space where vehicles may be parked or stored during a parking transaction. Parking zone may refer to but is not limited to a parking garage, outdoor lot, street parking, commercially owned lot, or private residence. In one or more non-limiting embodiments, parking zone may include all parking in a geographic area such as a homeowners association. In one or more non-limiting embodiments, park zone may refer to all space in a geographic area associated with a certain parking zone provider user 202.

At step 1302, the exemplary method may include valet user 203 initiating a session on parking management subsystem 105 on valet user computing device 253. Session may be initially started by valet user 203 launching and running smart community application 102 on valet user computing device 253 installed by valet user 203 through a manufacturer prescribed process such as downloading smart community application 102 from an application store or smart community application 102 may be preinstalled by the manufacturer or designer. In one or more non-limiting embodiments valet users 203 may navigate to a specific web address to initiate a session.

At step 1303, the method may include accessing a user profile for valet user 203. In one embodiment, the user profile may reside in user profile 400 database on server 500, which may be accessed by data processing module 525 and referenced using an identifier provided by valet user 203 as part of the registration process or login process such as an account name and password. When valet user 203 initially registers to become a registered valet user 203 of parking management subsystem 105, valet interface 303 may provide a first time valet user 203 the option to enter basic identifying information such as social security number, license plate, valet use's 203 license number, payment information for receiving payment. Information may be entered through valet user interface 303 by a pop-up menu data entry field selectable by valet user 203 on valet computing device 253, or pen based or finger based input using the screen of valet user computing device 253.

Valet user 203 may be required to take pictures of themselves during or after registration whereby data processing module 525 of server 500 analyzes pictures and data categorization module 515 categorizes and stores pictures of valet user 203 in user profile database 400. These pictures of valet user 203 then may be transmitted and displayed to other users 200 through user interface 300 during the parking process. Pictures may be for identification purposes during navigation of a session and to enhance the authenticity of the process by ensuring that the picture is of the correct, intended valet user 203 who is picking up the vehicle occupant user's 201 vehicle to be parked when requesting vehicle occupant user's 201 vehicle to be parked. Valet user 203 may couple, link, or connect with user accounts from social networking websites and internal networks. Examples of social networking websites include but are not limited to Instagram®, Facebook®, LinkedIn®, Snapchat®, and Twitter®.

At step 1304, a method may include vehicle occupant user 201 initiating a session over network with vehicle occupant user computing device 251. Vehicle occupant may be an owner, a passenger, somebody renting the vehicle, or any other type of user 200 who may need a vehicle transported. Session may be initially started by vehicle occupant user 201 launching and running smart community application on vehicle occupant user computing device 251 installed by vehicle occupant user 201 through a manufacturer prescribed process such as downloading smart community application 102 from an application store or smart community application 102 may be preinstalled by the manufacturer or designer. In one or more non-limiting embodiments vehicle occupant user 201 may navigate to a specific web address to initiate a session.

At step 1305, the method may include accessing a user profile for vehicle occupant user 201. In one embodiment, the user profile may reside in user profile database 400 on server 500, which may be accessed by data processing module 525 and referenced using an identifier provided by vehicle occupant user 201 as part of the registration process or login process such as an account name and password. When vehicle occupant user 201 initially registers to become a registered vehicle occupant user 201 of parking management subsystem 105, vehicle occupant user interface 300 may provide a first time vehicle occupant user 201 the option to enter basic identifying information of vehicle occupant user 201 and their vehicle such as vehicle identification number (VIN) license plate, vehicle occupant user's 201 license number, make and mark, color, mileage, insurance certificate of title, and any secondary drivers.

Vehicle occupant user's 201 vehicle is usually defined as passenger car, but it should be appreciated that any other vehicle including trucks, sports utility vehicles (SUVs), recreational vehicles (RVs), tanks, boats, may also be used. Information may be entered through vehicle occupant user interface 301 by a pop-up menu data entry field selectable by vehicle occupant user 201 on vehicle occupant user computing device 251 or pen based or finger based input using the screen of vehicle occupant user computing device 251.

Vehicle occupant user 201 may be requested to take pictures of themselves and/or vehicle occupant user's 201 vehicle whereby data processing module 525 of server 500 analyzes pictures and data categorization module 515 categorizes and stores pictures of vehicle occupant user 201 in user profile database 400 that may be transmitted and displayed to other users 200 through user interface 300. Pictures may be for identification purposes during navigation of a session and to enhance the authenticity of the process by ensuring that the picture is of the correct, intended vehicle occupant user 201 when requesting vehicle occupant user's 201 vehicle to be parked. Vehicle occupant user 201 may couple, link, or connect with user accounts from social networking websites and internal networks.

Examples of social networking websites include but are not limited to Instagram®, Facebook®, LinkedIn®, Snapchat®, and Twitter®. Server 500 may use access tokens or other methods as a parameter for searching for a friend list or address book of user 200 on a social networking site or other third party site or database. Data processing module 525 of server 500 then may use this friend list information to initialize a contact list database for vehicle occupant user 201 stored within user profile database 400. Further, vehicle user interface 301 may include status selections for indicating if vehicle occupant user 201 is associated with a certain status, such as a VIP member, a frequent client of the smart community system 100, parking management subsystem 105, other designated status indicators, for valet promotional purposes.

User profile for vehicle occupant user 201 may be associated with a parking zone provider's 202 social networking system such as a loyalty program account. A loyalty program account may provide various points and benefits that translate to savings and other desirable incentives for a vehicle occupant user 201 that is part of the loyalty program account.

At step 1306, the exemplary method may include data collection module 505 of server 500 receiving data pertaining to the specific location of where vehicle occupant user 201 or vehicle occupant user's 201 vehicle is located. Data processing module 525 of server 500 may send a data request to vehicle occupant user computing device 251, displayed through the vehicle occupant user interface 301, for identifying a geographic location of vehicle occupant user computing device 251 or a network location of vehicle occupant user computing device 251, as well as a timestamp identifying when the request was transmitted to vehicle occupant user computing device 251. The geographic location may be any physical location, which may be expressed in longitudinal and latitudinal coordinates, and may include other dimensions and factors such as altitude or height for determining an exact position of the geographic location.

In one or more other non-limiting embodiments, vehicle occupant user 201 may input zip codes, city, county, neighborhood, municipalities state names, landmarks or other important locations through the vehicle occupant user interface 301 to identify the geographical location of vehicle occupant user computing device 251 or vehicle occupant user's 201 vehicle. Vehicle occupant user interface 301 may display all available locations or coordinate points that are in the general area or in near proximity to user's geographic location. In one or more embodiments, vehicle occupant user's 201 location may be displayed on a map with an identifier. The map may be displayed to vehicle occupant user 201 with the surrounding area such as street names or point of interest may be displayed as markers, pins, or identifiers at their respective geographic locations whereby vehicle occupant user 201 then may move their identifier to a position where vehicle occupant user 201 wishes to have vehicle occupant user's 201 vehicle picked up. For instance if vehicle occupant user 201 knows they will be at a restaurant in 10 minutes vehicle occupant user 201 may set the location at the restaurant because vehicle occupant user 201 knows they will have arrived to the restaurant by that point in time.

Locations may also be displayed through a list or a drop-down menu from which a vehicle occupant user 201 may be able to select. Accordingly, vehicle occupant user 201 may select the establishment or place of business where vehicle occupant user 201 is currently located. In one or more non-limiting embodiments, the closest location in proximity to vehicle occupant user's 201 geographic location may be displayed, and in further embodiments, the closest location in proximity to the vehicle occupant user's 201 geographic location may be automatically selected if vehicle occupant user 201 remains at that location for a set amount of time. Vehicle occupant user interface 301 may selectively enable location tracking while smart community application 102 is running or in one or more non-limiting embodiments as long as vehicle occupant user computing device 251 is powered on or in full operating mode.

In one or more non-limiting embodiments for situations when vehicle occupant user 201 or vehicle occupant user computing device 251 are no longer within proximity of the vehicle or vehicle occupant user 201 wishes to monitor the status of the vehicle, sensor data from one or more onboard sensors of vehicle occupant user's 201 vehicle may be configured to send and receive information over network 600, such as satellite GPS location data, speed, acceleration and direction of vehicle occupant user's 201 vehicle, as well as environmental temperature. Video cameras or photograph cameras may also be are mounted at various positions on the vehicle to view the inside and outside of the cabin of the vehicle occupant user's 201 vehicle.

At step 1307, the exemplary method may include vehicle occupant user 201 being selected a parking spot in parking zone. Once a location has been identified or selected by vehicle occupant user 201 for vehicle occupant user's 201 vehicle or vehicle occupant user computing device 251, vehicle occupant user interface 301 allows vehicle occupant user 201 to browse and select services provided as possible selections that are associated with what type of services as well as the duration of said services they require for vehicle occupant user's 201 vehicle such as but not limited to the amount of time they wish to have vehicle occupant user's 201 vehicle parked or stored, if vehicle occupant user 201 requires vehicle occupant user's 201 vehicle to have covered parking, how much security vehicle occupant user's 201 vehicle requires, as well as if vehicle occupant user 201 wants to request additional services while vehicle occupant user's 201 vehicle is parked such as electric charging of vehicle occupant user's 201 vehicle, replenishing vehicle occupant user's 201 gasoline, washes, cleaning, details, oil changes, and other service-related items. Services may have nested hyperlinks for linking and to provide additional details to learn about the services. Fields may also be provided to vehicle occupant user 201 for inputting special instructions regarding vehicle occupant user's 201 preferences for services.

Using this information data processing module 525 of server 500 may analyze the best suitable parking zone whereby vehicle occupant user interface 301 may display the best suitable parking zone for vehicle occupant user's 201 vehicle to be taken. In one or more non-limiting embodiments the closest or most appropriate parking zone may automatically be selected for vehicle occupant user 201 while in one or more non-limiting embodiments a list may be shown where vehicle occupant user 201 may view the various available parking zones and the services they provide. Vehicle occupant user interface 301 may present vehicle occupant user 201 with these options by providing by a series of lists or drop-down choices from which the vehicle occupant user 201 may select.

In some non-limiting embodiments, vehicle occupant user 201 may search for a specific parking zone using a name or category to locate a nearby parking zone. For example, a search request having a character string may be entered whereby one or more parking zones may be identified using name, type of services provided, or other metadata. Further, a closest parking zone matching the search request may be provided that is located within some threshold distance of the vehicle occupant user's 201 current geographic location. For example, if vehicle occupant user 201 wants to locate a parking zone for receiving a replacement windshield while parked vehicle occupant user 201 may type “windshield” with a search request through vehicle occupant user interface 301. Data processing module 525 of server 500 may access parking zones in user profile database 400 and parking zone database 410 and return a list of nearby parking zones that replace windshields.

In another example, if vehicle occupant user 201, wants to locate a parking zone named “Park 4 Less” for parking services associated with parking services subsystem 105, vehicle occupant user 201 may type “Park 4 Less” with a search request through vehicle occupant user interface 301. Accordingly, a list of nearby taverns named “Park 4 Less” may be provided to vehicle occupant user 201 in response to vehicle occupant user's 201 search. In some non-limiting embodiments vehicle occupant user 201 may request through vehicle occupant user interface 301 that vehicle occupant user's 201 vehicle is delivered to another location by a valet user 203 whereby only valet user 203 may receive payment because the need for a parking zone and thus a parking zone provider 201 may be bypassed.

Vehicle occupant user 201 may input additional text or changes to the existing search request through vehicle occupant user interface 301 to receive an updated list of parking zones based on the newly entered text by vehicle occupant user 201. The search request may also include other parameters, such as categories, prices of the one or more services, distance from vehicle occupant user 201, already frequented parking zones by vehicle occupant user 201, and/or parking zone available hours. Further, in one or more non-limiting embodiments, these parameters as well as others may be automatically factored in when a search request is conducted. Vehicle occupant user interface 301 may present vehicle occupant user 201 with the ability to adjust and select parameters that may be used to filter and/or rank the results of the parking zones displayed to vehicle occupant user 201 from analysis by data processing module 525 of server 500

Vehicle occupant user interface 301 may present vehicle occupant user 201 the option to select if vehicle occupant user 201 wants their vehicle to be picked up immediately or, alternatively, provide the option for vehicle occupant user 201 to select a particular date and time for the vehicle to be picked up as well as moved to a parking zone. Accordingly, it may be possible for a vehicle occupant user 201 to place a request in advance, in which case the vehicle pick up request may be placed in a pre-order list stored in user profile database 400 until the designated time. The pre-order list may be modified or cancelled before the request has been processed. Vehicle occupant user interface 301 may present vehicle occupant user 201 with options to select multiple vehicles to simplify a multi-vehicle request. Vehicle occupant user interface 301 may present vehicle occupant 201 with additional information from user profile database 400 on the selections of vehicle occupant user 201 such as if they requested for vehicle occupant user's 201 vehicle to be picked up before and how many times vehicle occupant user's 201 vehicle has been picked up over one or more time periods such as week, a month, or a year.

Vehicle occupant user 201 may be presented through vehicle occupant user interface 301 the ability to alter selections for their request of services at any time during the process including while vehicle occupant user's 201 vehicle is in route to the parking zone or even after arriving at the parking zone. Once one or more selections have been chosen, the selections may be requested then transmitted to parking zone provider user computing device 251 whereby they may be accepted or denied by parking zone provider user 201. Vehicle occupant user 201 may be transmitted a notification if the request was accepted or denied.

After parking and/or services have been selected by vehicle occupant user 201, an estimated sub-total or total may be calculated that is displayed to vehicle occupant user 201 through vehicle occupant user interface 301. If satisfied with the calculation, vehicle occupant user 201 may proceed to confirm by selecting an appropriate button on vehicle occupant user interface 301. If vehicle occupant user 201 is not satisfied, vehicle occupant user 201 may cancel the entire request or alter one or more specific selections or modify an entire selection, returning vehicle occupant user 201 to a previously engaged menu session to alter the selection.

Vehicle occupant user interface 301 may then display to vehicle occupant user 201 the final order summary, the estimated price information including subtotal, discounts and taxes, along with promotional coupon and gift card text entry fields, gratuity or tipping text entry fields, mode of payment drop down menus or text entry fields, and a calculated total including subtotal combined with taxes discounts and gratuity added. Vehicle occupant user 201 may input their credit card or debit card information for a credit card or debit card using any card known in the art, including, without limitation an ATM card, a VISA®, MasterCard®, Discover®, or American Express® card in a credit card input field, or can alternatively use PayPal® or the like. Vehicle occupant user 201 may also withdraw from their digital wallet social account. Vehicle occupant user 201 may submit the payment information via an appropriate button through vehicle occupant user interface 301 or return to an earlier step in the session.

Vehicle occupant user interface 301 may present to vehicle occupant user 201 the ability to obtain one or more images of the credit card associated with the financial transaction. Images of the credit card may be captured by camera on vehicle occupant user computing device 251 whereby parking services subsystem 105 may then have access to the images. Images may include a front image of the credit card and back image of the credit card. Data collection module 505 of sever 500 may collect and store pictures of one or more credit cards of each vehicle occupant user 201 in user profile database 400 for subsequent use. In one or more non-limiting embodiments, images and the extracted details of the credit card may be deleted from user profile database 400 immediately or shortly after transaction has been completed or terminated while in further embodiments temporarily stored credit card data may be encrypted and compressed for added security when stored on user profile database 400 for subsequent use whereby vehicle occupant user interface 301 may allow vehicle occupant user 201 to select from previously used credit cards or payment information whereby vehicle occupant user 201 only needs to confirm the parking request.

Alternative transaction terms may also be included in parking services subsystem 105 whereby a certain amount may be deducted if vehicle occupant user 201 cancels their request after a certain amount of time. Also a valet user 203 may agree to pay a certain amount to administrator 700 or parking zone provider user 202 if request is unsuccessful due to valet user's 203 fault. After a certain number of cancelled requests by vehicle occupant user 201 or valet user 203, their account may be warned, charged an additional fee, or eventually terminated whereby vehicle occupant user 201 or valet user 203 may no longer access parking services subsystem 105 or the entirety of smart community system 100 for a set amount of time chosen by administrator 700 or permanently.

At step 1308, the method may include server 500 receiving a request over network 600 initiated by vehicle occupant user 201 on vehicle occupant user computing device 251 to pick up or retrieve vehicle occupant user's 201 vehicle. The request may indicate vehicle occupant user 201 sending the request including the one or more selections chosen by vehicle occupant user 201, the messages or communication sent by vehicle occupant user 201, and the payment information entered by vehicle occupant user 201. The payment information is then submitted and confirmed (e.g. by data processing module 525 of server 500 in one embodiment or third party payment processing systems) for processing of the payment to validate the payment information so that when vehicle occupant user 201 retrieves their vehicle from parking zone, vehicle occupant user's 201 payment card may then be charged automatically.

At step 1309, the method may include may include transmitting the request to valet computing device 253 of valet user 203 for presentation via valet user interface 303 to valet user 203 in order to fulfill the request. Valet user 203 may receive a notification of an indicator where a vehicle occupant user's 201 vehicle is located and needs to be picked up as well as an indicator confirming that valet user 203 will pick up vehicle occupant user's 201 vehicle and transport vehicle occupant user's 201 vehicle to a designated parking zone. Valet user 203 may automatically receive the task that they need to pick up vehicle occupant user's 201 vehicle at the location of the indicator and move the vehicle to the designated parking zone. Valet user interface 303 may provide the option for valet user 203 to select an indicator on screen on valet computing device 253 thus confirming that they will pick up the vehicle occupant user's 201 vehicle at the location of the indicator and move vehicle occupant user's 201 vehicle to the designated parking zone.

Valet user interface 303 may display a list of indicators including vehicle occupant user's 201 vehicle that vehicle occupant user 203 has requested to be parked at a parking zone. The indicators may be displayed on a map. The map may be displayed to valet user 203 with the vehicles displayed as markers, pins, or identifiers at their respective locations. Vehicle occupant user 201 and their vehicle may also be displayed on valet user interface 303 as a list or a drop-down menu. The list may display all vehicle occupant users 201 and depict vehicle occupant users 201 in different ways that may be distinguished by numerous parameters, such as, vehicle occupant users 201 who need specific services for their vehicle such as a “gasoline fill up”.

Once confirmed by valet user 203 or automatically chosen for valet user 203, the indicator for vehicle occupant user's 201 vehicle to be picked up may change color or activate another effect visible through valet user interface 303. Valet user interface 303 may also present valet user 203 more information about the pickup location (e.g., name of point of interest, latitude and longitude coordinates, and address, or a cross-street that may be represented by an indicator on a map showing the area surrounding valet user 203.) Simultaneously, all unselected indicators may be removed from the map or pull down menu as valet user 203 no longer requires to know about other vehicle occupant user's 201 vehicles that needed to be picked up.

In one or more non-limiting embodiments, driving or walking instructions to vehicle occupant user's 201 vehicle that needs to be picked up may be provided. In one or more non-limiting embodiments, valet user 203 may select multiple vehicle occupant user's 201 vehicles that have requested parking whereby vehicle occupant users 201 may be placed in a queue visible to valet user 203 through valet user interface 303. Further in one or more non-limiting embodiments, valet user interface 303 may present to valet user 203 more indicators after a specific amount of time or determined from the current location of valet user 203. Additionally when a valet user 203 confirms a vehicle occupant user's 201 vehicle, the indicator disappears from valet user interface 303 of other valet users 203. As such, the actual selection of who will pick up the vehicle occupant user's 201 vehicle is made by valets users 203 themselves or data processing module 525 of server 500 of parking services subsystem 105.

In one or more non-limiting embodiments valet user interface 303 may display an indicator for the location of other valets users 203 or designated parking zones that a vehicle occupant user's 201 vehicle may be taken. For example, a valet user 203 may choose not to select vehicle occupant user's 201 vehicles that need to be picked up near parking lots in order to ensure a situation does not arise where vehicle occupant user 201 has parked their vehicle before valet user 203 has arrived at the location. Or, the location, volume, and saturation of many valet users 203 may indicate to a valet user 203 that the location with multiple valet users 203 is more likely have multiple vehicle occupant users' 201 vehicles located there that may request parking. This is especially useful for a valet user 203 who is unfamiliar with or new to the area when operating as a valet user 203.

In one or more non-limiting embodiments only certain information may be presented to valet user 202 through valet user interface 303 when choosing to confirm the pick-up of a vehicle occupant user's 201 vehicle whereby some information such as identifying information or destination information of vehicle occupant user's 201 vehicle may be left out. In this manner, this may prevent valet users 203 from discriminating based on length of the trip or characteristics of vehicle occupant user 201 such as gender or race.

In one or more non-limiting embodiments when destinations are too far for valet users 203 to reach by walking or running such that it wouldn't be practical to travel back and forth from parking zones then to vehicle occupant users' 201 vehicles, a driver user 204 may be utilized. A driver user 204 conceivably could pick up multiple valet users 203 from their initial location or the parking zone where they dropped off a vehicle and then bring valet users 203 to another vehicle occupant user's 201 vehicle whereby valet user 203 then would pick up vehicle occupant user's 201 vehicle and deliver vehicle occupant user's 201 vehicle to the parking zone. Once this action has occurred, driver user 204 could then once again pick up valet user 203 and transport valet user 203 to the next vehicle occupant user's 201 vehicle. This process may be repeatable for multiple cycles.

Driver user 204 may be presented with information pertaining to valet users 203 through driver user interface 304 on driver computing device 254. Driver user interface 304 may present to driver user 204 a list of indicators including valet users 203 that have requested a ride manually or automatically by data processing module 525 of server 500 which has determined that valet user 203 needs to be picked up based on the valet user's 203 current tasks and location. The indicators for valet users 203 may be displayed on a searchable map on driver user interface 304. The map may be displayed to driver user 204 whereby valet users 203 are displayed as markers, pins, or identifiers at their respective locations. Valet users 203 in need of rides may also be displayed on driver user interface 304 as a list or a drop-down menu whereby each valet user 203 is selectable. Once a valet user 203 has been selected, driver user interface 304 may then present driver user 204 with additional information pertaining to the selected valet user 203 along with a selectable button whereby driver user 204 may confirm the pick-up of the selected valet user 203. This action may then be sent to server 500 and then transmitted to valet user computing device 253 for presentation to valet user 203 through valet user interface 303.

At step 1310, the method may include successfully accepting the request. While data processing module 525 of server 500 is processing the payment, the appropriate systems or providers are contacted in order to complete the transaction whereby payment is designated to be transferred from vehicle occupant user 201 to parking zone provider user 202. Payment may be transferred when vehicle occupant user 201 has removed vehicle from parking zone. A valet user 203 may also receive compensation as a percentage of the parking zone provider user's 202 compensation or an additional fee charged to vehicle occupant user 201 on top of parking zone provider user's 202 compensation. The amount of the compensation may be calculated based on factors such as trip distance, allocated time, actual fuel usage, type of vehicle to be picked up, adjusted by accumulated modification requests initiated by vehicle occupant user 201 or parking zone provider user 202, and offset by accumulated modification requests initiated by valet user 203.

If the request is successful, a confirmation message may be displayed to vehicle occupant user 201, confirming the time of purchase and the total price to be charged. If payment is declined, a failure message may be displayed to vehicle occupant user 201, notifying vehicle occupant user 201 of the reason for the failed request. After the transaction is completed, a digital receipt of the payment may be stored in user profile database 400 for vehicle occupant user 201, parking zone provider user 202, and valet user 203 as well as transaction database 420 in one or more non-limiting embodiments.

At step 1311, the method may include verifying a request and estimating a time for pick up completion. Vehicle occupant user 201 may be presented an approximate time it may take for vehicle occupant user's 201 vehicle to be picked up by valet user 203. Valet user interface 303 may present valet user 203 with a selectable button as an option to cancel the request. Valet user interface 303 may also provide text entry fields for valet user 203 to input the reason for the cancellation, which may be transmitted to server 500 and then to vehicle occupant user computing device 251 to be displayed to vehicle occupant user 201 through vehicle occupant user interface 301 as well as collected by data collection module 505 stored in user profile database 400 of valet user 203 and vehicle occupant user 201 for subsequent use. An example for this situation to occur would be if valet user 203 no longer could fulfill the request because they lack the strength or because parking zone provider user 202 cannot fulfill the request for any other reason such as there was an error and there is no longer any parking spaces at the parking zone.

At step 1312, the exemplary method may include valet user 203 arriving at designated pickup point and receiving vehicle occupant user's 201 vehicle from vehicle occupant user 201, a third party, or a lock box or other security device attached to vehicle occupant user's 201 vehicle whereby vehicle occupant user 201 may have entered a verification code through vehicle occupant user interface 303 that was sent to valet user computing device 253 that may be used by valet user 203 to retrieve the key from lock box, and then confirming through valet user interface 303 that they have picked up vehicle occupant user's 201 vehicle. In one or more non-limiting embodiments vehicle occupant user's 201 vehicle may have already installed a method for valet user 203 to unlock and drive vehicle occupant user's 201 vehicle, such as an automatic ignition or remote access through parking services subsystem 105.

Vehicle occupant user 201 may verify the identity of valet user 203 by in one or more embodiments, by scanning a thumbprint, optical bar code, a QR code, a RFID tag, other suitable identification technology using as selectable option displayed on valet user interface 303. This may be achieved using an optical bar code, a thumbprint scanner, a QR code, or a RFID tag reader connected to vehicle occupant user computing device 251 or another device on network 600. In one or more non-limiting embodiments the roles may be reversed whereby valet user 203 may verify the identity of vehicle occupant user 201. In one or more other non-limiting embodiments, vehicle occupant user 201 or valet user 203 may be given a code sequence generated by data processing module 525 of server 500 that when inputted into the appropriate field of user interface 300 may complete the verification.

Vehicle occupant user's 201 vehicle pick up may also be recorded and uploaded by data collection module 505 to parking zone database 410 of server 500 whereby the pick-up of vehicle occupant user's 201 vehicle may be transmitted to vehicle occupant user computing device 251 where vehicle occupant user interface 301 displays the pick-up of vehicle occupant user's 201 vehicle and recent activity pertaining to vehicle occupant user's 201 vehicle including services conducted on or to vehicle as well as well the vehicle's current states. This may be especially useful to vehicle occupant users 201 who are not with their vehicle while valet user 203 is accessing vehicle occupant user's 201 vehicle by a lockbox or other remote access method. Data collection module 505 of server 500 may also store vehicle occupant user's 201 vehicle pick up in user profile database 400 for subsequent use and the compilation of information pertaining to vehicle occupant user 201.

At step 1313, the exemplary method may include valet user 203 arriving at designated “check in” point or appropriate parking zone and parking vehicle occupant user's 201 vehicle. A “check in” as used herein is the self-reported positioning of vehicle occupant user's 201 vehicle at parking zone. A “check in” may also be accomplished using a sensor system positioned at or around the parking zone to identify that vehicle occupant user's 201 vehicle has arrived at parking zone.

Sensor system may be configured to monitor parking zone including multiple individual parking spots located in parking zone. Sensor system may include one or more sensor components to perform the monitoring of vehicle occupant user's 201 vehicle, then feeding the input data into logic control to generate a sensor data output signal that may be received by server 500 over network 600, followed by data processing module 525 calculating the status of vehicle occupant user's 201 vehicle and parking zone, then calculating occurrences in accordance with the output data.

Sensor system may include one or more suitable types of sensors, such as an optical sensor, an image capturing device such as a still camera or video camera, an audible sensor, a proximity sensor, a movement sensor, or a weight sensor. Sensor system may have infrared (“IR”) detectors having photodiode and related amplification and detection circuitry. In one or more other non-limiting embodiments, radio frequencies, magnetic fields, and ultrasonic sensors and transducers may be employed. Sensors may be arranged in any number of configurations and arrangements. For example, in one embodiment sensors may have an omnidirectional viewing area by having sensors mounted to the ceiling and floor to form a 360 degrees field of view while in one or more other non-limiting embodiments sensors may be mounted on the side of the walls which may be used to form a collective field of view of detection of all parking spaces and vehicle occupant user's 201 vehicles.

Sensor system may also identify individual vehicle occupant user's 201 vehicles by pictures or other identifying information uploaded by vehicle occupant user 201 and stored by data collection module 505 in user profile database 400 or by an applied bar code, a QR code, a RFID tag, or other suitable identification technology configured to be detected by sensor system. For instance when using parking services subsystem 105, vehicle occupant user interface 301 may present to vehicle occupant user 201 an option to print out a sticker that may be applied to vehicle occupant user's 201 vehicle, the sticker having a unique identification code that may be identified by sensor system. In further embodiments the sticker may be mailed directly to vehicle occupant user 201 as well as hand delivered by administrator 700 or agents of administrator 700.

Data collection module 505 of server 500 receives sensor data output signals, which is then analyzed by data processing module 525 and stored in parking zone database 410, which also generates parking zone information from this data including availability of parking lots and status of vehicle occupant users' 201 vehicles within the parking zone, such as if the vehicles are currently parked in the parking zone as well as if vehicle occupant user's 201 vehicle is entering or exiting parking zone or transitioning from one parking spot to another parking spot with the parking zone. Data processing module 525 of server 500 may be configured to determine from sensor data output signal if an individual parking spot is occupied as well as how many available unoccupied parking spaces are present which then may be indicated as available for parking through parking services subsystem 105 for vehicle occupant users' 201 vehicles to be parked in the parking spots.

Data processing module 525 of server 500 may also generate a map of parking zone, with parking availability overlaid on the map for indicating physical location information for each of the parking spots that may be available to vehicle occupant user 201 through vehicle occupant user interface 301 to quickly locate vehicle occupant user's 201 vehicle or for valet user 203 to view the parking spots through valet user interface 303 to quickly park vehicle occupant user's 201 vehicle among a plethora parking spots in a parking zone.

Vehicle occupant user's 201 vehicle “check-in” or “check in” identified by sensor system may also be recorded and uploaded to parking zone database 410 of server 500 whereby the “check-in” may be transmitted to other vehicle occupant user computing devices 251 where vehicle occupant user interface 301 displays the “check in” of vehicle occupant user's 201 vehicle and recent activity to the vehicle including services conducted or well-being of the vehicle. Vehicle occupant user interface 301 may also display the exact location of the vehicle via a map generated by data processing module 525 of sever 500 using data stored on parking zone database 410, including parking zone and parking spot where vehicle occupant user 201 may be able to pick up their vehicle as well as optionally show driving directions to parking zone and/or driving directions to a particular parking space in parking zone. Data collection module 525 of server 500 may also store vehicle occupant user's 201 vehicle “check-in” in user profile database 400 for subsequent use and collection of information pertaining to vehicle occupant user 201. In some non-limiting embodiments, vehicle occupant user's 201 vehicle “check in” is visible to their friends on smart community system 100, and even other non-limiting embodiments other users depending on privacy settings, which may be set or modified by vehicle occupant user 201 via the vehicle occupant user interface 301.

At step 1314, the exemplary method may include vehicle occupant user 201 arriving at designated parking zone to remove vehicle occupant user's 201 vehicle from parking zone. Vehicle occupant user 201 may verify the status of their vehicle as well as any services by comparing the request after selecting a completed or pending selectable button on vehicle occupant user interface 301. Once vehicle occupant user 201 removes their vehicle from parking zone, data collection module 505 of server 500 may receive a sensor data output signal from sensor indicating that vehicle occupant user's 201 vehicle is no longer present in parking zone. Data processing module 525 of server 500 may then process the appropriate payment whereby the appropriate systems or providers are contacted in order to complete the transaction whereby then payment is transferred from vehicle occupant user 201 to parking zone provider user 202 and valet user 203. In one or more non-limiting embodiments payment may be transferred to valet user 203 and parking zone provider user 202 at different times such as having valet user 203 receive payment when vehicle occupant user's 201 vehicle is delivered to parking zone and parking zone provider user 202 receiving payment when vehicle occupant user's 201 vehicle is no longer present in parking zone. Alternative transaction terms may also be determined in parking services subsystem 105 whereby a certain amount may be added or a fee may be assessed if vehicle occupant user 201 stays longer than their requested time or causes harm or damage to the parking zone while exiting the parking zone.

In one or more non-limiting methods a vehicle occupant user 201 selects an appropriate button displayed on vehicle occupant user interface 301 such as a redemption button to verify that vehicle occupant user 201 has indeed retrieved their vehicle and moved said vehicle from parking zone. In one or more non-limiting embodiments vehicle occupant user 201 may verify that they are taking vehicle occupant user's 201 vehicle from parking zone by inserting a code, command or, scanning a bar code, a QR code, a RFID tag, other suitable identification technology at a parking lot gate or other exit point. The parking lot gate may have a control system to send data to sever 500 over network 600 indicating that vehicle occupant user 201 wishes to take their vehicle from parking zone. The parking lot gate may then permit access for vehicle user's 201 vehicle to leave parking zone when they enter the proper command or code. Data processing module 525 then may determine vehicle occupant user's 201 vehicle is no longer present and parking spot of parking zone is available for another vehicle occupant user's 201 vehicle.

In one or more non-limiting embodiments a delivery confirmation may be displayed on vehicle occupant user interface 301 to vehicle occupant user 201. Vehicle occupant user 201 may choose to have a receipt or invoice sent to them as a printed receipt, via e-mail, text message, hyperlink, or other type of message. Data collection module 505 of server 500 may also store a virtual image of the receipt in user profile database 400 for valet user 203 and parking zone provider 202 as well as transaction database 420.

After pickup of vehicle occupant user's 201 vehicle, vehicle occupant user interface 301 may display a survey to vehicle occupant user 201 or instead the survey may be seen via email, text message or a link to a web site asking about the parking zone, services, and the overall process of parking zone subsystem 105. Vehicle occupant user 201 may give a rating according to any numerous numbers of ranges including punctuality, presentation, services rendered, and how many problems were encountered during the duration of the transaction. There many also may be one or more fields allowing vehicle occupant user 201 to optionally input their own worded comments. The survey results may be made private, public, or accessible based on the privacy settings of vehicle occupant user 201. Vehicle occupant user interface 301 may include a transaction history button for displaying previously made requests. Valet user 203 and parking zone provider 202 may also receive surveys in a similar manner to vehicle occupant user 201 as well as submit ratings pertaining to vehicle occupant user 201, the transaction, and overall process.

In one or more non-limiting embodiments vehicle occupant user's 201 vehicle may be an autonomous or self-driving vehicle. The self-driving vehicle occupant user's 201 vehicle may also include driving assistance systems to facilitate autonomous driving. Driving assistance systems may include collision avoidance, adaptive cruise control, speed modification, environmental and surrounding recognition, traffic sign and signal recognition, communication with other self-driving vehicles or manually operated vehicles, as well as other systems known by those of ordinary skill in the art to assist with autonomous driving. The vehicle may include various sensors to determine the surrounding environment as well as the best course of action in any given situation. Additionally, the vehicle may be equipped with map data to know the road network and to incorporate various destinations, addresses, or points of interest. Additionally, the vehicle navigation system may interact with off-board navigation systems (e.g. satellite traffic, TMC traffic, HD Radio Traffic, online traffic) to facilitate driver assistance.

Vehicle occupant user interface 301 may present option for vehicle occupant user 201 to select that they wish to park vehicle occupant user's 201 self-driving vehicle. This process may work in a similar manner to a manually operated vehicle occupant user's 201 vehicle however the need for a valet user 203 would be reduced or eliminated altogether and instead vehicle occupant user interface 301 may provide vehicle occupant user 201 with a set of instructions or driving directions so that self-driving vehicle occupant user's 201 vehicle may be self-driven, parked, and stored in parking zone. Self-driving vehicle occupant user's 201 vehicle may also be connected to server 500 over network 600 and parking services subsystem 105 so that self-driving vehicle occupant user's 201 vehicle may automatically be sent to the appropriate parking zone when vehicle occupant user 201 confirms they wish to have self-driving vehicle occupant user's 201 vehicle parked.

The functionality and aspects of parking zone management subsystem 105 may be utilized to accomplish other tasks including reserved parking and ridesharing programs. For instance when a vehicle occupant user 201 approaches a parking zone such as a parking garage, they may receive a reserved spot from either smart community application 102 or a device connected to network 600. Data processing module 525 of server 500 may select a parking spot for vehicle occupant 201 based on availability information from information stored in parking zone database 410 and generate a map of parking zone, with parking availability overlaid on the map for indicating physical location information for each of the parking spots that may be available to vehicle occupant user 201 through vehicle occupant user interface 301 to quickly locate their reserved parking spot to quickly park vehicle occupant user's 201 vehicle. Vehicle occupant user 201 may then be charged for how long their vehicle is in the parking spot.

Another example is that parking zone management subsystem 105 may also utilize many ridesharing functions such as user 200 allowing a driver user 204 to use their vehicle for any of the methods above or for the normal business of transporting people similar to Uber® and Lyft® whereby the user 200 may receive compensation for how long their vehicle has been used, how many miles traveled, or a combination of both. In further embodiments user 200 may allow another user 200 to have access to their vehicle to drive around directly whereby they may receive compensation through smart community system 100. In other non-limiting embodiments automatic vehicles may be rented at a parking zone such as an airport whereby a user 200 may have access to the automatic vehicle to take to their destination whereby they are charged a certain fee based on the distance or time traveled to user's 200 destination and back unless another user requests automatic vehicle then the price may be offset.

The aforementioned method was an exemplary example whereby the method described revolved around a vehicle, however smart community system 100 may instead be used with any type of objects or entities. Smart community system 100 may utilize a delivery subsystem 110 for the picking up, storing, and delivering of any other entity such as a child, an animal or pet, or any other object such as a package that needs to be delivered, stored, or transported to an alternate location.

For instance a package may need to be stored for protection against privacy or theft. User 200 begins by initiating a session over network 600 with user computing device 250. Data processing module 525 of server 500 then accesses the user profile stored on user profile database 400 for user 200. Data collection module 505 of server 500 then receives data pertaining to the specific location of where user 200 or user's 200 package or other entity is located. User 200 then enters any additional information such as what type of services are needed for the package and the duration of said services they require for their package such as but not limited to the amount of time they wish to have their package stored, if user 200 requires their package to be stored in a temperature controlled room, how much security their package requires, as well as if user 200 wants to request additional services while their package is stored.

Server 500 then receives the request over network 600 initiated by user 200 and data processing module 525 of server 500 then selects a storage location for the package. The request along with the storage location is then transmitted in a similar manner to parking services subsystem 105, to valet user computing device 253 of valet user 203 for presentation via valet user 203 interface to valet users 203 in order to fulfill the request. A valet user 203 then may accept request whereby request is verified and user 200 is notified of the successful request and an estimated time for completing the pick-up. Valet user 203 then retrieves the package at the requested location by receiving user's 200 package from user 200, a third party, or by retrieving an isolated package not in possession of user 200. Valet user 203 then arrives at designated check in point and stores the package. User 200 or a third party may then arrive the designated check in point to remove package from check in point or storage location. User 200 is then billed for the amount of time the package was stored at the check in point along with any other additional services or added fees that occurred during the transaction.

In one or more non-limiting embodiments packages may temporarily arrive at a hub or other nucleus from a source (valet user 203, driver user 204, user 200) whereby packages may be sorted and directed according to their respective destinations. For example, packages destined for delivery addresses within a geographical area (such as a homeowners association neighborhood) served by a hub may be sorted for local delivery within that geographical area. Different modes of transportation may be provided for conveying packages from their point of origin to their respective storage areas or delivery locations.

Packages may also have extra security protection in the form of a unique identifier. During the delivery of packages it is a major concern of customers as well as the manufacturers of products to develop methods for reliably marking genuine products to enable the identification of counterfeit goods or goods that have been damaged or otherwise tampered with. Packages may have a unique identifier attached as a production code, serial number, QR code, bar code, that may be fastened, impressed, glued, or printed on the package. In one or more non-limiting embodiments if unique identifier has been already used by someone, data processing module 525 of server 500 stops the registration and requests another unique identifier, or initiates an appropriate action, for example, issuing a warning to user 200 that package has been already comprised by an outside source. Package may have one more areas containing unique identifiers that may be revealed by user 200 scratching off an opaque covering or removing a removable opaque covering.

Unique identifier in one or more non-limiting embodiments may enable identification of the production site, and the tracking of the trade chain for a particular item. Unique identifier may be entered into or scanned by a user computing device 250 whereby user 200 has connected with social media platforms such as YouTube® and Dailymotion®. Unique identifier may be entered into or scanned by a user computing device 250 whereby user 200 may be directed to a video player or website featuring a step-by-step assembly tutorial for assembling the package, content that promotes the brand associated with package, or a feedback page whereby the page uses rating and comment box for users 200 to leave their review about the product, package, or delivery. Other uses will be discussed later in the description.

User categorization module 510 of server 500 may create one or more location based community networks, stored in community database 405, whereby users 200 may be associated with a specific geographic location, such as a neighborhood, town, city, or municipality as well as any other community networks based on any number of criteria. User interface 300 may provide multiple ways to login such as a private login where users 200 may interact with other users 200 in a specific location based community network. There may also public login whereby users 200 may interact with all other users 200 that are of any geographic distance or affiliation. User interface 300 may provide connection information about other users 200, such as names, photos, activities, and interests, and relationship of other users 200 whom are in the location based community network when privately logged whereby this information cannot be accessed when publicly logging on to smart community system 100.

Location based community network may have different classes or groups of users 200 with different types of access, permissions, and interfaces, determined by user categorization module 510. For example one location based community network on the smart community system 100 may be designed for assisting users 200 to communicate with their homeowners association. In this location based community network there may be but not limited to a homeowner class, a board member class, and a property management class, a homeowners association class, and a maintenance class, administrator class, vendor class, and office staff class. User categorization module 510 may prevent all access by a certain level of user 200 to specific access communication. For example, users 200 may be restricted from all access while in one or more non-limiting embodiments users 200 may be restricted from partial access to confidential messages between homeowners association class and board member class individuals.

In one or more non-limiting embodiments, smart community system 100 may have a polling subsystem 115 whereby users 200 may generate a poll viewable by other users 200. This is very useful for users 200 who are interested in other's opinions in the community or to determine which activities may interest others. Demographical information can also be obtained from polls, which may be important to determine the consensus on a specific issue such as zoning and leadership.

User 200 may be presented with a text box interface whereby user 200 may enter a question into a designated question text box as well as possible answer selections in designated answer selection text boxes then selecting an appropriate button that sends the questions and answers to server 500 whereby data collection module 505 may store the poll on user profile database 400 and poll database 415. User 200 may also be presented with options to select users 200 they wish to participate in this poll such as having only users 200 in a specific radius participating, or a part of a specific group, or at a certain events. Server 500 then may transmit the poll for presentation to other users 200 whereby the question and answers are viewable by other users 200 at a specific proximity from user 200 as selected by the user 200, or more private community networks user 200 has joined including another location based community network. Other users 200 may then view and analyze the question and answers as well as select the choice they think is the most suitable. The choices made by users are then transmitted to server 500 and stored on user profile database 400 and poll database 415. The choices then may be calculated by data processing module 525 whereby server 500 transmits the results to all users 200. Polls may be presented in the form of a table as well as bar graphs, pie graphs, line graphs, or any method known by those of ordinary skill in the art.

For example if John, a homeowner in a community, is planning the annual homeowners association luncheon, he may initiate a session for a private login for his homeowners association location based community network on smart community system 100 with user computing device 250. Data processing module 525 then accesses the user profile stored in user profile database 400 for John. John then may create question through user interface 300 asking what the theme of the party should be along with answer selections including superheroes, zoo animals, or pirates. This poll question is then received by data collection module 505 whereby server 500 transmits the question and answers for presentation to other users 200. Other users 200 that are members of the location based community network may then be able to view the question along the selectable answer choices and choose an answer through user interface 300. The answers are then received by data collection module 505 and stored on user profile database 400 and poll database 400. Data processing module 525 then calculates the total amount of votes for each selection in the poll then display results the results to John, the other users 200 participating in the poll, an administrator 700 who may search for the poll by data search module 520, and any other parties that may have access to the location based community network.

In one or more non-limiting embodiments user 200 may be presented with information pertaining to the selection of each other individual user 200 who selected an answer in the poll, users 200 may also be presented with the choice of each other user 200. In some embodiments the choice of each user 200 may not be presented for viewing and instead kept private. Other users 200 may also submit sub-polls that accompany the original poll as well as add additional answers if user 200 has selected the option through user interface 300 for this action to be allowable.

In further embodiments users 200 may be located at an event, gathering, a regional area, or other happening whereby data processing module 525 may generate questions to gather opinions and related data for the event using one or more group of users 200 amassed at the given event or gathering. In other embodiments administrator 700 may submit questions and answers that will be transmitted and displayed to users 200. Administrator 700 may then be presented with information pertaining to the selection of each individual user 200 or the group of users 200 who selected an answer in the poll. In even further embodiments poll may be replaced by elections whereby data processing module 525 may verify location of user 200 and if they are within a certain area such as a polling location they may select one or more candidates. Once the election is over data processing module 525 may transmit results to user computing devices 250 and administrator 700 for viewing.

In one or more non-limiting embodiments Data processing module 525 may retrieve user profile data from user profile database 400 associated with user 200 whereby user may be presented and view a poll generated by data processing module 525 pertaining to questions related to information on user profile or based on the geographic location of user 200. User 200 may answer these questions and receive incentives such as reward points, a credit towards future services, a gift card or certificate, and a discount.

In one or more non-limiting embodiments, smart community system 100 may have residential management subsystem 120 whereby users 200 may report a violation, request a work order, or request an approval. Users 200 may report a violation that is viewable by the property manager user 205 and other parties in one or more community networks. Examples of such violations include but are not limited to parking too many cars in front of a homeowners yard, painting a house a color that hasn't been approved, or leaving trash outside of the designated areas. Homeowners association and board members need to enforce the community regulations as violations can directly affect the value of the homes in the community as well as the overall well-being of its residents. Some violations even can even be a massive breach in safety that could have legal ramifications. In addition, aesthetic violations can lower the values of all homes in the surrounding area, not just those in violation. Property manager user 205 is a term merely for illustration purposes and the same actions may be conducted by a homeowner's association class, neighborhood watch, management company, board of directors, as well as other parties who deal in these types of situations.

Residential management subsystem 120 may provide multiple options to report violations in the community. A violation report may be sought by a user such as user 200a on residential management subsystem 120. User 200a wishes to report a violation for another user 200 such as user 200b in their location based network. User 200a begins by initiating a session on residential management subsystem 120 over network 600 with user computing device 250. Data processing module 525 of server 500 then accesses the user profile stored on user profile database 400 for user 200a and receives data pertaining to the specific location of where user computing device 250 is located. If user 200a wishes to enter a new violation, user interface 300 may present to user 200 an option to create a new violation. After selecting this option, user 200a may enter information pertaining to the violation including the type of violation, the date and time of the violation, and other additional information. User interface 300 may also provide user 200a with ability to upload associated data including any file attachments, images, or videos directly from camera on user computing device or photo library stored on user computer device 250 using methods known by those of ordinary skill in the art.

User 200a may also be presented with a related users selectable button to select all users 200 that have been or are currently connected or tangentially related to the violation. Once user 200a confirms the violation, a report is generated. Data collection module 505 of server 500 then receives the violation report over network 600 initiated by user 200 and then stores the violation report in the user profile database 400 and community database 405. The violation report along with any associated data including photos, videos, and file attachments, may then transmitted to property manager user computing device 255 of property user manager 205 for presentation via property manager user interface 305 to view report violations. In one or more non-limiting embodiments the violation report may instead be any criminal activity whereby user 200a may submit a photo or video of the crime in a similar manner to the violation report, as well as any additional information whereby after user 200a submits report, data collection module 505 receives the report and transmits the report for presentation to another user 200 such as a call center, police station, or other entity designated for the specific crime. User 200a and call center or police station may also communicate through the communication interface of residential management subsystem 120 on smart community system 100.

In one or more non-limiting embodiments of residential management subsystem 120, users 200 may request a work order in the community network that is viewable by the property manager user 205. It is important for property managers, a homeowners association, and board members to assist homeowners or residents with their problems as well as maintain a healthy relationship between one another.

Residential management subsystem 120 may provide multiple options for users 200 to request work orders in the community network. A work order may be from a user 200 request or created by property manager user 205, administrator 700, or a third party. Work orders may be created as follow ups to inspections or audits conducted by property manager user 205 or a third party. A work order may be for any type of goods, products, and services. To request a work order, user 200 may begin by initiating a session over network 600 with user computing device 250. Data processing module 525 then accesses the user profile stored on user profile database 400 for user 200. Data processing module 525 then requests and receives data pertaining to the specific location of where user computing device 250 is located. If user 200 wishes to enter a new work order request, user interface 300 may present an option to create a new work order for user 200.

After selecting this option user 200 may be presented with a screen on user interface 300 to enter information pertaining to the work order including the type of work order. User interface 300 may also provide user 200 with ability to upload associated data including any file attachments, image, or videos directly from camera on user computing device 250 or photo library stored on user computer device 250. Once submitted by user 200, data collection module 505 then receives the work order initiated by user 200 over network 600 and then stores the work order in user profile database 400 and community database 405, where it may be viewed by property manager user 205 and administrator 700. The work order along with any associated data including photos, videos, and file attachments, may then transmitted to property manager user computing device 255 of property manager user 205 for presentation via property manager user interface 305 to view work orders.

In one or more non-limiting embodiments of residential management subsystem 120, users 200 may request an approval of something in their community network that may be transmitted to property manager user 205. Homeowners typically have numerous types of additions and changes they wish to make to their house and the surrounding area that first need to be approved by the homeowners association. Usually this requires a representative from the homeowners association going to each house and inspecting for the item or object to be approved. This can be quite burdensome and costly.

Residential management subsystem 120 may provide multiple options to request approvals in a community network. An approval may be from a user 200 request or created by property manager user 205 after discussing with the user 200 as well as administrator 700. An approval may be for any type of person, place, or thing including but not limited to a roof, a pet, a new baby, or a boat. To request an approval, user 200 may begin by initiating a session over network 600 with user computing device 250. Data processing module 525 then accesses the user profile stored on user profile database 400 for user 200. Data processing module 525 then requests and receives data pertaining to the specific location of where user computing device 250 is located. If user 200 wishes to enter a new request, user interface 300 may present to user 200 an option to create a new request for an approval. After selecting this option user 200 may enter information pertaining to the approval including the type of approval and any additional information about the request for approval.

User interface 300 may also provide user 200 with ability to upload associated data including any file attachments, image, or videos directly from camera on user computing device 250 or photo library stored on user computer device 250. After user submits the request for approval, data collection module 505 receives the request for approval over network 600 initiated by user 200 and then stores the request for approval in user profile database 400 and community database 405. The request approval along with any associated data including photos, videos, and file attachments, may then transmitted to property manager computing device 255 of property manager 205 for presentation via property manager interface 305.

In one or more non-limiting embodiments a user 200 may place an identification device on the source or associated article connected with the violation, work order, or approval. The identification device may be a QR code or bar code with a GPS locator placed inside whereby data processing module 525 of residential management subsystem 120 may track the location of the identification device. This may be useful if extra approval or verification is needed whereby by either a drone or other automated device may be dispatched to the location of the identification device to review the entity on which the identification device is placed or positioned. For instance if a user 200 wishes to have the color of their new porch swing approved user 200 may place an identification device on the top surface of the porch swing.

The identification device may be connected to network 600 and have a switch whereby when the switch is turned on, property manager user 205 may receive a notification through property manager user interface 305 that the switch has been turned on and where the location of the device is. Property manager user 205 may then send out a drone or employee personnel to the location of the identification device. User 200 may also be presented through user interface 300 with an option to manually notify property manager user 205 that identification device has been placed on an entity they wished to have further examined by property manager user 205. This may very useful when a homeowner user 200 places the identification device on an entity that is associated with a work order user 200 submitted whereby a dispatched handyman may receive a notification and better identify the correct entity associated with the work order. For instance if there are multiple toilets located on a property, the handyman would know the correct toilet that needs to be repaired based on the GPS location of the identification device.

After logging on to the private network and initiating a session on residential management subsystem 120, property manager 205 may be presented with a screen through property manager user interface 305 which shows the total number of violations, work orders and approvals for the specific community network as well as allowing property manager 205 to scroll through and select violations, work orders, and request for approvals. Property manager interface 305 may provide a list of multiple properties or groups if property manager 205 has multiple community association properties, sites, or locations.

If property manager user 205 wishes to enter a new approval, violation, or work order or inspection, property manager user interface 305 may provide property manager user 205 the option to create a new case whereby then property manager user 205 may then select whether they wish to request an approval, request a work order, or report a violation in a similar fashion to the user 200. Data collection module 505 then receives the new case over network 600 initiated by property manager user 205 and then stores the case in the database in user profile database 400 and community database 405. The new case along with any associated data including photos, videos, and file attachments, may then transmitted to any user computing device 250 of user 200 for presentation via user interface 300.

Property manager interface 305 may also present property manager 205 the ability to generate cases for new violations, requests for approvals, and work orders whereby the report may be generated utilizing templates one or more templates for contracts stored on contract database 435, contract database 435 having a collection of homeowners association contract documents such as violation, work orders, approvals, or other requests. Using user interface 300 the documents may be compiled automatically by information gather from user profile databases 400 or information entered by property manager 205 or other users 200. This provides an effective and intuitive automation of documents without property manager 205 having extensive knowledge of the contracts such as these. In some embodiments reports generated from templates may be transmitted to users 200 through smart community system 100 or mailed directly to user 200 or transmitted to homeowners association community network.

Property manager 205 may select a specific category such as violations, work orders, or requests for approvals, property manager 205 may then be provided with options through the property manager user interface 305 to filter the violations, work orders, or approvals by pending or completed. If a particular violation, work order, or request for approval is selected from the list, property manager user interface 305 may then display all related information pertaining to that particular case, including address, related users, type, time and date the case file was sent and received. Property manager user interface 305 may also present property manager user 205 the ability to select users 200 such as a homeowner associated with the particular case and display all other cases associated with user 200.

If the selected case is a request for approval, property manager user 205 may then approve or reject the request for approval as well as ask for any additional information from user 200 utilizing communication interface of residential management subsystem 120. Different users 200 that are with property manager user 205 in the homeowners or property management class of community network may be synced together and see updates and posts from other users 200 who have entered violations, work orders and requests for approvals. Users 200 may also see status updates for violations, requests for approvals, and work orders that have been updated by property manager user 205.

If the case selected is a violation, property manager user 205 may then view the violation from a user 200. Property manager user 205 may confirm a violation has occurred or reject the violation as well as input any additional information on their own pertaining to an associated user 200 that has committed the violation or any related parties. Data collection module 505 then receives the violation and additional information over network 600 initiated by property manager user 205 and then stores the violation and additional information in user profile database 400 and community database 405. The violation along with any associated data including photos, videos, and file attachments, may then transmitted to the associated user 200 who committed the violation for presentation via user interface 300 whereby user 200 may object to the violation or acknowledge they have committed the violation. Any updates to the violation may then be stored on user profile database 400 and community database 405 and transmitted to other parties for them to respond.

In one or more non-limiting embodiments property manager user 205 may input through property manager user interface 305 the action to be taken as well as date the violation that must be corrected. This may be automatically calculated by data processing module 525 based on data collected by data collection module 505 and stored in community database 405 whereby when property manager user 205 enters the type of violation into the property manager user interface 305 by a selecting a violation from a drop down menu or by entering the violation into a text box, data processing module 525 may determine the appropriate action to be taken. This action then may be displayed to user 200 who is in violation of the rules as well as property manager user 205.

In one or more non-limiting embodiments user 200 who committed the violation may be presented with a remedy screen in user interface 300 whereby user 200 may submit photos, videos, and file attachments to show that the violation has been remedied. The remedy with any associated data including photos, videos, and file attachments, may then transmitted to property manager user computing device 255 of property manager user 205 member for presentation via property manager user interface 305

If the case selected is a violation or work order, data collection module 505 receives the violation work order report and additional information over network 600 initiated by property manager user 205 and then stores the violation or work order and additional information in the user profile database 400 and community database 405. The violation or work order report along with any associated data including photos, videos, and file attachments, may then transmitted automatically by data processing module 525 to appropriate handyman computing device 256 of handyman user 206 for presentation via handyman user interface 306.

When requesting for a handyman user 206 to help remedy with a violation or work order, property manager user interface 305 may present property manager user 205 with entry fields for information such as but not limited to the type of violation or work order, the date and time of the work order, the current status of the project based on how much user 200 or another handyman user 206 has accomplished, the priority level, an estimated rate, and whether the user 200 has to pay the entire amount or property manager user 205 will be paying a share, as well as if the user 200 should be afforded a discounted rate. Reports may be generated for work order from contract database 435.

Property manager user interface 305 may then present property manager 205 with selectable option to post work order that may be viewable to handyman users 206. Property Manager 205 may also set criteria for the work order request including the distance handyman users 207 may be from property manager's 205 location, location of the violation or work order, as well as which qualifications they may require. In one or more non-limiting embodiments property manager 206 may select a bidding option whereby instead of automatically being selected for the request handyman users 206 may instead be inserted into a bidding process whereby property manager interface 305 may present to property manager 205 a list of potential handyman users 206 where property manager 205 may then select a specific handyman user 206 from the list based on their bid and other information about them. Handyman user interface 306 may present options with ability to upload photos of the work order or violation completed as well as notify other parties the task has been completed. This will be discussed later in the description where the principle is not only used with violations and work orders but all kinds of service work.

In one or more non-limiting embodiments property manager user interface 305 may provide property manager user 205 the ability to create lists of internal resources or external vendors by predefined skillsets that may be assigned to assist in the violation work order. Property manager user 205 may also receive work order or violation progress as well as gathered metrics on outstanding and completed work orders from data processing module 525 of server 500 utilizing updated information from various handymen users 206.

In one or more non-limiting embodiments, smart community system 100 may have a handyman service subsystem 125 whereby users 200 may search for and request any service provider users 207 providing goods and services, not just limited to the residential management subsystem 120. Service provider users 207 may be searched for directly by users 200 or recommended by other users 200 whereby user 200 may request the services of a service provider user 207 and track their location in real time, verify they are indeed the appropriate service provider user 207 and not a fraudulent entity or an imposter, and receive commission or other awards for recommending another user 200 to a specific service provider user 207.

One of the main goals for service providers is to reach out to a broader range of customers and expand their businesses. To do this service providers purchase advertisements in newspapers, yellow pages, on television or radio, or on the internet with websites such as Craigslist® or directed ads on searches such as Google®. However, customers are more likely to listen to a friend or someone else they trust. Furthermore, customers are usually creatures of habit and may not wish to work with services providers they know little about or don't feel safe working with. For example, a customer may not just want anyone to work on their home after they leave for work and the service provider is left alone with the customer's pets.

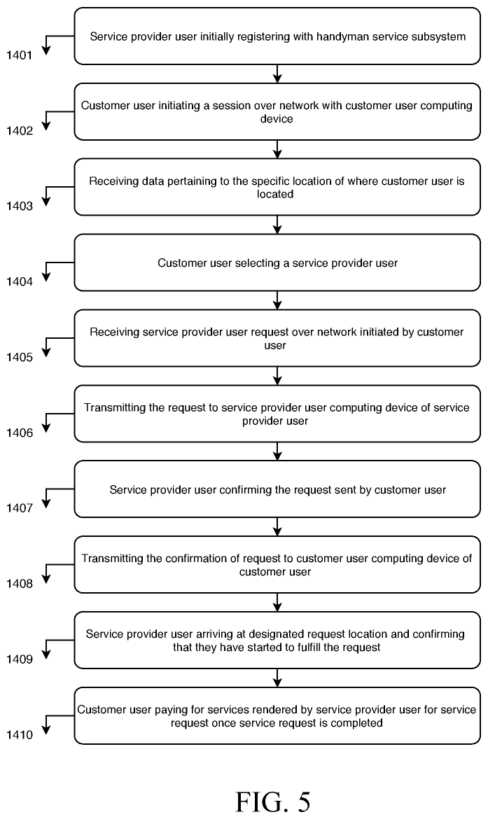

Turning to FIG. 5, FIG. 5 depicts a flow diagram showing an embodiment of an exemplary method for implementing handyman service subsystem 125 on smart community system 100. Handyman service subsystem 125 may have one or more components, such as, without limitation, service provider user computing device 257 and customer user computing device 258, networks. Further, one or more exemplary method steps may be performed by smart community system 100 including server 500, service provider user computing device 257, customer user computing device 258, which may be interconnected via network 600.

At step 1401, a method may include service provider user 207 initially registering with handyman service subsystem 125, for the purpose that customer users 208 may be able search for service provider user 207 and request their services. Upon initially signing up handyman service subsystem 125, service provider user 207 may select an industry their available jobs are associated with and the location the job will be located at as well as any additional information such as a service provider profile, sub-industry, curriculum vitae, insurance details, registration, licenses, referrals, testimonials, and payment information for when customer users 208 are sending payment for the services provided by service provider user 207.

When registering with handyman service subsystem 125, service provider user 207 may be able to log into handyman service subsystem 125 using login credentials from other platforms such as their work enterprise application. Service provider user 207 may navigate through handyman service subsystem 125 through a service provider user interface 307 where they may be presented with a dashboard whereby they may see summaries of their activities as well as their pending service requests, completed service requests, and referrals by customer users 208. Service provider user interface 307 may present service provider user 207 with availability on/off selectable button. When availability is on, service provider user 207 is available to fulfill service requests, while when off they are shown as not available or are not visible to customer users 208.

At step 1402, a method may include a customer user 208 initiating a session over network with customer user computing device 258. Session may be initially started by customer user 208 launching and running handyman service subsystem 125 on customer user computing device 258 installed by customer user 208 through a manufacturer prescribed process such as downloading smart community application 102 from an application store or smart community system 100 may be preinstalled by the manufacturer or designer. In one or more non-limiting embodiments customer user 208 may navigate to a specific web address to initiate a session.

After registering and initiating a session on handyman service subsystem 125 of smart community system 100, customer user interface 308 may present customer user 208 with options to view posted service requests, completed service requests, view service provider users 207 recommended by friends of customer user 208, and the option to search for a service provider user 207.

At step 1403, the exemplary method may include data collection module 505 receiving data pertaining to the specific location of where customer user 208 is located while data processing module 525 may send a data request to customer user computing device 258, displayed through the customer user interface 308, for identifying a geographic location of customer user computing device 258 or a network location of customer user computing device 258, as well as a timestamp identifying when the request was transmitted to customer user computing device 258. The geographic location may be any physical location, which may be expressed in longitudinal and latitudinal coordinates, and may include other dimensions and factors such as altitude or height for determining an exact position of the geographic location.

At step 1404, the exemplary method may include customer user 208 selecting a service provider user 207. After selecting an option to search for a new service provider user 207, customer user 208 may then be presented with a searchable text window to insert text.

In one or more non-limiting embodiments, customer user 208 may search for a specific service provider user 207 using a name or category to locate service provider user 207. For example, a search request having a character string may be entered whereby one or more service provider users 207 may be identified using name, type of goods and/or services provided, or other metadata. Further, the closest service provider user 207 matching the search request may be presented predominantly on customer user interface 308 that is located within some threshold distance of the customer user's 308 current geographic location. For example, if customer user 208 wants to locate a nearby plumber for their services associated with handyman service subsystem 125, customer user 208 may type “plumbing” with a search request through customer user interface 308. Server 500 may access user profile database 400 and return a list of nearby plumbers. In another example, if customer user 208 wants to locate a plumbing business name named “Chuck's plumbing” for using their services associated with handyman service subsystem 125, customer user 208 may type “Chucks” with a search request through customer user interface 308. Accordingly, a list of nearby plumbers named “Chuck” may be provided to customer user 208 in response to their search.

Customer user 208 may input additional text or changes to the existing search request through customer user interface 308 to receive an updated list of service provider users 207 based on the newly entered text. The search request may also include other parameters, such as categories, price, distance, and already visited service provider users 207. Further, in one or more non-limiting embodiments, these parameters as well as others may be automatically factored in when a search request is conducted. Customer user interface 308 may provide the ability to adjust and select parameters, that may be used to filter and/or rank the results of service provider users 207 displayed to customer user 208.

In one or more non-limiting embodiments a map may be also displayed to customer user 208 based on customer user's 208 determined location by server 500 whereby various service provider users 207 may be displayed as markers, pins, or identifiers at their respective locations on the map. Service provider users 207 may also be displayed on customer user interface 308 as a list or a drop-down menu. In other non-limiting embodiments, customer user 208 may input zip codes, city, county, state names, landmarks or other important locations through the search window of customer user interface 308 whereby customer user 208 is then presented with all service provider users 207 registered and stored within user profile database 400 of server 500 that are in the general area or in near proximity to customer user's 208 geographic location or the location customer user 208 has elected.

After selecting a service provider user 207, customer user 208 may be presented with additional information pertaining to service provider user 207 as well as categories of customer users 208 who have recommended service provider user 207. Categories may be divided up by friends of customer user 208 on smart community system 100 or linked third party applications or all users 200 who have recommended or reviewed service provider user 207. Specific services of service provider user 207 may also be displayed on customer user interface 308 as a list or a drop-down menu. Customer user 208 may also wish to enter additional information about the services they require in a text box window.

Customer user 208 may then confirm they wish to utilize this service provider user 207. In one or more non-limiting embodiments customer user interface 308 may present customer user 208 with selectable option to post a service request that may be viewable to service provider users 207. Customer user 208 may also set criteria for the service request including the distance service provider users 207 may be from their location as well as which qualifications they may require. In one or more non-limiting embodiments customer user 208 may select a bidding option whereby instead of automatically being selected for the request service provider users 207 may instead be inserted into a bidding process whereby customer user interface 308 may present to customer user 208 a list of potential service provider users 207 where customer user 208 may then select a specific service provider user 207 from the list.

At step 1405, the method may include data collection module 505 of server 500 receiving service provider user 207 request over network 600 initiated by customer user 208 on customer user interface 308 and storing the request in a user profile related to customer user 208 in user profile database 400.

At step 1406, the method may include may include transmitting the request to service provider user computing device 257 of service provider user 207 via service provider user interface 307 to service provider user 207 for viewing. Service provider user 207 may also receive notifications by email, text, or through service provider user interface 307 of requests meeting certain criteria based on information in user profile database 400 as well as view requests through service provider user interface 307 that have been listed by customer users 208. In one or more non-limiting embodiments service provider user 207 may automatically receive the request if they have opted in to settings on smart community system 100 allowing the appointment booking subsystem 155 (which will be discussed later in the description) to automatically hire service provider user 207. Service provider user 207 may view the request and details as well as cancel a request

At step 1407, the exemplary method may include service provider user 207 confirming the request sent by customer user 208. Once confirmed by service provider user 207, the request may appear to service provider user 207 on a list of pending service requests.

At step 1408, the method may include may include transmitting the confirmation of request to customer user computing device 258 of customer user 208 for presentation via customer user interface 308 to be displayed as a pending job request. Customer user 208 may view the request and details as well as cancel a request.

At step 1409, the exemplary method may include service provider user 207 arriving at designated request location and confirming through service provider user interface 307 that they have started to fulfill the request. Customer user 208 may be presented through customer user interface 308 the location of service provider user 207 to track the current position of service provider user 207 well as obtain updates from service provider user 207 such as pictures and videos such as the photo of the completed project. In one or more non-limiting embodiments, all parties including customer user 208 and service provider user 207 may be entered into a group chat to communicate with one another.

In one or more non-limiting embodiments data processing module 525 may identify the location of service provider user 207 to confirm they are at the location of the job shift. Data processing module 525 then transmits a code through email or text whereby service provider user 207 and customer user 208 may verify they are indeed the appropriate parties for the service request. In one or more non-limiting embodiments customer user 208 may be presented with a text window to insert a code. Once entered, code may be transmitted to server 500 and then to service provider user 207 whereby service provider user 207 may display code to customer user 208 whereby customer user 208 may verify to see if the code on service provider user computing devices 257 matches the generated code by customer user. 208 In other non-limiting embodiments service provider user 207 may instead generate the code while customer user 208 displays code to service provider user 208 for verification. After verifying the code customer user 208 may confirm this is the appropriate service provider user 207 and not an imposter. In some embodiments code may be generated by data processing module 525 and sent to service provider user 207 or customer user 208 as well as both parties. In other embodiments the method may include customer user 208 arriving at the location of service provider user 207 instead of a requested designated location.

At step 1410, the exemplary method may include customer user 208 paying for services rendered by service provider user 207 for service request once service request is completed. Customer user 208 may be presented with option to pay service provider user 207. Data processing module 525 may then process the appropriate payment whereby the transaction is completed and payment is transferred from service provider user 207 to customer user 208. In some non-limiting embodiments payment may be transferred to service provider user 208 at different times or increments. Alternative transaction terms may also be determined in handyman service subsystem 125 whereby a certain amount may be added or a fee may be assessed if service provider users 207 or customer users 208 cancels service request.

Further elaborating on the principles just discussed, users 200 may not only identify and verify service provider users 207 but any other users 200 or any other entities in smart community system 100 by generated verification codes. For example, if a bank calls user 200 and identifies themselves as the bank user 200 is registered with, user 200 may select a selectable button whereby user 200 or data processing module 525 generates a code that is presented to the bank through user interface 300 or transmitted audibly by a digital voice assistant to the bank. Bank then may recite this code to user 200 which user 200 may manually verify. In other non-limiting embodiments a text window may be presented to bank whereby bank may enter the code. Data processing module 525 then may verify if the inserted code matches with the generated code and notify user 200 if the verification was successful or the bank if fraudulent. Smart community system 100 may then provide user 200 with additional options through user interface 300 such as recording the conversation between bank and user 200 as well as selecting a button to notify the proper authorities.

In one or more non-limiting embodiments handyman service subsystem 125 may also utilize a referral subsystem such as referral subsystem 155 to incentivize customers users 208 of handyman service subsystem 125 to refer other customer users 208 to promote or recommend service provider users 207 whereby service provider users 207 pay referral commission to a referring member for initiating others customer users 208 to request their services. Service provider user 207 may be promoted, recommended, referred and/or offered by a referring customer user 208 or another party. Customer user 208 may post a question asking for recommendations for a service provider user 207 whereby the question is transmitted to referring customer users 208 who may then post service provider users 207 they believe are best suitable for customer user's 208 needs whereby customer user 208 may then select the recommended service provider user 207.

When customer user 208 selects the link from a referring customer user 208 pertaining to a service provider user 207, this selection along with the referring customer user 208 may be presented to service provider user 207 whereby if referred customer user 208 does indeed request service provider user's 207 service, a payment commission may automatically be sent to referring customer user 208 or in one or more non-limiting embodiments may manually be sent to referring customer user 208 by service provider user 207. In further embodiments customer user 208 may select and view a review by another customer user 208 and be presented with a choice to select a service provider user 207, whereby reviewing customer user 208 may be presented to service provider user 207 for automatic or manual payment commission. In further embodiments customer user 208 may also be presented with option to insert another customer user 208 that recommended service provider user 207 whereby service provider user 207 may view the recommending customer user 208. In further embodiments a referring customer user 208 may also be presented with option to refer another customer user 208 a service provider user 207, whereby service provider users 207 are searchable through customer user interface 308 and may be displayed on a map or drop down list.

In some non-limiting embodiments users 200 of a community network may purchase goods or services from one or more service provider users 207 whereby service provider users 207 may be presented the community network as a shopping grocery cart through service provider user interface 307. This allows service provider users 207 to provide marketing deals and advertisements to community networks as a whole as well as deliver to community networks in bulk, thus eliminating the need for multiple trips and deliveries to individual users 200.

In further embodiments service provider users 207 may be presented with the reviews of how well their services are as reviewed by customer users 208 or reviews collected by data collecting module 505 from outside sources. Data processing module 525 may determine the reason service provider user 207 has a low rating using artificial intelligence or any method known by those of ordinary skill in the art. Administrator 700 may also provide assistance to service provider user 207 through communication interface. Service provider user may also be presented with options such as setting goals.

Using a combination of methods discussed above, customer user 208 may purchase goods or services from one or more service provider users 207 whereby service provider users 207 may be presented with the location of customer user 208 through service provider user interface 305 as well as the distance of customer user 208 from the location of service provider user 207 place of business. The location of customer user 208 may be determined by customer user computing device's 258 location or sensors on a vehicle or a road, connected to network 600. This allows service provider users 207 to operate more efficiently and provide customer user with the best quality goods or services. Such as if service provider user 207 is a pizza company, they will know the location of customer user 208 and thus can provide fresher pizza to them based on their location. Service provider user 207 may upload information into user profile database 400 whereby data processing module 525 may determine the tasks that need to be completed based on customer user's 208 location which is then displayed to service provider user 207 or agents of service provider user 207.

In another example service provider user 207 may receive a request from customer user 208 for goods whereby they may place the goods in a kiosk or other connected device to network 600 when customer user 208 is getting near service provider. Once goods are place in kiosk, data processing module 525 may generate a code that is displayed to customer user 208 through customer user interface 308 to insert to access kiosk. Customer user 208 may then enter service provider user 207 place of business and go directly to the kiosk, enter the generated code, and remove the goods from the kiosk and leave the place of business. In further embodiments smart community system 100 may connect to a service provider user 207 database whereby customer user 208 may capture pictures of a specific good or insert into user interface a specific good they wish to request because service provider user's 207 place of business does not have the specific size or color available but are available online through service provider user 207. Customer user 208 may then be presented with option to pay for good using a credit card, from their social account, or directly at the store. The good may then be mailed to customer user 200 or delivered to service provider's 207 place of business for customer user 208 to pick up.

In one or more non-limiting embodiments, smart community system 100 may have a monitoring service subsystem 130 whereby users 200 may have their home, neighborhood, vehicle or any object monitored by administrator 700 or monitored by another user 200. The term home may be but is not limited to a single residence housing, duplex, dormitory, apartment, condominium, or any type of real estate such as multi-unit dwelling, both residential and commercial, and all other forms of personal and/or commercial real estate. When a user 200 is away from their home it may be important to monitor the property for not only environmental damage but also crime related problems. Also when buying property it is not always feasible to visit the property ahead of time to monitor the actual property and surrounding area to see if you are receiving what is specified in the contract or just to have further assurance that you are making the correct choice. Monitoring service subsystem 130 allows users 200 to request video, audio, appraisals, and other information from neighbors as well as users 200 who may be at a specific location such as property that is sought to be purchased by user 200.

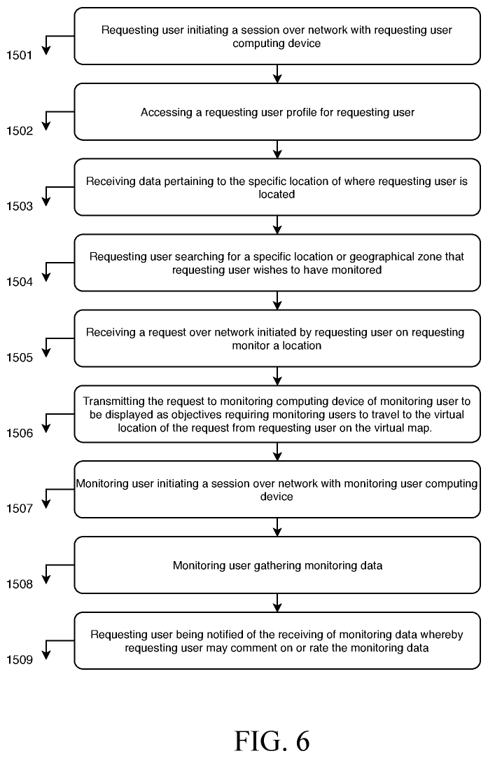

Turning to FIG. 6, FIG. 6 depicts a flow diagram showing an embodiment of an exemplary method for implementing the monitoring services subsystem 125 of smart community system 100. Monitoring services subsystem 125 may have one or more components, such as, without limitation, monitoring user computing device 259 and requesting user computing devices 260. Further, one or more exemplary method steps may be performed by smart community system 100 including server 500, monitoring user computing device 259, and requesting computing devices 260, which may be interconnected via network 600.

At step 1501, a method may include a requesting user, such as requesting user 210 initiating a session over network with requesting user computing device 260. Session may be initially started by requesting user 210 launching and running smart community application 102 on requesting user computing device 260 installed by user through a manufacturer prescribed process such as downloading smart community application 102 from an application store or smart community application 102 may be preinstalled by the manufacturer or designer. In one or more non-limiting embodiments requesting users 210 may navigate to a specific web address to initiate a session.

At step 1502, the method may include accessing a requesting user profile for requesting user 210. In one embodiment, the requesting user profile may reside in user profile database 400 on server 500, which may be accessed by data processing module 525 and referenced using an identifier provided by requesting user 210 as part of the registration process or login process such as an account name and password.

At step 1503, the method may include data collection module 505 receiving data pertaining to the specific location of where requesting user 210 is located. Data processing module 525 may send a data request to requesting user computing device 260, displayed through requesting user interface 310, for identifying a geographic location of requesting user computing device 260 or a network location of requesting user computing device 260, as well as a timestamp identifying when the request was transmitted to requesting user computing device 260. The geographic location may be any physical location, which may be expressed in longitudinal and latitudinal coordinates, and may include other dimensions and factors such as altitude or height for determining an exact position of the geographic location.

At step 1504, the method may include requesting user 210 searching for a specific location or geographical zone that requesting user 210 wishes to have monitored. For example, a search request having a character string may be entered whereby one or more locations may be identified using name or other filters. Requesting user 210 may also be presented with a searchable map through requesting user interface 310 whereby requesting user 210 may select a location they wish to have monitored or observed. Once a location has been identified or selected by requesting user 210, requesting user 210 may be presented possible selections that are associated with what type of services requesting user 210 wishes to have for the location such as but not limited to 24 hour monitoring and specific location monitoring on the home or surrounding area.

Requesting user 210 may also view videos, photos, or other files on map that have already been added by a monitoring user 209 as monitoring content spaces overlaid on the map. Monitoring content may vary with the display region and zoom level of the map or are independent of the characteristics of the map. Requesting user 210 may also share comments and opinions about locations or real property that are visible and searchable on the map whereby these comments may be linked to requesting user's 210 profile or may be posted anonymously depending on what the requesting user 210 chooses. Requesting user 210 may also provide ratings to the real property or location that is being monitored as well as pictures and videos uploaded by a monitoring user 209.

At step 1505, the method may include receiving a request over network 600 initiated by requesting user 210 on the requesting user interface 310 to monitor a location.

At step 1506, the method may include may include transmitting the request to monitoring computing device 259 of monitoring user 209 for presentation via monitoring user interface 309 to be displayed as objectives requiring monitoring users 209 to travel to the virtual location of the request from requesting user 210 on the virtual map.

At step 1507, the method may include monitoring user 209 initiating a session over network with monitoring user computing device 259. Data processing module 525 then accesses the monitoring user profile for monitoring user 209 stored on user profile database 400 and receives data pertaining to the specific location of where monitoring user 209 computing device is located. Data processing module 525 may verify monitoring user computing device 259 is in the correct location. Monitoring user 209 may be presented with a geo-spatial environment having a virtual map of the geographical location in which monitoring user 209 is positioned. The virtual map may have geography and topography, which parallels the geography and topography of the physical real world. For instance a range of longitudinal and latitudinal coordinates defining a geographic area or space in the real world may be mapped to a corresponding range of longitudinal and latitudinal coordinates defining a virtual space on the virtual map as well as each individual coordinate in the range.

The range in the real world may be associated with a homeowners association neighborhood, apartment complex, university, town, or any other region of space including the entire. A monitoring user's 209 position on the virtual map corresponds to the monitoring user's 209 position in the real world. For instance, monitoring user 209 may be located at the local police department in the real world, which has a corresponding position on the virtual map pertaining to the local police station. While receiving data pertaining the specific location of monitoring user 209, data processing module 525 may analyze the monitoring user's 209 position as monitoring user 209 navigates the range of geographic coordinates in the real world such as when monitoring user 209 moves throughout the neighborhood. Monitoring user interface 309 may also provide monitoring user 209 with ability to upload an image or a video directly from camera on monitoring user computing device 259 or photo library stored on monitoring user computer device 259.

In one or more non-limiting embodiments, monitoring user 209 may be using an electronic pair of glasses or smart glasses that are capable of reflecting smart community system 100 and monitoring services subsystem 130 as well as allowing monitoring user 209 to see the real world thus being able to view both simultaneously whereby images or video may be captured by a camera located on the glasses for 360 degree monitoring of the requested location. Audio may also be taken by a microphone or other audio input device located on the speaker of the electronic glasses.

In one or more non-limiting embodiments instead of monitoring user 209 traveling to the location physically, a drone or other automated device may be dispatched to the location to collect the requested monitoring data. In further embodiments monitoring services subsystem 130 may be a service provided by one or more service providers users 207, other users 200, or administrator 700 or outside hosting sites instead of monitoring users 209.

At step 1508, the method may include monitoring user 209 gathering monitoring data as part of the monitoring services subsystem 130. Monitoring user 209 may collect the monitoring data by traveling to the corresponding location of the requested location by requesting user 210 and satisfying the requirements of requesting user 210. In one or more non-limiting embodiments monitoring data may be collected for monitoring user 209 to receive real world payment whereby a predetermined percentage of a fee paid by requesting user 210 for monitoring services may go to administrator 700 or hosting site with the remainder allocated as payment for monitoring user 209. The amount allocated for monitoring user 209 may be credited to an account previously established by a monitoring user 209 such as their social account on smart community system 100.

At step 1509, the method may include requesting user 210 being notified of the receiving of monitoring data whereby requesting user 210 may comment on or rate the monitoring data. In one or more non-limiting embodiments monitoring users 209 may be limited to users 200 that are on the same private network or community network as requesting user 210 or have been verified to live within the geographical restraints as requesting user 210. In further embodiments requesting user 210 may limit their request to monitoring users 209 of a specific skill or pedigree such as only certified property appraisers whereby they are the only ones able to view the requests on map.

Monitoring services subsystem 130 may also work in conjunction or separate to property sale subsystem 135 of smart community system 100. For instance a user 200 who wishes to sell their property may be provided the option through user interface 300 to create a listing for their property that is visible to other users 200 through user interface 300. When creating a listing, user 200 may be prompted to provide information about the property such as the address of the property, numerical range data, such as minimum and maximum price for the target listing, any photographs or videos of the property in order to more fully inform a buyer about the property, as well any additional information such as the deed, ownership, property reports, and appraisal ratings.

Seller may also upload an interactive floor plan utilizing a series of sensors to capture the 3D viewing area of the floor plans and each individual room as well as any information about amenities or other utilities displayed in apartment listings commonly known by those ordinary skill in the art. Upon completion of entering the information, the seller may submit the registration, whereby the property listing is collected by data collection module 505 of server 500 whereby the listing may be displayed for presentation to potential buyers through user interface 300. Buyers may be presented with this listing through a scrollable and search map interface or via a search box whereby the buyer may input key words whereby data processing module 525 may return results of listings that meet the criteria. In one or more non-limiting embodiments administrator 700 or hosting site may also create listings in a similar fashion to the seller for selling their own property or other holdings.

While searching for listings, buyer may be presented with options for selection criteria in order to locate a property that best suit the buyer's needs. For instance the filters may be, but are not limited, to whether buyer is looking for a residential or commercial property, the price range and location for the property (either by zip code, neighborhood, city, state country), religious references, school zone district, amentias such as a pool or tennis court, a required or desired range of number of bedrooms and bathrooms. After selecting the appropriate search criteria, buyer may initiate a search to view uploaded seller property listings or other created listings.

Smart community system 100 may also utilize artificial intelligence to refine the search process. For example, data processing module 525 may utilize information from user profile stored on user profile database 400 of server 500 to determine the best suited property for the buyers needs such as if the buyer is a married woman who recently gave birth to twins might needed a larger house or if buyer believes in a certain religion doctrine such as Vatsu that requires homes to be facing in a certain direction. Smart community system 100 may also provide options for making an offer on a home, negotiating the offer between buyer and seller through the communication system, and closing the deal on the property whereby the buyer and seller may digitally sign the contract and receive notifications and verification of completed sale.

Data processing module 525 may generate an overall score and sub scores for various forms of property available on smart community system 100 utilizing the information stored on user profile database 400 of server 500 and information collected by Data collection module 505 from third party sources and databases whereby the attributes may be sorted into clusters. The clusters are designed to help provide a better scored based on the specific user and improved search results for the user. The clusters may be weighted differently to determine the overall score and sub scores of a property as well as provide better search results when purchasing a property, the properties with a higher score displayed first to the user. An adjusted price may also be displayed to the user based on it the value of the property with the attributes needed based on how much it would have cost for the property to achieve that level of attribute if the property did not have those attributes. In other embodiments all attributes may be of equal weight and for users not having a preference in the type of property.

Attributes, or individual scores, that may be used in determining the scores of property include, for example a user's safety index based on accidents, crime, or neighbor alerts through smart community system. Attributes may include a street safety index calculated by the distance the street of the property is from streets having a predetermined amount of traffic over a certain time period. This may be directly based on the distance the property is from major roads whereby houses farther from major roads may score higher because of added safety of not having vehicles speed by the property. Attributes may include a traffic index based on the commute, travel, and destination of user's work as well as other places user has interacted with through smart community system. This attribute may also be based on the walking, running, and biking distance the property is from various points of interest such as a school or a work, whereby user may insert places of interest into user interface. Distance may also be calculated using techniques known by those ordinary skill in the art such as map track and traffic calculations.

Attributes may include a health index safety index based on allergies, air quality, insect population. Attributes may include a religious score index based on the qualities needed to accommodate those of different religions such as Vaastu shastra which relies on principles of design, layout, measurements, ground preparation, space arrangement, and spatial geometry. Attributes may include a climate index such as if a property has been destroyed due to extreme weather (hurricane, tornado, flood wildfire) and the likelihood of this happening again based on previous history. The climate index for wildfire may be determined on the density of the forest or environment still in the surrounding area. For example, a wildfire may not happen again if the tree density of a forest is so low a wildfire cannot be started.

Attributes may include a sunlight transmittance index based on the amount of windows, doors, or skylights and the ability of glazing in a window, door, or skylight to transmit sunlight. This attribute may be based may be generated based on the location of the sun in relation to the property and how much sunlight it receives during a typical day as well as other periods of time. An attribute may be based on the amount of air circulation the property receives such as a house having windows on multiple sides of the house would being rated higher than a house with windows on one side of the house. An attribute may be based on the surrounding wilderness or dangerous animal sightings, and any religious reasons. Other common attributes known by those of ordinary skill in the art for determining property value may also be integrated in combination with one or more of the attributes already listed.

Attributes may be sorted into one or more clusters utilizing the information stored of multiple users on user profile database 400 who have purchased a property through smart community system or have associated themselves with one or more pieces of property. For example, when a buyer is presented with options for selection criteria in order to locate a property that best suit the buyer's needs, the buyer may select “religious attributes” are important to them when purchasing a home. After choosing this selection criteria, buyer then may be presented with properties above or equal to predetermined religious index value. Eventually after buyer purchases the property from seller, data processing module 525 may determine which other attributes were important in the purchase by the buyer by analyzing which property was bought and the attributes of said property.

When a certain amount of properties are bought comprising a first and second attribute or score of the attributes is reached, a correlation may be determined, and the attributes may be grouped in a cluster. In this case there may be many properties with a suitable religious index so determining what other important attributes are considered when purchasing a property by one or more users may be useful when determining how future property listings may be displayed in a search to a user and how a weighted score for a user is generated. Attributes in the same cluster as the needs of the user may generate a higher score for properties having both attributes and the present the properties predominately in a search. Clusters having overlapping attributes may also be weighted higher. In some embodiments user's past purchases of properties may be even more highly weighted than the purchases of other users. A sub score may also be displayed in conjunction or replacing the overall score just focused on the one or more clusters having the attribute of a property the user is interested in when purchasing the property. In some non-limiting embodiments certain values may be omitted from the sales data. In one or more embodiments, missing values may be inputted using the median value of similar variables or factors, or the mode or most frequent values from other properties sold

In one or more non-limiting embodiments, property sale subsystem 135 may utilize the storage of a real estate property blockchain representing closing sale transactions of the home, furniture, appliances, automobiles, vehicles, or any other items associated with the property, whereby buyer and seller user may view the complete history of the property or other object. Construction and storage of the blockchain enables smart community system 100 to quickly and efficient validate or access data for the home using a series of connected devices that record the same event or transaction, thereby improving the safety of transactions knowing the previous history of the home as well enable real estate contracts, and property records to be completed and without title companies or attorneys.

The blockchain may also record the closing sale, title, or deed with the appropriate public records. The storage of blockchain continues by obtaining a historical block identifier of the homes historical blockchain. Once the various pieces of information have been collected, a validity requirement based on the transaction may be calculated whereby if the validity requirements are met, the historical blockchain may be updated.

In a similar fashion to parking services, property or homes may be rented out in a similar fashion to Airbnb® through smart community system 100 whereby properties may have a certain amount of designated areas for occupants to occupy. The properties may one or more sensors that send sensor data output signals. Data processing module of server may determine from sensor data output signal if an individual property is occupied by an occupant as well as how many available unoccupied properties are present which then may be indicated as available for another occupant. Data processing module of server also generate a map of a zone having one or more properties, with area availability overlaid on the map for indicating physical location information for each area that may be available to pet storage employee to quickly locate pet or area. Once data processing module determines a pet is no longer occupying an area, the pet owner of the pet may be billed, and the area may show as available.

Smart community system 100 may also have its own appraisal services subsystem 140 that may work in conjunction with the property sale subsystem 135 and monitoring services subsystem 130 to gather the current market value of the real estate or property to assist seller and buyer to better gauge how much the property cost. Currently appraisals are opinion based solely on the reasoning of the appraiser or web administrator, but do not factor in specific situations or circumstances that may affect the price of a property for an individual user or multiple users. Appraisal services subsystem 140 may not only be manually updated by an appraiser or administrator 700 but also data processing module 525 analyzes data concerning user's 200 preferences stored in user profile database 400 of server 500 in order to allow appraisal services subsystem 140 to target an optimal appraisal price for user 200.

Using information stored on user profile database 400 from server 500 such as user's 200 descriptive data, preference data, religious data, relationship data, and interest, data processing module 525 may provide a more accurate appraisal price. Appraisal services subsystem 140 may then display different prices based on user's 200 preferences to more accurately determine a fair price for the specific user's 200 needs. User interface 300 may also present one or more preference questions to further determine preferences one user 200 might have. For example, user 200 may indicate that she is looking for a home in a school district with a 5 star school for kindergarten so that user's 200 child may have a better education. Data collection module 505 collects this information and stores this preference in user profile database 400 whereby then data processing module 525 may analyze this information and display a more accurate appraisal price for user 200.

Data processing module 525 may visually determine with uploaded maps for database routes, distance, directions, and any objects corresponding to locations on a geographic map to provide a more accurate appraisal price, not commonly used by appraisers. Data processing module 525 may locate and identify factors that may affect the listing price of the property in general as well as based on user's 200 preference data stored on user profile database 400. For instance, data processing module 525 may analyze a geographic map for the distance that properties are from main roads or highways and if data processing module 525 detects that if the property is located in close proximity to a main street or highway relative to other properties, price of property may be reduced relative to neighboring properties that are at a farther distance from the main street. In other examples, data processing module 525 may locate and identify the amount of backyard area or how close a piece of property is to a retention drain, as well as the direction the property is facing. In some embodiments user 200 may add one or more entities such as a retention pond that may be displayed on map and factored in into appraisal price by data processing module 525.

When a property is sold to buyer through smart community system 100, buyer may additionally be provided the option to receive not only the property but also individual components or bundled services such as monitoring services, certified home offerings, property preservation services, as well as other service provider offerings, such as monthly cleaning, appliance services, insurance pest inspection, 360 degree monitoring, drone monitoring, or having constant automated requests visible to monitoring users on a virtual map. The price of the property may be displayed with or without the bundling of services. Instead of property this may also be for any other entity such as a vehicle or pet. These services may also be selected without the purchase of a property such as if user 200 requires these services for a home, property, or other entity, they already own. It should be appreciated that these services are not just limited to real estate property but may be any type of property whose location may currently be shown on a geographic map such as but not limited to an automobile, boat, refrigerator, television, or household pet.

In one or more non-limiting embodiments smart community system 100 may provide a monitoring agent or multiple monitoring agents such as monitoring agent user 220 to a user 200 who is purchasing a property or for an established property owner whereby monitoring agent 200 may assist user 200 in finding service providers as well overseeing the maintenance and security for the user as well as the property for a selected amount of years or the entirety of the ownership. Monitoring agent user 220 may be automatically selected by smart community system 100 or by user 200 manually after viewing the available choices of monitoring agent users 220 within a predetermined distance of user 200. Monitoring agent user 220 may be selected based on a bidding process. A monitoring agent may refer to an individual and/or a plurality of monitoring agent users 220 working together.

A preliminary process may determine if a monitoring agent meets one or more requirements of a user 200 such as location, price, associated service providers, before acting on the received information of the bundled services required by user 200 to then initiate a possible bid price for user 200. A monitoring agent may determine a bid to be placed regarding the one or more bundled services. The bid may be a flat fee or initial retainer fee for a starter price with additional fees added on as the situation arises, or any other combination for their fee. Selections for available monitoring agent users 220 may be presented to user 200 whereby they are sorted by distance to user 200 or property, as well as certifications, superlatives, ratings, references by other users 200 within smart community system 100. Winning monitoring agent users 220 may be selected and presented to user 200 whereby a contract may be generated where both parties may insert their signature through user interface 300. Data collection module 505 may then receive each signature whereby data processing module 525 combines the contracts into a single document that is then stored.

Monitoring agent users 220 may be associated with one or more service providers through smart community system 100 whereby they may choose service provider users 207 to aid user 200 in a service request. Monitoring agent may charge a flat fee to service provider users 207 for referrals of transactions with user and the shipping of items, the users not affected by the referral fees. Such a fee may include a flat dollar amount, a percentage, a fee based on a service level, a fee based on a number of services provided or goods ship that have referred by monitoring agent users 220. In some embodiments, service providers may not pay a base fee, but may be charged a percentage per transaction with each user 200 referred to service provider through smart community system. In some embodiments, a service provider may pay, for example, about 5% of the cost for the services provided. Based on the services needed selected by user 200 a contract may be automatically generated by data processing module 525 and then presented to service provider, monitoring agent, and user 200 whereby they may insert their signature through user interface 300. Data collection module 505 may then receive each signature whereby data processing module 525 combines the contracts into a single document that is then stored.

When user 200 is in need of multiple services or tasks that require more than one service providers, data processing module 525 may generate a hierarchical payment system between the multiple service providers associated with monitoring agent user 220 to provide services based on the individual subtasks provided by the providers for a specific task of user 200 based on their coverage plan. Monitoring agent user 220 may then receive a commission for the combined income generated from the individual subtasks from each of service provider users 207.

When users 200 have an associated monitoring agent assigned to them or their property for one or more services, user 200 may utilize them when requesting to have a problem associated with the property fixed in a similar manner to the HOA component of smart community system 100. Users 200 may input a service required for themselves or their property which then may be transmitted to monitoring agent who may then select one or more service providers to assess or remedy the problem.

When user 200 requires a service provider user 207, user 200 who has a coverage plan or associated with a monitoring agent may access a marketplace with a private channel supporting the providers associated with monitoring agent users 220. User 200 may input a request whereby the request is then transmitted to monitoring agent user 220 who may select a service provider user 207 or service provider users 207 associated with monitoring agent user 220 who may solicit bids for providing service to the user. The private marketplace may have a protocol for communication between the supply-side and demand-side platforms for matching bid requests and bid responses in order to provide user a service provider. This is beneficial to users 200 because of the established guarantees between service provider users 207 and monitoring agent user 220 so user 200 will be reassured they will have service provider users 207 of a certain quality. In some embodiments the marketplace may also be accessed by users of smart community system 100 who do not have a coverage plan with a monitoring agent user 220 through a second channel whereby user may insert the service required, the request for service transmitted to service provider users 207 within a predetermined maximum distance of user 200, who then may solicit a bid for their services.

As discussed later in the detailed descriptions service provider users 207 may also refer one another through smart community system 100 as well as provide suggestions or advice to other service provider users 207 whereby a credit point system may be established for service provider users 207 who assist in helping other service provider users 207. With the credit point system, service provider users 207 may receive rewards, notoriety, better search results, or be displayed service requests of users 200 at an earlier time than other service provider users 207. Service provider users 207 may also upload a picture or any other information related to the service requests of user 200 whereby other service provider users 207 may be presented this information when providing service to the user 200. In some embodiments this may limited to service provider users 207 associated with a monitoring agent user 220 while in other embodiments this may be accessed by every service provider on smart community system 100.

Once a service provider has been selected by monitoring agent user 220 and they are in route to assist user 200 with their service request, data processing module 525 may generate a single or multiple identification codes for presentation to user 200 and service provider user 207 to authenticate one another. User 200 and service provider may then audibly recite the code to one another whereby data processing module 525 may analyze if the proper identification code has been entered by both parties. User 200 may have a code discussed similarly in other sections whereby the code may only be changed through email of user 200 or one or more selected guardians. Service provider user 207 may only have a code generated when providing services to user 200. This is advantageous over prior art that only has one party receive the code to verify that they are the correct party. In some embodiments identification codes and the sharing of pictures and service history may also be utilized between one or more service provider users 207 such as employees in a company, franchise, or other entity. For example, history of an employee in a business may be accessed by different franchises operations within the company whereby the employee may share and access data with other franchises through the exchanging of identification codes. This process may also be utilized by HR so that employees may communicate with HR or another entity such as within a private kiosk or booth positioned inside an establishment so that they may safely exchange information with one another.

Smart community system 100 may present the location of service provider users 207 providing services and user 200. The presentation may be in the form of a pop up window displayed to user 200. Users 200 may also be presented with a geo-spatial environment having a virtual map of the geographical location in which service provider users 207 are located. The virtual map may have geography and topography, which parallels the geography and topography of the physical real world. For instance a range of longitudinal and latitudinal coordinates defining a geographic area or space in the real world may be mapped to a corresponding range of longitudinal and latitudinal coordinates defining a virtual space on the virtual map as well as each individual coordinate in the range. The graphical map may be displayed with service provider users 207 as markers, pins, or identifiers at their respective locations. Service provider user 207's position on the virtual map corresponds to their position the real world. Data processing module 525 may analyze service provider's position as they navigate the range of geographic coordinates in the real world such as when they are moving to their destination.

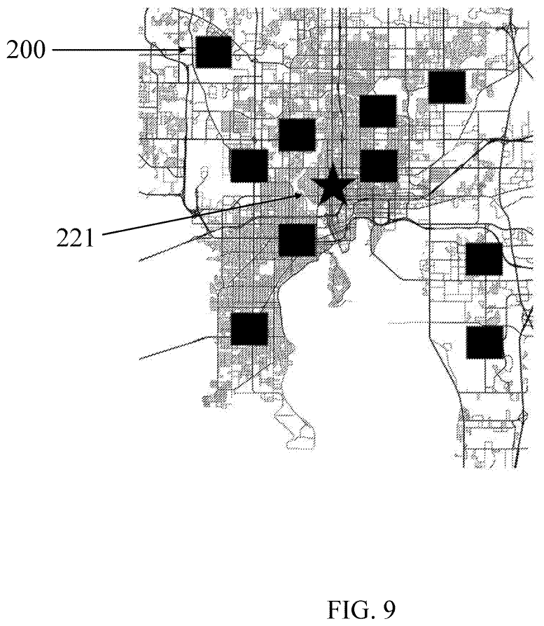

Smart community system 100 may also be connected to third party marketplaces, shipping delivery agents, or carrier databases tracking the items after they are shipped, and determining completion of delivery. Smart community system 100 may have a community deliver system whereby data processing module 525 may select a single location for a cluster of users 200, who have opted in, in a location based network based on the location and density of users 200 in a geographic area. An illustration of a cluster of users 200 is shown in FIG. 9 with the black squares illustrating the users 200 in a cluster and the selected user 221 who may receive all the goods from other users 200. For example selected user 221 may be the user who lives at a location the closet to the central average location or coordinates for a cluster of users 200 (such as 5-10 users). Users 200 may then select this location for delivery of goods or connected third party marketplaces may direct this location automatically or this location may be preselected by default whereby a user 200 may manually alter the address if needed. The selected user 221 will then receive all the delivery items and goods for other users 200 in that cluster whereby users 200 may retrieve the items from the selected user 221.

Smart community system 100 (or connected third party marketplace) in exchange for multiple users 200 having a simplified location may provide a discount to users 200 for the items or goods. Discount may be a flat rate discount on all items for users 200 in a cluster or based on but not limited to the type of items, the price of items, the location, the time of delivery. Centrally located user 200 may also receive a commission for the safe storage of items or an increased discount through smart community system 100 or connected third party marketplaces.

Once a selected user 200 has been selected by data processing module 525 and data processing module 525 determines selected user 200 is in possession of the items goods belonging to one or more of the other users 200 in the cluster, data processing module 525 may generate a single or multiple identification codes for presentation to user 200 and the centrally located user 200 to authenticate one another. The user 200 and selected user 221 may then audibly recite the code to one another whereby data processing module 525 when analyze if the proper identification code has been entered by both parties. Instead of selected user 221, another user 200 may volunteer to receive the goods of the other users. If selected user 221 is unavailable at certain times, or otherwise occupied data processing module 525 may redirect or already arrange for items to be delivered to a user 200 at the second closest location to the central average location of the cluster of users 200. This process may continue for the entirety of the users 200 in the cluster. In other embodiments all goods for users 200 may be delivered to a self-service kiosk or apparatus capable of safely storing goods, the self-service kiosk constructed or otherwise positioned at the point nearest to selected user 221 of the cluster of users that is available for smart community system 100.

The number of years and services provided through one or more service provider users 207 connected to monitoring agent user 220 may also affect the score, price, and priority in search results for a property. For example, a property that has had a monitoring agent user 220 enlisted to monitor a property by the user through smart community system 100 is likely to have less problems because of the constant supervising and thus will have an increased score compared to a property that has not had a monitoring agent user 220 providing their service. This advantageous because not only does it ensure prospective buyers a more researched and quality purchase, it also encourages growth and the system for users who are encouraged and rewarded for taking part in the system. The score may also be adjusted based on which of the bundling of services the property had bundled with the property (and for how long) and the selections of required bundled services the user makes while searching for a property. For example a user is a part of the country with a large infestation of pests, the user may seek to have a property with pest inspection bundling service. Properties that have had a monitoring agent user 220 overseeing pest inspection may have higher adjusted scores to properties that have not. A score may also be adjusted by how long monitoring agent user 220 was overseeing the pest inspection.

In some non-limiting embodiments user 200 may enlist a monitoring agent user 220 who is a real estate agent to sell one or more properties of the users 200 through smart community system 100. User 200 may deposit a predetermined amount of money in smart community system 100 whereby monitoring agent user 220 may retrieve this money if they do not sell the house for user 200 in lieu of their normal commission. This provides a reassurance for monitoring agent user 220 to help sell the property knowing they will be compensated for their time if they fail while still wanting to get the commission if they do find a buyer for the property. Users 200 who deposit money in smart community system 100 may also have their properties be prioritized in searches. A marker or indicator may also be presented to buyers who are searching for a property signifying that the seller is serious about selling the property soon. The deposited amount may be based on in how many days or over what period user 200 wishes to sell their property.

In other embodiments user 200 may pay an insurance company or utilize insurance services provided through smart community system an amount over a selected time that they wish to have the property sold. The amount user 200 needs to pay may be based on how long they think it will take to sell the property (1 month, 3 months, 12 months). Monitoring agent user 220 may place a claim with insurance company that they have acted in good faith but were unable to sell the property or user 200 backed out or was hurting the process of selling the property. Insurance company may then distribute money to monitoring agent user 220. The price that monitoring agent user 220 may retrieve for a claim or the price for insurance from user 200 may be adjusted based on past transactions between users 200 and monitoring agent users 220. For instance if a monitoring agent user 220 wasn't able to sell a property with a previous seller and it was at least partially their fault (lack of marketing, lack of proper scheduling) they may only retrieve a predetermined percentage of the claim such as 90%. Conditions may also be agreed upon by user 200 and monitoring agent user 200 to determine who is at fault such as monitoring agent user is required to have 10 scheduled appointments. The conditions and the amount related to each condition may also affect price of the monthly payment by user 200 or the amount monitoring agent 200 is able to retrieve. Another example would be if a user 200 wasn't able to sell their property with a previous monitoring agent users 220 and it was at least partially their fault they may have to pay more money monthly to receive insurance for a monitoring agent user 220.

In some embodiments an auction may be generated for monitoring agent users 220 to bid on the chance to sell a property of user 200. Smart community system 100 may create an auction site where monitoring agent users 220 can bid on the “job” of selling the property of user 200. The bids represent the amount monitoring agent users 220 are betting against if they do not sell the property that may be provided to user 200 and smart community system 100. The auction parameters may be, but do not have to be set to a predetermined time limit, bid maximum, bid minimum, geographic location of the property, geographic location of the monitoring agent users 220, or the like. In one embodiment, the auction provides to the monitoring agent users 220 the maximum bid amount. Smart community system 100 may receive bids on the job. The bidding process allows all monitoring agent users 220 that are within the predetermined auction parameters to enter at least one bid.

The auction receives bids for a predetermined amount of time, which may be, but not limited to hours, days, or weeks. Smart Community System 100 selects a winning bid based on the parameters. The winning bid is selected either by the completion of the time frame, or a bid meeting the auction parameters. The auction may stay open till the time has expired and select a winner based on the totality of the circumstances regarding each bidding monitoring agent user 220. In one embodiment, a winning bid is selected based on when the bid was placed, the highest bid, or other variables which are set by smart community system 100. In some embodiments, the winning bid is manually selected by user 200 or smart community system 100.

Monitoring agent users 220 may also provide supervisory and managerial services for user 200 as a bundled service whereby monitoring agent users 220 may exist user 200 in operation of their new property. For instance if monitoring agent users 220 are well versed in the field of gas station management to assist user 200 after purchasing a property such as a gas station.

Insurance services, typically known by those of ordinary skill in the art, may also be included directly by smart community system 100, through monitoring agent user 220, or in collaboration with an outside third party, responsible for paying for all or part of services provided by a provider to a user 200. The third party payer may receive user's 200 insurance information from smart community system 100 and provide payment and/or partial payment. Smart community system 100 may utilize one or more algorithms that are commonly not used by current insurance systems when evaluating environmental damage and risk. For example, insurance prices typically increase for homes that have been burned or are in near proximity to homes or points of interest that have been burned in a wildfire. Data processing module 525 may identify location of a home using information stored in user profile database 400 and then comparing location information with outside information from the internet, websites, social media, news uploaded to server 500 by data collection module 505. Data processing module 525 then analyses this information to see if insurance should increase or should not increase since land can no longer be burned since there aren't any trees or brush left within the proximity of the home, thus decreasing the odds of a second fire.

User 200 may also be presented through user interface 300 with uploading an insurance claim whereby user 200 may be presented with a drop down menu or by entering the insurance claim into a text box. This claim is then sent over network 600 to server 500, whereby data collection module stores claim on transaction database 420 and presents claim to insurer whereby insurer may be presented with choices to approve or reject insurance claim.

Pest inspection services may include the monitoring for various insects at locations throughout the property or surrounding area. Typically pest services are usually initiated when a person sees the accumulation of insects, mold, or other animals in a specific area of their house such as bed bugs under the mattress or termites under the floor bed. The person then calls an exterminator who comes out to eradicate the pests. Sometimes the exterminator may take a few days or a week, which can lead to serious damage to the infrastructure of the house. If user 200 wishes to be provided pest inspection services, user 200 may have a series of sensors installed on their property or activate one or more previous sensors that have been installed. Sensors are configured to monitor problems on the property that may be occurring such as but not limited to an influx of termites underneath the floorboards of the home. Sensors installed on the property may be configured to send and receive information over the network, such as satellite GPS location data, audio and video, temperature, dew point, to server 500 and stored in user profile database 400.

When data processing module 525 determines a certain action has occurred (automatically comparing information stored on user profile database 400 pertaining to the action or manually viewed by a web administrator of smart community system 100) such as when termites under the floor bed have reached a certain threshold, a handyman user 206 or service provider user 207 may automatically be dispatched to the property whereby handyman user 206, or service provider user 207 receives a notification on handyman user interface 306 or service provider user interface 307, respectively, for the location and type of services needed while customer user 208 may receive a notification through customer user interface 308 including uploaded video and audio footage of the pest situation, the dispatched service provider user 207 or handyman user 206, as well as any additional information uploaded.

Appliance services subsystem 145 may be included individually or with monitoring agent user 220, monitoring services subsystem 130 of smart community system 100, whereby users 200 may be charged a subscription fee for automatically repairing various appliances in a user's 200 home after the appliances are in need of repair, if there has been a recall on the appliance, or parts of the appliance are no longer safe to use for the user 200. In your typical home a homeowner has many different appliances such as but not limited to a refrigerator, stove, television, oven, microwave or blender. These appliances are also made by many companies such as GE®, Samsung®, or Kraftsman®.

When an appliance breaks the person either has call the manufacturer for a replacement or repair or take it to the store or distributer that the appliance was purchased from such as Best Buy®. When an appliance is recalled the person usually discovers the recall by either browsing the Internet, word of mouth, or a mailer the manufacturer sends to user's 200 home. In one or more non-limiting embodiments appliances may be replaced by any number of objects such as but not limited to a car, a boat, a toilet, a roof, or any other object known by those of ordinary skill in the art that may be in need of repair or may be in need of a recall. Smart community system 100 streamlines this process by connecting manufacturer users 211, customer users 208, and appliances 212, to provide a system for the automatic detection and resolution for these occurrences.

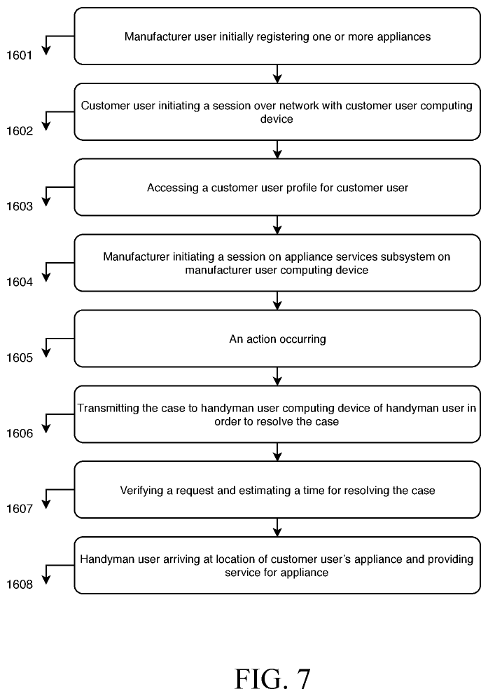

Turning to FIG. 7, FIG. 7 depicts a flow diagram showing an embodiment of an exemplary method for implementing appliance services subsystem 145 of smart community system 100. Appliance services subsystem 145 may have one or more components, such as, without limitation, customer user computing device 258 and manufacturer computing device 261. Further, one or more exemplary method steps may be performed by appliance services subsystem 145 including server 500, customer user computing device 258, manufacturer computing device 261, appliance computing device 262, and handyman computing device 256 which may be interconnected via network 600.

At step 1601, an exemplary method may include manufacturer user 211 initially registering one or more appliances 212 with appliance services subsystem 145, appliances 212 having one or more appliance computing devices 262 and configured to connect to network 600 whereby appliance computing devices 262 may transmit and receive data over network 600. Appliance computing devices 262 of appliance 212 may have one or more sensors, the sensors allowing the status of appliances 212 to be transmitted to server 500 whereby it is then collected by data collection module 505 of appliance services subsystem 145 and stored in user profile database 400 for manufacturer user 211. Appliances 212 may be preinstalled with appliance computing devices 262, retrofitted with appliance computing devices 262, or installed by any other method known by those of ordinary skill in the art.

Upon initially signing up with appliance services subsystem 145, manufacturer users 211 may be prompted to provide information along with a requested password. Information may be the hours available for contacting manufacturer user 211, manuals for appliances 212, a designated authorized handyman user 206 working with manufacturer user 211, promotional content, contact information, and corporate structure. When registering with appliance services subsystem 145, manufacture users 211 may also be able to log into appliance services subsystem 145, using login credentials from other social networking platforms, such as, for example, logging in with a Facebook® profile.

At step 1602, a method may include a customer user 208 initiating a session over network with customer user computing device 258. Session may be initially started by customer user 208 launching and running smart community application 102 on customer user computing device 258 installed by customer user 208 through a manufacturer prescribed process such as downloading smart community application 102 from an application store or smart community application 102 may be preinstalled by the manufacturer or designer. In one or more non-limiting embodiments customer users 208 may navigate to a specific web address to initiate a session.

At step 1603, the method may include accessing a customer user 208 profile for customer user 208. In one or more embodiments, customer user 208 profile may reside in user profile database 400 on server 500, which may be accessed by data processing module 525 and referenced using an identifier provided by customer user 208 as part of the registration process or login process such as an account name and password. When customer user 208 initially registers to become a registered customer user 208 of appliance services subsystem 145, customer user interface 308 may provide a first time customer user 208 the option opt into appliance services subsystem 145.

Once opted in, customer user 208 may then be presented with a screen to enter basic identifying information of customer user 208 and customer user's 208 appliances 212 such as an appliance's 212 serial number or identifying code. Information may be entered through customer user interface 308 by a pop-up menu data entry field selectable by customer user 208 on customer user computing device 258 or a pen based or finger based input using the screen of customer user computing device 258. In one or more non-limiting embodiments customer user 208 may register appliance 212 by logging into a Wi-Fi or peer to peer network emitted by appliance computing device 262 and linking appliance 212 to customer user 208

Customer user 208 may be requested to take pictures of their appliance 212 or receipts for verification purposes whereby data collection module 505 collects and stores pictures of each customer user 208 in user profile database 400 to be saved and be displayed to other users 200 through user interface 300. Customer user 208 may be presented with a screen to link customer user 208 profile for customer user 208 with a manufacturer user's 211 social networking system such as a loyalty program account. A loyalty program account may provide various points and benefits that translate to savings and other desirable incentives for a user that is part of the loyalty program account.

At step 1604, the exemplary method may include manufacturer 211 initiating a session on appliance services subsystem 145 on manufacturer user computing device 261. Session may be initially started by manufacturer user 211 launching and running smart community application 102 on manufacturer computing device 261, installed by manufacturer user 211 through a phone manufacturer prescribed process such as downloading smart community application 102 from an application store or smart community application may be preinstalled by the manufacturer or designer. In one or more non-limiting embodiments manufacturer user 211 may navigate to a specific web address to initiate a session.

At step 1605, the exemplary method may include an action occurring, the occurred action being either that one or more sensors detects an event with the customer user's 208 appliance 212 or manufacturer user 211 wishes to provide an event for one or more appliances 212. The event may be one or more parts or the overall appliance 212 breaking down or requiring an update. For this kind of event appliance computing device 262 generate a sensor data output signal that may be received by data collection module 505 of server 500 over network 600, whereby data processing module 525 may calculate the status of customer user's 208 appliance 212, then calculating the action in accordance with information from the sensor output or an action in accordance with output data compared to any information uploaded by the manufacturer user 211 or from any other outside source. For instance if a blender has broken down and the sensors detect a problem with the blender blade this information may then be sent to server 500. If the output is outside of the expected values a case is then created.

The event may also be that manufacturer user 211 has identified a problem with appliance 212 or needs to issue an update to appliance 212. For this kind of event, manufacturer user 211 may log into appliance services subsystem 145. Data processing module 525 then may access manufacturer user's 211 profile for manufacturer user 211. In one or more embodiments, the manufacturer user's 211 profile may reside in user profile database 400 on server 500, which may be accessed by data processing module 525 and referenced using an identifier provided by manufacturer user 211 as part of the registration process or login process such as an account name and password. Once an action has been identified or selected by manufacturer user 211 for one or more appliances 212, manufacturer user interface 311 allows manufacturer user 211 to select if manufacturer user 211 wishes to send an update to appliances 212 whereby update may be uploaded by manufacturer user 211 through manufacturer user interface 311 or manufacturer user 211 inputs that appliance 212 needs to be recalled or repaired, thus creating a case.

At step 1606, the method may include may include transmitting the case to handyman user computing device 256 of handyman user 206 for presentation via handyman user interface 306 to handyman user 206 in order to resolve the case. Handyman user 206 may receive a notification of an indicator whereby a user appliance 212 needs to be serviced whereby they then may confirm that they will provide service for appliance 212. Handyman user 206 may automatically receive the task that he or she needs to service appliance 212, or handyman user interface 306 may present the option for handyman user 206 to select an indicator on screen thus confirming that he or she will service appliance 212.

At step 1607, the method may include verifying a request and estimating a time for resolving the case. Handyman user interface 306 may present handyman user 206 an option to cancel the request, which is then received by data collection module 505, whereby handyman user 206 cancels the request thus sending a notification to customer user 208 and manufacturer user 211.

At step 1608, the exemplary method may include handyman user 206 arriving at location of customer user's 208 appliance 212 and providing service for appliance 212. Once servicing appliance 212, handyman user 206, may confirm through handyman user interface 306 that they have resolved the case by either repairing or replacing appliance 212. In one or more non-limiting embodiments handyman user interface 360 may also display other customer users 208 in a geographically limited area with the same appliance 212 so that handyman user 206 may service all appliances 212 at the same time. In further embodiments handyman user 206 may receive notification of cases only after a certain threshold has been met in a geographically limited area. For example if five or more blenders in a specific neighborhood have broken down or if there are seven blenders that are in need of a recall in a specific area. Further appliance services subsystem 145 may prioritize handyman user's 206 notifications based on the volume of certain appliances 212 in a geographical area. For instance a neighborhood with 7 blenders in need of repair may be prioritized over a neighborhood with 3 blenders.

In one or more non-limiting embodiments, smart community system 100 may have an emergency subsystem 150 whereby users 200 may have their well-being automatically monitored by administrator 700 or monitored by another user 200 as well as where user 200 many manually transmit an emergency signal if they are in danger or are in need of assistance. Every day people come into contact with situations which may be very dangerous for their personal safety such as taking a stroll down a city sidewalk at night, walking to their car in a parking garage after shopping, waiting for someone's help after their car breaks down, or getting lost and traveling through an unsafe neighborhood.

Sometimes people can even find danger in their home when they are on the other end of a home invasion or burglary attempt. Emergency subsystem 150 may be comprised of multiple functions such as notifying the police, call center, or emergency guardian of the user's 200 health and well-being, monitoring and safety and/or emergency situations, as well as other situations such as requesting a handyman to help provide services to a user 200 in need.

Emergency subsystem 150 of smart community system 100 may be utilized in smart community application 102 installed on user computing device 250, user computing device 250 capable of recording peripheral sound and image and location, by utilizing a connected or integrated microphone, a camera, and global positioning system. User computing device 250 then may transmit this information over network 600 to server 500 and then to other user computing devices 250. Server 500 then may transmit the recorded peripheral sound, peripheral image, and location data, to guardian computing device 263 of guardian user 213.

Emergency subsystem 150 may also interwork with any other computing devices including any number of wearable technologies such as a wristband or biometric device with one or more sensors and communication functions. Further emergency subsystem 150 may be utilized on any number of user computing devices 250 following the principle of the internet of things including a tablet, television, desktop computer, laptop computer, video game console, wearable device electronic glasses, contact lenses capable of computer-generated sensory input and displaying data, smart home device, virtual reality system, or augmented reality system, which are able to connect and send data over network 600 to server 500 and other user computing devices 250.

User computing device 250 may be customizable and features known by those of ordinary skill in the art such as location tracking by another user computing device 250 if it goes missing, microphones, speakers, and Bluetooth®. In further embodiments user computing devices 250 may be comprised of one or more led panels whereby user computing device 250 may change appearance and color based on the customization of user 200 through user interface 300. For example glasses may be used however this is non limiting and a purse, handbag, shoe, vehicle, shirt, or wallet or any other objected connected over network 600 may be used

Other devices may also be connected to smart community system 100 over network 600 such as service provider user 207 having a restaurant establishment whereby the coasters that drinks are placed or matts where food is placed on at user's 200 tables may be used to signal service provider user 207 or identify which user 200 ordered which type of food whereby it may visible to service provider user 207. Establishment may also utilize 3D holographic projectors that generate a projected image by refraction through an interference pattern while also using a spinning mirror to reflect the image to users 200 whereby they may view images such as a holographic selection menu of the goods that service provider user 207 is providing.

In other embodiments connected devices may be aligners made from molds of the users teeth whereby an impression of the teeth are initially taken of the user's teeth to make the mold. The term aligner is non-limiting and may be used interchangeably with retainer or braces. An aligner is then created based on the structure and positioning of the teeth in the mold. The aligner may be made of a transparent material and is installed on user's 200 teeth in such a way that it covers the teeth in a manner similar to that of a mouthpiece. One aligner may be designed for the upper jaw and one aligner for the lower jaw. The aligner may be constructed such that teeth in need of orthodontia can be expanded, rotated and returned whereby when a user 200 wears aligner for a predetermined amount of time whereby the teeth are forcibly and finely moved by the shape of the aligner. Multiple aligners may be used to adjust user's teeth in a series of intermediate stages to a final position. The aligner may be sent to user's 200 location based on a set plan provided by a service provider user 207 or by other information stored on user's 200 profile. The aligners may have individual motors connected to the interior walls or other points on the aligner whereby the aligners or motors may have one or more computing devices. The motors connected a floss apparatus whereby the motors may initiate movement or vibration of the floss apparatus to floss user's 200 teeth at set intervals from data stored on user's 200 profile such as specific time increments over the course of a day. In some embodiments floss apparatus may be retrofitted or otherwise connected to a preexisting aligner.

Additionally, in one or more embodiments, user computing device 250 may comprise biometric detection devices such as blood pressure monitor, heart rate monitor, body temperature sensor, pupillary response detector, hemoglobin saturation monitor, skin conductivity monitor, respiration rate monitor, brainwave activity inspector, or any other device capable of providing biometric data, whereby the biometric detection devices may send information and data acquired to determine the biostatistics of the compromised user 200.

In one or more non-limiting embodiments user 200 begins by initiating a session over network with user computing device 250. Data processing module 525 then accesses the user profile for user 200 stored on user profile database 400. Data processing module 525 then receives data pertaining to the specific location of where user 200 is located as well as any biometric data from user's 200 biometric data using one or more sensors on the biometric detective devices. Biometric data is then analyzed by data processing module 525 which may determine user's 200 state of mind and well-being based on controlled environment and expected values information which were collected by data collection module 505 from user 200 through user interface 300 such as but not limited to user's 200 height, weight, age, and any existing conditions user 200 may have, as well as data stored on server 500 from an external database or system in communication with server 500 over network 600. When the biometric data exceeds a certain trigger threshold, an alert may be sent out to cause a variety of actions on emergency service subsystem 150.

For instance the biometric detection may be a heart rate monitor sensor that can transmit heart rate information to sever 500, the heart rate information may then be displayed on user interface 300 for user 200 to view the available data on their heart rate. The heart rate sensor also can be used to indicate distress as an alert trigger such as when the heart rate exceeds a certain trigger threshold, an alert may be sent out to cause a variety of actions on emergency service subsystem 150.

In one or more non-limiting embodiments user 200 may be presented with a selectable button through user interface 300 which triggers user computing device 250 to initiate a variety of actions including automatically communicating information allowing guardian user 213, police, or call centers to receive periphery video and audio from user computing device 250 as well as the location of user computing device 250. The call center that receives the notification from user 250 may be automatically selected by data processing module 525 based on the location of user computing device 250 or chosen by user 200 through a selection menu in user interface 300. In further embodiments user 200 may initiate an alarm event audibly simply by calling out a designated or chosen word such as “pineapple” or saying another word associated with an alarm such as “I'm getting robbed”.

The action may be that the alert trigger along with the location of user 200 as well as periphery video and audio collected from user computing device 250 is then transmitted to one or more guardian user computing devices 263, call centers, or police stations which may have emergency personnel computing devices 264. As a result, user's 200 image and current location are displayed to guardian user 213 through guardian user interface 313 as well as emergency personnel user computing devices 264 through emergency personnel user interface 314. Emergency personnel user 214, which are transmitted the alert trigger may be based on the location of user computing device 250 or user 200 such as that if user 200 is traveling in Barcelona, Spain, emergency personnel users 214 located in the area may be notified instead of emergency personnel users 214 located at user's 200 normal residence.

The peripheral sound is also output to guardian user computing devices 263 and emergency personnel computing devices 264. The guardian user's 213 information such as name, contact info, and email may initially be entered by guardian user 213 through guardian user interface 313 for guardian user profile whereby guardian user 213 may confirm their relationship with user 200. In one or more non-limiting embodiments guardian user 213 may also be presented with a listen or watch mode whereby they may be provided with the location of user 200 and periphery video and audio.

In one or more non-limiting embodiments after user 200 has selected a selectable button through user interface 300 which triggers an alert, guardian user 213 or emergency personnel user 214 may be presented with the option to request to see if the user 200 is safe or still in need of assistance. For instance this may be useful in situations where user 200 accidently requested for help or is being held hostage and is under distress. User 200 then may receive the notification through email, text, audibly through a voice assistant, or any other method known by those of ordinary skill. User 200 then may accept the request whereby request is a designated passcode or color combination generated by data processing module 525 of server 500 or chosen initially by guardian user 213 or emergency personnel user 214.

User 200 may then manually recite the passcode to guardian user 213 or emergency personnel user 214. If code recited by user 200 is incorrect, guardian user 213 or emergency personnel user 214 may select a button notifying all parties that user 200 is in danger. In one or more non-limiting embodiments user interface 300 may provide user 200 with option to insert passcode. If user 200 incorrectly inserts the wrong passcode or color combination, data processing module 525 may determine the codes are not a match, whereby then guardian user 213 or emergency personnel user 214 may be sent a notification by data processing module 525 that user 200 may be in a compromised situation and is in need of assistance.

In one or more non-limiting embodiments after user 200 has selected a selectable button through user interface 300 which triggers an alert, data processing module 525 may generate a code or a code may be selected by user 200. User 200 then may receive the notification through email, text, audibly through a voice assistant, or any other method known by those of ordinary skill that a code needs to be entered. User 200 then may accept the request whereby request is a designated passcode or color combination generated by data processing module 525 of server 500 or chosen initially by guardian user 213 or emergency personnel user 214. User 200 may then enter the passcode. If code entered by user 200 is incorrect, emergency personnel user 214 may receive all information pertaining to user 200 including guardian users 213 or other interested parties and select a button notifying all parties (such as a mother or father) that user 200 is in danger. In one or more non-limiting embodiment emergency personnel user 214 may instead directly call guardian users 213 after receiving their information or a digital voice assistant A.I. known by those of ordinary skill in the art may call guardian users 213 and notify user 200 may be in danger.

In one or more non-limiting embodiments user's 200 passcode or color combination as well as any other information found on user's 200 profile may only be modified by guardian user 213 through guardian user interface 313. In further embodiments passcode or color combination may rotate every 24 hours to ensure further safety of user 200 by thwarting fraudulent attempts by an imposter who may have gained access to user computing device 250.

In one or more non-limiting embodiments, emergency personnel user 214 may request an ambulance or emergency vehicle is sent to the location of user 200 whereby the information such as the audio, video, location, and information may be received on emergency personnel interface 314. User 200, guardian user 213, and emergency personnel user 214 may be presented the location of one another to track the current position of one another as well as obtain updates regarding one another. In one or more non-limiting embodiments, all parties may be entered into a communication interface to communicate with one another.

In one or more non-limiting embodiments if a user 200 is confronted with an emergency situation, the trigger alert may be activated whereby a notification may be sent out and presented to all user computing devices 250 in a geographically located community network or confined area. To accomplish this notification, user 200 may select a selectable button through user interface 300. The notification may also be sent automatically based on the user's 200 biometric data causing a trigger alert, which will be sent to the server 500 whereby data processing module 525 generates the notification.

In one or more non-limiting embodiments the trigger alert may be used in conjunction with the handyman services subsystem 125 whereby a trigger alert may be activated either by user 200, user's 200 vehicle, or any other entity whereby a handyman user 206 is then automatically dispatched to the location of user 200. The specific handyman user 206 that is dispatched may be based on information and data for user 200 on user profile database 400 on server 500 as well preferences created by user 200 such as but not limited to automatically sending handyman users 206 that are at a certain distance from user's 200 location as well as handyman users that have been recommended by a certain number of users 200 in user's 200 community network. For example the highest rated handyman user 206 may automatically be dispatched to user's 200 location.

In one or more non-limiting embodiments handyman users 206 may be presented with information pertaining to user 200 as well as additional information concerning the emergency or trigger alert whereby handyman users 206 may confirm they wish to provide services to user 200 while in other non-limiting embodiments handyman users 206 may confirm they wish to provide services and select a price for their fees. Their price selected may count as a bid whereby user 200 will then be able to view the different bids by handyman users 206 and confirm the specific handyman user 206 they wish to use. A notification may then be sent to handyman user 206 displaying user's 200 confirmation.

In one or more non-limiting embodiments a trigger alert may be activated by user 200 by uploading an image such as a speeding ticket. A digital image of the speeding ticket as well as the location of user computing device 250, the date, and time, may be collected by data collection module 505 to user profile database 400 on server 500. User 200 may also be presented with text boxes or pull down menus through user interface 300 whereby user 200 may insert or describe additional information pertaining to the ticket and the services needed. While in one or more non-limiting embodiments server 500 may detect key words from the speeding ticket, the key words for determining who will be notified of the trigger alert.

The trigger alert may then be activated whereby a notification may be sent out and presented to all user computing devices 250 in a geographically located community network or a certain proximity to user 200 who are attorneys or are of a profession that may assist user 200 with the speeding ticket. The attorneys may be presented with information pertaining to user 200 as well as additional information whereby they may confirm they wish to provide services to user 200 while in other non-limiting embodiments attorneys may confirm they wish to provide services and select a price for their fees. Their selected price may count as a bid whereby user 200 will then be able to view the different bids by the attorneys and confirm the attorney they wish to use.

In one or more non-limiting embodiments, user computing device 250 may have switches that are responsive to the force of a user's 200 fingers whereby a user 200 may squeeze the switches, thus generating a notification. The notification may include the location, time, date, peripheral video and audio as well as a textual description based on the user's 200 profile or any added information by the guardian user 213 or emergency personnel 214.

Emergency subsystem 150 may also utilize a route guidance assistance subsystem that may be built into a navigation system in smart community system 100 or work in conjunction with a third party client navigation system such as Apple® maps, Google® maps or Waze®. User 200 may enter into user interface 300 a desired destination such as a home, place of work, restaurant, movie theater, or other locale whereby route guidance assistance system presents to user 200 a specific route to travel along based on or more maps or maps associated with a third party client. The destination and route is then stored on server 500 in user profile database 400.

If another user 200 is an emergency situation or is need of assistance and has caused a trigger alert, the trigger alert may be sent to server 500. Data processing module 525 then may determine any users 200 traveling along a route that may be able to assist the user 200 who has sent the trigger alert. Data processing module 525 then may generate a notification, that a user 200 is need of assistance along with the location of user 200, which is presented to the other user 200 on user computing device 250. For instance a user 200 may be traveling from Atlanta to Charlotte while another user 200 is stranded on the side of the interstate along the route from Atlanta to Charlotte. In one or more non-limiting embodiments users 200 may customize what type of notifications they receive, such as how far away or time delaying coming to the aid of the user 200 will be, as well as what type of services they can provide to user 200.

Emergency subsystem 150 of smart community system 100 may have a missing persons database 440 whereby users 200 may upload pictures and videos of a child, pet, elderly person, or other entities that are capable of being separated from user 200. When the pictures or videos uploaded are, for example, of children, smart community system 100 enables users 200 to actively participate in the process of locating and uniting missing children with their families as well. User 200 may initially start a session by launching smart community application 102 on user computing devices 250. In one or more other non-limiting embodiments, user 200 may initially commence a session by going to a predefined website address or domain name. In one or more other non-limiting embodiments, user computing devices 250 may have smart community application 102 already downloaded onto user computing devices 250.

User 200 may select a selectable button through user interface 300 whereby user 200 may then presented with a screen whereby user 200 may upload a picture or video of the entity to missing persons database 440 along with additional information pertaining to the entity. Additional information may include the child's first and last name, a home or other physical address including street name and name of a city and state, online contact information such as social media or gaming consoles names, a screen or user name that functions as online contact information, a telephone number, A social security number, a video, or audio file, where such file contains a child's image or voice. User interface 300 may allow user 200 to upload images or videos to missing persons database 440 directly from camera on user computing device 250 or photo library stored on user computer device 250 using methods known by those of ordinary skill in the art.

Once the picture or video has been uploaded to missing persons database 440, the picture will be categorized by data categorization module 515 by location and date the picture or video was captured or uploaded by user 200. The pictures or videos may be protected by a private key generated by data processing module 525 or created by user 200 through a text entry box whereby only user 200 may access pictures or videos of the entity or other users 200 that have been given access to the private key by user 200. In one or more non-limiting embodiments private key may be transmitted to proper authorities when user 200 selects a button that the entity has gone missing. In other non-limiting embodiments user interface 300 may present a toggle switch whereby the entity has gone missing, user 200 may toggle the switch from private to public whereby pictures and videos of entity will be viewable and searchable through user interface 300 to other users 200.

In one or more non-limiting embodiments smart community system 100 may have utilize facial recognition software known by those of ordinary skill in the art whereby users 200 may initiate a session by launching smart community application 102 on user computing devices 250 then capturing an image of an entity such as a child they have discovered who looks lost and lonely on the street. The image then is transmitted and collected by data collection module 505 of server 500 and stored in missing persons database 440 whereby data processing module 525 compares the photos of street children captured by users 200 to those of lost entities that are public or shared by a user 200 and present in missing persons database 440. If a match is found by data processing module 525, the user 200 who is searching for the entity and the proper authorities may be sent a notification by data processing module 525 whereby data processing module 525 may transmit the image or video captured so user 200 or proper authorities may be presented with the picture or video captured to view if that is indeed the missing entity.

In one or more non-limiting embodiments, smart community system 100 may have an appointment booking subsystem 155 whereby multiple customer users 208 may book appointments for one or more service provider users 207 on a master calendar where the updates to the schedule are shown to all parties in real time to provide a seamless booking system for customer users 208 and service provider user 207 in all businesses areas. When running a business such as a hair salon, a lot of time is devoted to scheduling appointments with clients as well as keeping track of their specific needs and preferences. This may lead to countless hours arranging meetings on the phone or through email. Sometimes a receptionist or administrator is hired just for this purpose.

For a business such as a hair salon this may be extra strenuous because the individual hair stylists operate as independent contractors for a business and clients can be very picky, requiring their hair be a certain way or needing specific products for their hair. Appointment booking subsystem 155 in smart community system 100 provides customer users 208 with a way to book appointments with a service provider user 207 or individual employees or independent contractors working for service provider user 207 as well as provide a way for service provider users 207 to identify the needs of customer users 208 before they even step through the door.

Customer user 208 may initiate a session over network with customer user computing device 258. Session may be initially started by customer user 208 launching and running smart community application on customer user computing device 258 installed by customer user 208 through a manufacturer prescribed process such as downloading smart community application 102 from an application store or smart community application 102 may be preinstalled by the manufacturer or designer. Data processing module 525 then may access a user profile for customer user 208. User profile may reside in user profile database 400 on server 500, which may be accessed by data processing module 525 and referenced using an identifier provided by customer user 208 as part of the registration process or login process such as an account name and password.

When customer user 208 initially registers to become a registered customer user 208, customer user interface 308 may provide a first time customer user 208 the option to enter basic identifying information including name, email address, home address, phone number, age, sex, hair color, hair style, hair length, available time during the week, allergies, hair treatment, and other preferences. Information may be entered through user interface 300 by a pop-up menu data entry field selectable by customer user 208 on customer user computing device 258 or pen based or finger based input using the screen of customer user computing device 258.

Customer user 208 may be requested to take pictures of themselves whereby data collection module 505 collects and stores pictures of each customer user 208 in user profile database 400. Customer user 208 may couple, link, or connect with user accounts from social networking websites and internal networks. Examples of social networking websites include but are not limited to Instagram®, Facebook®, LinkedIn®, Snapchat®, and Twitter®. Data processing module 525 may use access tokens or other method as a parameter for searching for a friend list or address book of customer user 208 on a social networking site or other site. Further, customer user interface 308 may include status selections for indicating if customer user 208 is associated with a certain status, such as a VIP member of one or more service provider users 207 for promotional purposes.

After initiating a session, customer user interface 308 may provide customer user 208 with ability to search and select a service provider user 207. When registering or operating as a service provider user 207, a service provider user 207 may be prompted for a variety of information, such as name, contact information, as well as additional rules for customer user's 208 appointments. The rules can be manually entered through a text interface or selected using a series of drop down menus. Rules may be but are not limited to maximum number of customer users 208 visits per a selected amount of time, the duration of specific services provided such as 1 hour for hair coloring, the amount of time in advance that service provider user 207 requires the customer user 208 to book an appointment, a start date to begin scheduling with the appointment booking subsystem 155, the days, type, and times in which service provider user 207 is available to meet with customer users 208, specific employees working for service provider user 207, time already booked for clients by outside sources such as a family friend who simply called service provider user 207. Appointment booking subsystem 155 also allows customer user 208 to enter information after selecting a specific service provider user 207, whereby the data pertaining to service provider user 207 is stored on the user profile database 400 for customer user 208 for later use by both customer user 208 and service provider user 207.

After selecting a service provider user 207, customer user interface 308 may present customer user 208 with a calendar interface whereby by clicking on a time slot icon on the calendar, customer user 208 may be presented with any information relevant to the appointment. Customer user 208 then may insert information including his or her preferred type of service and any special requirements and select a confirmation button. A scheduled appointment is subsequently created on the calendar that is viewable by service provider users 207 and other customer users 208. Customer user interface 308 may also provide customer user 208 with ability to view all confirmed appointments in customer user's 208 history whereby customer user 208 may view appointments for recording purposes or cancel previously booked appointments. In one or more non-limiting embodiments other customer users 208 may only see through customer user interface 308 that the time slot has been taken by another customer user 208 and not the specific customer user 208 that has taken the time slot.

The calendar for service provider user 207 may also be sorted and filtered based on a customer user's 208 preference. For example, the calendar can be sorted to display the available time slots of only one hair stylist as well as the appointments of all hair stylists. The calendar may also be filtered to display only the available times for a specific type of hair treatment the user wishes to have. The calendar may also be filtered by data processing module 525 based on information or preferences stored on customer user's 208 profile in user profile database. Customer user 208 and service provider user 207 may receive notification sent by server 500 that an appointment has been booked for the confirmed time slot.

Service provider user 207 may initiate a session and view information pertaining to each customer user 208 that has booked an appointment to facilitate friendliness as well as to provide proper care and maintenance specifically tailored to customer user's 208 need. Service provider user 207 may also input additional information through service provider user interface 307 pertaining to customer user 208 whereby the information may be viewable to all parties or only service provider user 207.

The scheduled appointment may be automatically monitored by appointment booking subsystem 155 whereby customer user 208 may receive notifications through smart community system, email, or text, reminding customer user 208 of the booked appointment. If customer user 208 has patronized service provider user 207 previously, the appointment booking subsystem 155 may send notifications to customer user 208 based on customer user's 208 preferences from customer user's 208 profile stored on user profile database 400. For instance if customer user 208 has input information pertaining that they require a hair treatment bi-weekly, appointment booking subsystem 155 may automatically notify customer user 208 of upcoming available time slots and in one or more non-limiting embodiments book a future appointment if customer user 208 has allowed automatically scheduling as a preference.

In one or more other non-limiting embodiments service provider user 207 may have a series of sensors installed on their property or activate one or more previous sensors that have been installed. Sensors are configured to transmit data to data processing module 525 which may identify customer users 208 who have entered service provider user's 207 place of business so as to match the sensor output data with any customer user's 208 profile picture using any existing technology known by those of ordinary skill in the art. Sensor data from the one or more sensors may be configured to send and receive information over network 600, such as satellite GPS location data, audio and video, temperature, dew point, to server 500.

Information and preferences pertaining to the matching customer user 208 may then be displayed automatically on service provider user interface 307 so service provider user 207 may quickly identify the specific needs of customer user 208 for the appointment. Sensors also may be used to capture pictures of customer users 208 entering and exiting the place of business and stored on user profile database 400 of server 500. This may be useful in such circumstances where a customer user 208 wishes to have the same haircut as last time. The hair stylists may then have access to the picture of customer user 208 from their last visit so the stylist may know exactly the way customer user 208 wants their hair style. In some embodiments these pictures or pictures uploaded by customer user 208 of themselves may be presented to users 200, whereby service provider users 207 or users 200 may provide ratings, feedback, or additional pertaining to image of customer user 208. For instance if customer user 208 uploads a picture of their new haircut, service provider users 207 may provide their feedback if they think the haircut was a good choice and what they could do differently.

Data processing module 525 may send promotions to user 200 when user 200 is at a specific location or area. When a user 200 is within a predetermined distance of an establishment, or within the establishment, of a service provider user 207, an automated advertisement procedure may be initiated, and as part of that process user 200 may be “checked in” into that location if they are located at the establishment whereby the “check in” may be stored on user profile database 400. An automatic advertisement from user 200 may also be transmitted to user computing device 260 for presentation on user interface 300 to user 200. Advertisement may be in the form of offers such as discounts, or other incentives presented to user 200 through user interface 300. In some non-limiting embodiments, automatic advertisements may be sent to other devices such as a vehicle traveling alone a route on one or more screens connected to vehicle. For example this would be useful for service provider users 207 that want to reach out to customers with promotions by displaying them on the back of the front head sets in a ride-sharing vehicle while the customer is in the area. Drivers or owners using ride-sharing may receive extra compensation for allowing promotional content in their vehicle.

In one or more non-limiting embodiments metrics may be utilized by data processing module 525 using data from user profile database 400 to only present advertisements to users 200 such as but not limited to users 200 who have not visited the establishment of service provider user 207 before (a user with zero “check-ins”), users 200 of a certain demographic such as age or profession, or users 200 that belong to a specific geographically located community network. In one or more non-limiting embodiments a user 200 may manually check in into an establishment by methods known to those of ordinary skill in the art.

Smart community system 100 may have a shared space management subsystem 160, which provides shared workspace management and utilization, which increases the usage and operating efficiency of each service provider located in the workspace to minimize the amount of overhead, cost, and employees required by shared space monitoring. Shared space management subsystem 160 may use the workplace space information to efficiently manage space in a workplace. Conventional space monitoring systems for tracking attendance, monitoring class progress, payment processing, and operational monitoring suffer from a number of drawbacks including that they are tedious, time-consuming, and subject to human error which may lead to lost or misfiled data entries. Workplace may include any number of buildings, floors, rooms, facility areas, or an area of any size or type, including locations outdoors or sections that are remote from one another. Workplace may also be defined by their type, category, or corporate level. Workplace is used as one example however this is non-limiting and workplace may be replaced by a classroom, clubroom, or similar area.

Workplaces as well as classes and other activities may initially be registered by service provider user 207 for the purpose that customer users 208 may be able search for service provider user 207 and the bookings they provide. Upon initially registering a class on smart community system 100, service provider user 207 may select an industry their class is associated with, as well as the location, time, and schedule, as well as any additional information such as a service provider profile, sub-industry, curriculum vitae, ranking system and progression calendar, instructional videos, maximum occupants, insurance details, registration, licenses, referrals, testimonials, and payment information for when customer users 208 are sending payment for the services provided by service provider user 207.

For example, service provider user 207 may be a judo instructor whereby the judo instructor may enter information regarding how many classes a customer user 208 needs to attend to progress to the next belt level that may be presented to customer user 208 when viewing class page on smart community system 100. In another example the judo instructor may upload videos or images featuring a step-by-step tutorial for mastering one or more specific moves that may be presented to customer user 208 when viewing class of judo instructor on smart community system 100. Judo instructor is merely used as a non-limiting example whereby service provider user 207 may be any type of instructor or provider such as for dance, football, or cooking.

Videos may also be accessed by codes such as a QR code given by instructor or placed on promotional flyers or in the workplace, that may be scanned by customer user computing device 258 whereby customer user 200 may be directed to the class page and view the instructional video. Service provider user interface 307 may present service provider user 207 with a class on/off selectable button such that when availability is on, service provider user's 207 class or classes will be active, while when availability is off the class is not active and customer users 208 may not sign up for the class.

Data processing module 525 is configured to be able to access service provider user 207 and customer user 208 identification information from user profile database 400, class schedules, and additional information or data so that it can track attendance in each class. Data processing module 525 may also be able to track attendance in groups of classes, such as all classes at shared space residential club room, or all classes funded by a specific user 200. Data processing module 525 may track and report attendance by any unit of time, such as by class period or by day, month, or year.

Workplace may have a series of sensors configured to monitor as customers 208 enter the shared space or individual room in the shared space. Sensors installed at the workplace may be configured to send and receive sensor data over the network 600, such as satellite GPS location data, audio and video, temperature, dew point, to server 500 and stored in user profile database 400 of service provider user 207 or any other user 200 connected to the workplace as well as administrator 700. Typically, the sensors may be permanently mounted near the entrance of the workplace or individual room, such as above or on the sides of the entrance door.

Sensors may be of a design to have the ability to identify multiple customer users 208 who are entering the workplace. Sensors may have facial recognition software known by those of ordinary skill in the art for identifying customer users 200 by comparing customer users 200 pictures stored in user profile database 400 of server 500. Sensors may also utilize Radio Frequency Identification whereby customer users 208 are in possession of an (RFID) tag that are scannable by sensors in the form of RFID scanners that may track when customer users 208 enter or exit the workplace. In other non-limiting embodiments customer users 208 may wear one or more identification devices that are worn by the person, or carried on the object or asset, which then may be detected by sensors installed in the workplace. In some embodiments sensors may monitor when customer users 208 enter and leave their workplace or room so as to charge customer users 208 in a similar fashion to vehicle occupant user's 201 vehicle in a parking zone.

Sensors may monitor customer users 208 entering and leaving the workplace whom have already been identified present for a class period so as to prevent customer users 200 from walking into a class and walking out of the class moments later. Sensors may monitor or control workplace utility functions such as temperature control, security functions, fire alarms in addition to monitoring customer users 208.

Once sensor data is transmitted to server 500 and stored in user profile database, data processing module 525 may generate an attendance report that may be transmitted to service provider user computing device 257. Service provider user interface 307 may display the attendance report to service provider user 207. To access the attendance report, service provider user 207 may initiate a session over network with service provider user computing device 257. Service provider user 207 may visually inspect the attendance report as well as the physical space of the workplace to determine if the attendance report is accurate. Navigating through service provider user interface 307, service provider user 207 may view attendance reports for each individual customer user 208. Service provider user 207 may also be presented with payment information for each individual customer user 208 such as to see which customer user 208 has paid for their classes, who's payment is still pending, and who hasn't paid. Customer user 208 may also be categorized, filtered, or ranked by user categorization module 510 and data categorization module 515 depending on punctual payment, attendance, or any other factors.

Customer user interface 308 may then display data on attendance report related to customer user 208 to customer user 208. To access information concerning customer user's 208 attendance report, customer user 208 may initiate a session over network with customer user computing device 258. When initially registering, customer user 208 may be requested to take pictures of themselves whereby data collection module 505 collects and stores pictures of each user 200 in user profile database 400. After initiating a session, customer user interface 308 may provide customer user 208 with ability to search and select a service provider user 207, a class, or a workplace, as well as add service provider user 207, class, or workplace, to their current classes or activities.

When selecting a current activity, customer user interface 308 may view their attendance record and data related to customer user 208 such as how many more classes customer user 208 is required of to reach the next ranking or videos service provider user 207 has selected for customer user 208 to view to assist them in gaining skills for the class. Customer user interface 308 may also present one or more menus or calendars allowing a customer user 208 to book, reserve or schedule a class or workplace, for a desired period of time in a similar fashion to those discussed in appointment booking subsystem 155. A customer user 208 may be provided with one or more menus to select data relating to booking the workplace or class such as which space should be booked, a time of day for which the space should be booked, and in case of a workplace, which company user 200 works for or what service the workspace may be used. By selecting a use or company customer user interface 308 may display which spaces are available are suitable for that type of company or use.

Customer user 208 may also be presented with options to filter criteria such as company; type of workplace, time, and date, to view presently scheduled bookings or future bookings. Customer user interface 308 may also present customer user 208 payment processing selections whereby customer user 208 may input their credit card or debit card information for a credit card or debit card using any card known in the art, including, without limitation an ATM card, a VISA®, MasterCard®, Discover®, or American Express® card in a credit card input field, or can alternatively use PayPal® or the like. Customer user 208 may also withdraw funds from their social account for the necessary funds to pay service provider user 207 or reserve a workplace. Customer user 208 may also be presented with option through customer user interface 308 to request another user 200, such as a parent, legal guardian, or employer to pay for the class or workplace.

In one or more non-limiting embodiments shared space management subsystem 160 may display real-time or historical occupancy data as well as real time payment processing or history payment processing of the workplace to one or more users 200 such as administrator 700 who may either own or provides management of workplace. This may be useful for companies who hire workers to work remotely but don't have the necessary capital to monitor them so they may utilize one administrator 700 of smart community system 100 to monitor activities of their workers. Administrator 700 may also monitor multiple companies at once in a single workplace or multiple workplaces. This may also be useful for users 200 who have provided funding for multiple service provider users 207 or who are running multiple classes and wish to see which ones are the most profitable and are progressing in gainful way. An exemplary embodiment provides an administrator 700 with accurate space utilization and monetization data so that the administrator 700 may make a performance measurement that can lead to improved analysis and specifications for the workplace.

Space and monetization utilization may be presented to administrator 700 in the form of utilization grid and reports that provides a percentage of time the space is occupied by service provider user 207 and the occupancy percentage of customer users 208 as well as the ratio of money generated to the time the space is occupied as well as any additional costs or expenses. The data collected about space and monetization utilization in one or more non-limiting embodiments may be anonymous in that the actual identity of persons in any one space could remain unknown for certain services where discreteness is required or may be detailed to administrator 700.

Blockchain may also be utilized for hierarchal company funding structures of currency flow to one or more workplaces or service provider users 207 whereby administrator 700 or other users 200 who have provided funding may monitor how their money is being allocated as well as relevant information pertaining to the businesses or structure user 200 has funded directly or through a fund manager or third party broker. In a pooled (collective) investment, one or more persons put their money into a fund whereby they may be partners, a corporation, or other identity and share in the profits generated by service provider users 207 in the shared space or in general. The funds may be invested in shares or other assets in the companies they are funding whereby they are providing capital to the businesses or other entities for a percentage of the profits. The blockchain of smart community system 100 allows users 200 to view not only where their funds have been allocated but also monitor the businesses they have invested in.

In one or more other non-limiting embodiments independent contractor users and other employee users 216 may be able to search for various jobs or tasks in their location and book shifts that have been posted by employer users 215 in a similar fashion.

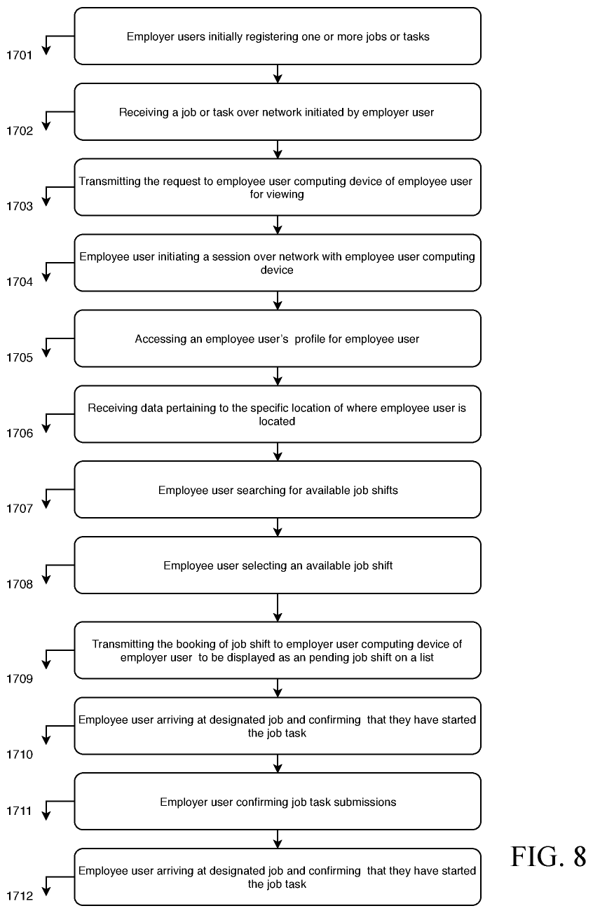

Turning to FIG. 8, FIG. 8 depicts a flow diagram showing an embodiment of an exemplary method for implementing the employee booking subsystem 165 for temporary employees user 216 of smart community system 100. Employee booking subsystem 165 may have one or more components, such as, without limitation, employee user computing device 265 and employer user computing device 266. Further, one or more exemplary method steps may be performed by smart community system 100 including server 500, employee user computing device 266, employer user computing device 265, which may be interconnected via network 600.

At step 1701, a method may include employer users 215 initially registering one or more jobs or tasks, associated with employee booking subsystem 165, such that the jobs or tasks may be available to employee users 215 to search for the job and book a shift to work at said job. Upon initially signing up with employee booking subsystem 165, employer users 215 may select an industry their available jobs are associated with and the location the job will be located at as well as any additional information such as a company profile and payment information for sending payment. When registering with smart community application 102, employer users 215 may be able to log into smart community application 102 using login credentials from other platforms such as their work enterprise application. Employer users 215 may navigate through employee booking subsystem 165 through an employer user interface 315 whereby they may be presented with a dashboard where they may see summaries of their activities as well as their posted shifts, bookings, timesheet, current employees and time shifts.

Employer user interface 315 may present employer user 215 with options to post a new shift, view posted shifts and view pending future bookings, whereby when employer user 215 selects a shift, employer users 215 may be presented with additional details pertaining to the shift that has been selected and a method to enter additional information. Employer user interface 315 may provide information and options for employer users 215 to input relevant information associated with shift including further job details such as equipment needed. Information pertaining to shifts may be entered through employer user interface 315 by a pop-up menu data entry field or pull down menu. Employer user 215 may also modify or delete a shift posted by employer user 215. Employer user 215 may also be presented with interested employee users 216 that are available to work in the area whereby employer user 215 select an employee user 216 from a list presented on employer user interface 315

At step 1702, the method may include data collection module 505 of server 500 receiving a job or task over network 600 initiated by employer user 215 on employer user interface 315. The job or task may indicate the employer user 215 sending the request

At step 1703, the method may include may include transmitting the request to employee user computing device 256 of employee user 216 via employee user interface 316 to employee user 216 for viewing. Employee user 216 may also receive notifications of jobs or tasks meeting certain criteria based on information analyzed by data processing module 525 from employee user's 216 profile stored on user profile database 400. In one or more non-limiting embodiments employee user 216 may automatically receive the job or task if they have opted in to settings on employee booking subsystem 165 allowing the employee booking subsystem 165 to automatically hire the employee users 216 for job shifts.

At step 1704, a method may include employee user 216 initiating a session over network with employee user computing device 266. Session may be initially started by employee user 216 launching and employee booking subsystem 165 on employee user computing device 266 installed by employee user 216 through a manufacturer prescribed process such as downloading smart community application 102 from an application store or smart community application 102 may be preinstalled by the manufacturer or designer. In one or more non-limiting embodiments employee user 216 may navigate to a specific web address to initiate a session.

At step 1705, the method may include accessing an employee user's 216 profile for employee user 216. In one or more embodiments, employee user's 216 profile may reside in user profile database 400 on server 500, which may be accessed by data processing module 525 and referenced using an identifier provided by employee user 216 as part of the registration process or login process such as an account name and password. When employee user 216 initially registers to become a registered employee user 216 of employee booking subsystem 165, employee user interface 316 may provide a first time employee user 216 the option to enter basic identifying information of employee user 216 such as industry and sub industry, curriculum vitae, insurance details, registration, licenses, referrals, testimonials, and payment information for receiving payment. This information may be verified independently by administrator 700 for smart community system 100.

At step 1706, the exemplary method may include data collection module 505 receiving data pertaining to the specific location of where employee user 216 is located. Data processing module 525 may send a data request to employee user computing device 266, displayed through employee user interface 316, for identifying a geographic location of employee user computing device 266 or a network location of employee user computing device 266, as well as a timestamp identifying when the request was transmitted to employee user computing device 266. The geographic location may be any physical location, which may be expressed in longitudinal and latitudinal coordinates, and may include other dimensions and factors such as altitude or height for determining an exact position of the geographic location.

At step 1707, the exemplary method may include employee user 216 searching for available job shifts. Employee user interface 316 may display a list of available jobs shifts for a certain time period, such as a day, on a graphical map. The graphical map may be displayed to employee user 216 with the job shifts displayed as markers, pins, or identifiers at their respective locations of the job. Job shifts may also be displayed on employee user interface 316 as a list or a drop-down menu with booked shifts of the day. In case there are no shifts for the time period the map may show available shifts outside of their radius that employee user 216 can book. Employee user interface 316 may present employee user 216 with availability on/off selectable button. When availability is on, employee user 216 is available to work jobs and tasks and may receive notifications. When availability is off, employee user 216 will not receive new-posted shifts.

At step 1708, the exemplary method may include employee user 216 selecting an available job shift. Once confirmed by employee user 216, the indicator for the job or task may change color or have another effect activate whereby more information may be provided about the job or task. In one or more non-limiting embodiments after selecting an available job shift, employee user 216 instead of automatically being selected for the job may instead be inserted into a bidding process whereby employer user interface 315 may present to employer user 215 a list of potential employee users 216 listing in working the job shift. Employer user 215 may then select a specific employee user 216, whereby server 500 may notify employee user 216 they have been selected for the job shift.

At step 1709, the method may include may include transmitting the booking of job shift to employer user computing device 265 of employer user 215 for presentation via employer user interface 316 to be displayed as a pending job shift on a list. Employer user 215 may view the bookings and booking details as well as cancel a job shift booking. Employer user 215 will also be able to view all the cancelled shifts and employee inserted reasons for cancelation.

At step 1710, the exemplary method may include employee user 216 arriving at designated job and confirming through employee user interface 316 that they have started the job task. In one or more non-limiting embodiments data processing module 525 may identify the location of employee user 216 to confirm they are at the location of the job shift. Once the location has been confirmed by data processing module 525 a timer will be activated whereby the job shift may be timed. Employee user 216 may pause the timer in case they want to take a break. Once the shift is completed employee user 216 may select a complete button whereby data collection module 505 may receive the job shift and present the job shift to employer user 215 via employer user interface 315. The job shift may also be presented to employee user 216 as a completed task available for employee user 216 to view on a timesheet page. Timesheet may display pending tasks, completed tasks, and disputed tasks.

At step 1711, the exemplary method may include employer user 215 confirming job task submissions. Start time and end time of employee user's 216 job shift may be transmitted to server 500 whereby server 500 may present the start time and end time to employer user 215 via employer interface 315. Employer user 215 may view this information and confirm that job shift has been completed. Employer user 215 may disagree with what has been submitted by employee user 216 and instead of approving the shift they may modify the shift or reject the shift. Employee user 216 may accept the modifications or reject the modification. If employee user 216 rejects the modifications the shift administrator 700 may view the dispute, any information added by the employer user 215 and employee user 216, as well as contact them through a communication interface on employee booking subsystem 165. Once administrator 700 has made their decision and resolved the conflict a notification may be sent to employer user 215 and employee user 216.

At step 1712, the exemplary method may include employer user 215 paying for services rendered by employee user 216 for job shift. Data processing module 525 may generate an invoice that is sent to employee user 216 and employer user 215 whereby employer user 215 may be presented with option to pay employee user 216. Data processing module 525 may then process the appropriate payment whereby the transaction is completed and payment is transferred from employer user 215 to employee user 216. The transaction may also be stored in transaction database 420 of server 500. In some non-limiting embodiments payment may be transferred to employee user 216 at different times or increments. Employee user 216 may then receive notifications for being paid for shifts. In one or more non-limiting embodiments a fee or commission may be deducted from the amount employer user 215 pays for the job shift or an additional amount added on top the of the payment by the employer user 215. Alternative transaction terms may also be determined in smart community application 100 whereby a certain amount may be added or a fee may be assessed if employer user 215 or employee user 216 cancels the job shift within a certain time of the job shift.

Though employers and independent contractors are used in the aforementioned example, any job, partnership, agreement, covenant, or understanding may be used. In one or more other non-limiting embodiments data processing module 525 may identify the location of employer user 215 whereby employer user 215 may post a job listing or shift through employer user interface 315 in a new location. This may be beneficial if employer user 215 is currently in a new location for a temporary period of time and needs assistance from an independent contractor or employee user 216. For example a doctor may need to visit a patient to perform surgery in another state from which the doctor normally resides. Since it is a complicated procedure the doctor may require a medical assistant, another doctor with specialized expertise in the field, or a registered nurse to assist in the surgery. Using employee booking subsystem 165, doctor may post a job that may be presented for viewing by independent contractor users and other employee users 216.

In one or more non-limiting embodiments, smart community system may have a medical assistance subsystem 170 whereby doctor users 217 may upload analysis and recommended prescriptions to medical assistance subsystem 170 and have them transmitted to lab users 218 and patient users 219. Lab users 218 may then upload their report and send it back to the doctor user 217 who may then discuss the results with patient user 219. Patient user 219 also has the added advantage of confirming which lab user 218 they wish to use, which can be financial, beneficial, as well as more curtailed to their individual needs. Patient user 219 may also select where they can receive additional work or treatment from other doctor users 217, hospitals, or treatment centers that have analyzed the diagnosis of the patient and determined a total cost for patient user 219 including treatment as well as additional factors such as travel and lodging.

Medical assistance subsystem 170 may have one or more components, such as, without limitation, doctor computing device 267, lab user computing device 268, and patient user computing device 269. Further, one or more exemplary method steps may be performed by medical assistance subsystem 170 including server 500, doctor user computing device 267, lab user computing device 268, and patient user computing device 269, which may be interconnected via network 600.

Doctor user 217 may initially register for medical assistance subsystem 170, associated with smart community system 100, such that the doctor user 217 may upload and transmit their analysis and reports on one or more patient users 219. Medical assistance subsystem 170 may verify the doctor user's 217 number by the doctor user interface 317 presenting a text box whereby the doctor user 217 enters their number, thus sending the number to server 500. The server then transmits a code through email or text whereby the doctor user 217 then inserts the code and data processing module 525 verifies this is the correct code. Upon initially signing up with smart community application 100, doctor user 217 may select a qualification, specialty, super specialty, and registration number, as well as upload any documents. This information may be stored on user profile database 400 on server 500. This information may be verified by administrator 700 before the doctor user 217 is able to use medical assistance subsystem 170.

When registering with medical assistance subsystem 170, doctor user 217 may be able to log into smart community application 102 using login credentials from other platforms such as their work enterprise application. Doctor users 217 may navigate through smart community application 102 through a doctor user interface 317 whereby they may be presented with a dashboard where they may see summaries of their activities as well as their posted analysis, results, lab users 218, and patient users 219. Doctor user interface 317 may present doctor user 217 with a selectable button to add a new patient user 219 whereby the doctor user 217 may add patient user's 219 name, number, email, country, state, district, town, area, and pin code. Once doctor user 217 has inserted a new patient user 219, doctor user 217 may be presented with a list of existing patients as well as search for a specific patient user 219 using a search window.

Doctor user interface 317 may present doctor user 217 with selectable button whereby once selected doctor user 217 may transmit important instructions for patient users 219 who are scheduled for a visit or treatment with doctor user 217. This removes the call that needs to be made to patient user 219 before their visit as well as provides a recorded copy for them. The instructions may be for example, medications, patient user 219 should stop taking before the visit, when they should be stopped, and when they can resume taking them after visit. Instructions may also include dietary, rest requirements, or any other instructions sent to patient user 219 before a visit to doctor user 217. In one or more non-limiting embodiments, instructions may be sent by doctor user 217 through a text to speech feature or voice assistant whereby the instructions may be translated into speech and then into a language understandable to patient user 219 by any method known by those of ordinary skill in the art, and played to patient user 219 through medical assistance subsystem 170 or through audio input of patient user computing device 269.

After selecting a patient user 219, doctor user 217 may be presented with options to refer a patient to a lab user 218 or another doctor user 217 more tailored for patient user's 219 needs. Doctor user interface 317 may provide doctor user 217 with ability to upload advice about the patient as well as a prescription. Advice or prescription may be inserted by doctor user 217 into doctor user interface 317 by a text input box, or the doctor user 217 may upload the files. If doctor user 217 needs to send a physical object or sample to any of the parties, doctor user 217 may deliver it to the parties in a similar method to the ones discussed above using smart community system.

Doctor user 217 may also input the analysis or prescriptions into medical assistance subsystem 170 by using a capacitive touch screen, whereby doctor user 217 writes with their finger, altering the properties of the charged screen in that spot, registering where the device was touched. A stylus made of a conductive wire or other material configured to transmit an electrical field necessary to register the contact may also be used instead of the doctor user's 217 finger. Doctor user 217 may also input prescription into medical assistance subsystem 170 by using a resistive touch screen, having two conductive layers layered inside the surface of the screen.

When doctor user 217 presses down on the resistive touch screen, the two layers come in contact, completing a circuit and sending a signal of where the device was touched. Smart community system 100 may then analyze where the device has been touched to determine the text input of the doctor user 217 by any method known by those of ordinary skill in the art to insert the text into the doctor user interface 317. In other non-limiting embodiments doctor user 217 may also capture images or video of the analysis or prescription using smart glasses which are a head-mounted display designed in the shape of a pair of eyeglasses or any other user computing device 250 as followed by the philosophy of the “internet of things”

Patient user's 219 number may be verified once inserted by doctor user 217 to see if patient user 219 has an existing profile on medical assistance subsystem 170 of medical services subsystem 170. Doctor user interface 317 may present doctor user 217 with a general test clickable button. When selecting the button, doctor user 217 may be shown a plurality of tests they may be recommended for patient user 219 which are selectable through doctor user interface 317. Doctor user 217 may also be presented with favorite tests, which are comprised of tests the doctor user 217 has already selected in the past, has frequently selected at a certain rate, or has selected through doctor user interface 317 on a preference screen whereby the doctor user 217 may manually select their favorite tests. This is useful in cases where multiple patient users 219 may need the same type of test done because the entire area has the same symptoms. In one or more non-limiting embodiments medical assistance subsystem 170 may automatically favorite tests based on the location of doctor user computing device 257 by comparing to other doctor users 217 within a certain threshold of the doctor user 217.

When selecting the selectable button doctor user 217 may be presented with a list of lab users 218 that are a part of medical assistance subsystem 170 and have been entered in user profile database 400. Lab users 218 may be presented according to the patient's user 219 zip code. The zip code also may be the area that the doctor user 217 is currently in or a zip code that is more suitable for patient user 219 such as if patient user 219 and doctor user 217 are outside of their normal geographical location. Data processing module 525 may also determine the location of doctor user's computing device 257 to determine the zip code doctor user 217 is in. Doctor user 217 may then select one or more lab users 218 from the list of the available lab users 218. In one or more non-limiting embodiments once doctor user 217 has selected one or more lab users 218, lab users 218 may be presented to the patient user computing device 259 whereby patient user 219 may select a lab user 218 they wish to use based numerous criteria such as but not limited to the listed price of the tests, if the patient's insurance will offset the cost, or reputation.

Once a lab user 218 has been chosen, advice reference code and prescription reference code may be generated by data processing module 525, which then may be sent for presentation by email, text, or patient interface to patient computing device 269. Doctor user 217 may view status of individual patient users 219 and their reports through doctor user interface 317 and after selecting a patient user 219 may be presented with a calendar scheduler whereby doctor user 217 may book a follow up appointment with patient user 219. Patient user 219 may also book an appointment in a similar fashion to the appointment booking subsystem 155.

Doctor user 217 may select the available times they are available and how many patient users 219 doctor user 217 is able to handle in a specific time period. For instance doctor user 217 may set their available time on Wednesday for 7:00 am to 10:30 am in the morning with a maximum patient capacity of six for every 30 minute period. In this example six patient users 219 would be able to book an appointment in the 7:30-8:00 am period. Medical assistance subsystem 170 may arrange patient users 219 in the time period by priority or other factors such as ranking, how many appointments booked in the past, or the necessity of the appointment.

Lab users 218 may initially register on medical assistance subsystem 170, associated with smart community application 100, such that lab users 218 may upload and transmit their test analysis after being referred by a doctor user 217 back to doctor user 217 or one or more patients. Data processing module 525 may verify lab user's 218 phone number by lab user interface 318 presenting a text box whereby the lab user 218 enters their number, thus sending the phone number to server 500. Server 500 then transmits a code through email or text whereby lab user 218 then inserts the code and data processing module 525 verifies this is the correct code. Upon initially signing up with medical services subsystem 170, lab user 218 may select a specialty, super specialty, and registration number, and location of lab, as well as upload any documents. This information may be stored on a user profile database 400 on server 500. Medical assistance subsystem 170 may also determine the location of lab user's computing device 268 to determine the zip code or other type of geographical region lab user 218 is in. This information may be verified by administrator 700 before the lab user 217 is able to use smart community application 100.

Once lab user 218 is registered and has initiated a session whereby data processing module 525 receives data pertaining to lab user 218 from the user profile database 400, lab user 218 then may be presented with selectable options such as referred patient users 219, new patient users 219, complete report, pending reports, and test price list. When selecting the new patient users 219 clickable button, lab user 218 may be presented with a text window to insert the advice code lab user 218 received through text or email. Once entered advice code will be transmitted to server 500 and verified by data processing module 525 to see if the code entered matches the generated code.

Successfully entering the advice code presents lab user 218 with details about patient users 219 including their name, phone number as well as the doctor user 217 who referred them and the doctor user's 217 phone number. Lab user 218 may also be presented with a selectable confirm button, whereby data processing module 525 will not acknowledge patient user 219 has been accepted by lab user 218 until the lab user 218 has selected the confirm button. Once a patient user 219 has been accepted, patient user 219 will appear when lab user 218 has selected the referred patient user 219 button. Lab user 218 may then select patient user 219 and view the test submitted by doctor user 217 that needs to be conducted as well as selectable buttons to upload reports, view the current uploads, and update status of the testing.

After selecting upload report, lab user 218 may upload a report as well as identify what the report is detailing along with any additional information. Lab user 218 may then be presented with the option to send the report to the referring doctor user 217. Selecting this option may send the report to server 500 whereby data collection module 505 stores the report in user profile database 400 for lab user 218 as well as notifies the referring doctor user 217 by email, text, or another method that report has been transmitted to server and available for presentation on doctor user computing device 257 after doctor user 217 initiates session. Though a lab user 218 is described it may be foreseen that a doctor user 217 may send the analysis to another hospital, medical center, or another doctor user 217 in a similar fashion and medical assistance subsystem 170 may have various other utilities.

For example a pharmacy may be used in place of a lab user 218 whereby the pharmacy may be sent a prescription by doctor user 217 concerning a patient user 219. Pharmacy may confirm patient user 219 then select patient user 219 from a list and view the prescription submitted by referring doctor user 217 that need to be prescribed to patient user 219. Pharmacy may also be presented selectable buttons to view the current prescriptions for other patient users 219.

After selecting a patient user 217, pharmacy may confirm a prescription as well as identify what the prescription is for along with any additional information. Pharmacy may then be presented with the option to send the receipt to the referring doctor user 217. Selecting this option may send the receipt to server 500 whereby data collection module 505 stores the report in user profile database 400 for pharmacy and patient user 217 as well as notifies the referring doctor user 217 by email, text, or another method that prescription receipt has been transmitted to server 500 and available for presentation on doctor user computing device 257 after doctor user 217 initiates session.

In one or more non-limiting embodiments pharmacy may deliver prescription to patient user 219 using any of the methods discussed above or select a button through user interface 300 that they wish to store medicine related to prescription in an automated vending machine, the automated vending machine connected so smart community system 100 over network 600. To access automated vending machine, patient user 219 is transmitted a code, the code generated by server 500 and viewable through patient user interface 319, whereby when patient user 219 inserts code into automated vending machine, automated vending machine may distribute medicine related to prescription to patient user 219.

In one or more non-limiting embodiments server 500 may have a medical assistance database 430 with a collection of diagnosis information, medical analysis, test results, pharmaceutical use information, as well as other data either provided by other doctor users 217 or collected in other ways from third party medical assistance databases which server 500 may communicate with. Doctor users 217 may search through the database manually or doctor users 217 may insert patient user's 219 information through doctor user interface 317 including medical history, vitals and information, medication currently taken, medication taken in the past, complaints, and other presently occurring symptoms. Server 500 may include a list of support findings that corresponded to medical diagnoses. Once a patient user's 219 information has been entered by a doctor user 217, data processing module 525 may match a support finding that corresponds to patient user's 217 diagnosis whereby a detail report may be generated and may be displayed to doctor user 217 through doctor user interface 317.

Analysis provided by doctor users 217, stored in medical assistance database 430 may receive referral commission for assisting others doctor users 217 to request their services. Analysis by doctor users 271 may be promoted, recommended, referred and/or offered by a referring doctor user 217 or another party. In one or more non-limiting embodiments a doctor user 217 may post a question asking for assistance from another doctor user 217 whereby a doctor user 217 who does assist may receive credits, awards, or digital currency in smart community system 100.

Medical assistance database 430 may also include a list of associated medicines whereby associated medicines may be generated when doctor searches for a specific medicine by entering the medicine in a text window or selecting the medicine from a pull down menu in doctor user interface 317. An associated medicine is a medicine that is the same or similar to a medicine in dosage form, safety, strength, route of administration, quality, and performance characteristics. For example associated medicine may be a generic version medicine that works in the same way and provides the same clinical benefit as its brand-name version.

In one or more non-limiting embodiments medical assistance subsystem 170 may have a medical tourist service that permits users 200 to request different types of medical procedures or treatments through medical assistance subsystem 170. When building an itinerary for a medical procedure, users can also receive reservations from several other travel provider systems such as hotels and transportation. A user (which may be a patient user 219, or an intermediary for patient user 219, such as a guardian) may reserve or purchase a variety of medical services by accessing the medical tourism service, which in turn communicates with third parties that offer additional services (e.g., hotel rentals, car rentals, flights, travel insurance, etc.) as well as service providers that have uploaded their own personal services for medical procedures into smart community system 100.

For example a patient user 219 may logon to medical assistance subsystem 170 through smart community application and request for a treatment such as to remove their tonsils. Patient user 219 may be presented with filtering options through patient user interface 319 such as distance the medical service provider is located from patient user computing device 269 or those that accept a certain type of insurance. The request is then transmitted to server 500. Server 500 may communicate with medical service providers or third parties to access the third parties' systems through public application program interfaces (APIs) over network 600 or another suitable network, such as the Internet, and receive total pricing for their services.

The pricing of each medical service provider then may be transmitted to patient user 219. For example there may be a service provider in Brazil, one in a state different from patient user 219 such as Kansas, and one in the state of patient user 219. Based on patient user's 219 user profile and location, the prices may be presented to patient user 219. The price may include room, board, accommodations, and travel, as well factor in other items to determine how much it would cost the patient if patient user 219 decided to receive services from that hospital. This information may be presented collectively or individually to patient user 219.

Once selecting a medical service provider and the price displayed patient user interface 319 may then display to patient user 219 the final summary for the medical services, the estimated price information including subtotal, the individual prices for services, discounts and taxes, along with promotional coupon and gift card text entry fields, gratuity or tipping text entry fields, mode of payment drop down menus or text entry fields, and a calculated total including subtotal combined with taxes discounts and gratuity added. Patient user 219 may input their credit card or debit card information for a credit card or debit card using any card known in the art, including, without limitation an ATM card, a VISA®, MasterCard®, Discover®, or American Express® card in a credit card input field, or can alternatively use PayPal® or the like. Patient user 219 may also withdraw from their social account for the necessary funds.

In one or more non-limiting embodiments patient user 219 may also select a medical service provider and their price whereby a communication interface may be displayed to patient user 219 and medical service provider so they may discuss the arrangements or patient user 219 may be presented with appointment booking interface 155 for the flight, lodging, and actual treatment.

Data collection module 505 may store medical procedure and travel information associated with each patient user 219 in user profile database 400. For example, a patient user's 219 medical treatment, flights, car rentals, travel insurance, and hotel reservations may be recorded in user profile database 400 in a user profile associated with user 200 and stored in the user profile database. If a patient user's 219 medical itinerary is canceled, sever 500 may initiate communication with a third party to cancel or modify the other services that are dependent upon the patient user's 219 medical treatment. For example, if a patient user's 219 procedure is cancelled due to illness of doctor, data processing module 525 may initiate a cancellation request for the patient user's 219 travel services. If a medical itinerary is cancelled by medical service provider, an alert requesting a next action may be transmitted to patient user 219. Patient user 219 may then determine whether to reschedule, change, or cancel any associated travel services.

Medical assistance subsystem 170 may also provide patient users 219 with subscription based medical services that gives users 200 a way to pay for better care incrementally through smart community system 100. Using this method of payment patient users 219 will not be charged for each service a doctor performs, as they are in traditional practices. Instead patient users 219 may select options including a set time fee such as a monthly, quarterly or annual fee in exchange for a wide assortment of enhanced services through all medical service providers in smart community system 100 or a select group of medical service providers such as an individual hospital. Services may include unlimited office visits; emergency visits, same-day or next day appointments, personalized service, pre-operation, post operation, and, greater access to their doctor.

Patient users 219 may also select subscriptions for their entire family such as a husband and their two kids. Patients may also be presented with subscriptions that are specifically tailored to children or the elderly. In other non-limiting embodiments the subscription may be replaced by an allocation based system whereby patient user 219 is given a specific amount of visits treatments on a virtual punch card on medical assistance subsystem 170 that may be used at any given time. When a patient user 219 requests a visit, qualifying service, or treatment the medical service provider will “punch” out one visits on the virtual punch card. A patient user 219 may replenish the amount of visits when the punch spots have been filled. The subscription based service or allocation service is not limited just to the medicine field with doctors and hospitals providing treatment or other medical services but also labs and pharmacies. They may also be utilized with any service provider that provides goods or services such as an attorney or masseuse.

Medical assistance subsystem 170 may also provide patient users 219 with subscription based medical services that allows users 200 to register for a subscription to reduce or eliminate the need to pay co-pay to an insurance company when paying for medical services whereby user 200 only needs to a pay monthly fee instead. The subscriptions are for various periods of time, for example, one month, one year, or a lifetime. User 200 may book an appointment or treatment through user interface 300 on user computing device 250. At this point, user 200 has no funds. When user 200 is at the hospital or other location of appointment or treatment and checks in data processing module confirms the location of user 200 as well as verifying that user is at the correct hospital at the correct time for the treatment or appointment and the person checking in is indeed user 200. In some embodiments, the location is verified using the global positioning system (GPS) capabilities of user computing device 250. Once user 200 location is verified as being the location of the selected appointment or treating, data processing module 525 may place funds on user's 200 account to pay for the required co-pay. In other embodiments user's location may not need to verified for data processing module 525 to place funds on user's account.

In further embodiments the same principle may be applied to other aspects such as the legal industry or accounting industry whereby instead of co-pay user 200 may receive free consultations from attorneys and accounting or other service providers who are currently a part of smart community system 100 in exchange for user 200 paying a certain subscription fee.

Smart community system 100 may utilize aspects of the parking management subsystem 105 and delivery subsystem 110 in conjunction with medical assistance subsystem 170 for the picking up, and transporting of any person to a service provider or for bringing a service provider to a user 200 such as a doctor user 217 providing services directly to patient user 219 at their current location. Patient user 219 begins by initiating a session over network 600 with patient user computing device 269. Data processing module 525 then accesses the user profile stored on user profile database 400 for patient user 219. Data processing module 525 then receives data pertaining to the specific location of where patient user 219 or entity such as a family member is located. Patient user 219 then enters any additional information such as what type of medical services they require and what kind of condition they are in.

Server 500 then receives the request over network 600 initiated by patient user 219 and server 500 then transmits the request to doctor user computing devices 267 of doctor users 217 for presentation via doctor user interface 417. Doctor user 217 may receive a notification of an indicator where a patient user 219 needs to be assisted as well as additional information pertaining to the kind of treatment or help patient user 219 requires. In one or more non-limiting embodiments a doctor user 217 may automatically receive the task that he or she needs to assist patient user 219 at the location of the indication. Doctor user interface 319 may provide the option for multiple doctor users 217 to select an indicator on screen on of doctor user interface 317 thus confirming that he or she will provide treatment to patient user 219 at the location of the indicator. In one or more non-limiting embodiments, after confirming they will provide treatment to a patient user 219, driving or walking instructions to patient user 219 up may be provided through doctor user interface 317.

Smart community system 100 may also have various other documents in contract database 435 that users 200 such as a collection of legal documents such as but not limited to: a bill of sale, affidavits, guardianship forms, letters of recommendations, non-disclosure agreements, resignations, release of liability, non-compete clauses, invoice, purchase order, employee contract, job application, lease agreement, contract for deed, eviction notice, rental application, and tax forms. Using user interface 300 the legal documents may be compiled automatically by information gather from user profile databases 400 or information entered by user 200. This provides an effective and intuitive automation of legal documents without user 200 having extensive knowledge of the law as well as quickly creates suitable legal documents between users 200.

Smart community system 100 provides a new and unique way for users to interact with other users as well as the surrounding area. Smart community system 100 is designed assist users 200 with security, emergencies, monitoring, good and services, real estate services, medical purposes, as well as any other number of areas to improve their overall quality of life.

While the present description has included many specific details with respect to smart community system 100 and a method of using the system for various purposes, those of ordinary skill in the art can appreciate that this system may be used for numerous other applications other than the subsystems listed. For example how smart community system 100 may be utilized for pets and pet owner users 200. When a pet owner initially registers to become a pet owner user of smart community application, pet owner user may be prompted to provide some information through user interface concerning one or more pets they own or are otherwise taking care of or associated with, such as their name, DNA, breed, age (e.g., birth date), gender, dietary restrictions, contact information, interests, and skills.

Pets may receive medical assistance through smart community system in a similar fashion to medical assistance subsystem whereby veterinarian users may upload analysis, prescription, recommendation or the DNA and have them transmitted to lab users and pet owner users. Lab users may then upload their reports and send it back to the veterinarian user who may then discuss the results with pet owner user. Pet owner user may also search for medical services and be presented with veterinarian users, hospitals, or treatment centers that have analyzed the service needed and determined a total cost for pet owner for medical services.

Pet owner users may search for and request any service provider users providing goods and services, such as dog grooming or training. Pet owner users may then utilize appointment booking whereby they may book appointments for one or more service provider users on a master calendar where the updates to the schedule are shown to all parties in real time. Pets may have a computing device connected over network whereby pet owner user may track the location of pet, the location viewable on a graphical map that may be displayed to patient owner whereby the pet may be displayed as markers, pins, or identifiers at their location. In some embodiments pet owner users may upload pictures of their pets of themselves, which then may be transmitted for display to service provider users, whereby service provider may provide ratings, feedback, or additional pertaining to image of the pet. For instance if pet owner user uploads a picture of their pets new hair style, service provider users may provide their feedback if they think the haircut was a good choice and what they could do differently as well as bid to provide services

Pet owners users may join location based networks or other associations and may also communicate through the communication interface of smart community system where they may discuss topics such as shared recipes. Smart community system may provide pet insurance in a similar fashion to medical insurance where a pet owner user may select options including a set time fee such as a monthly, quarterly or annual fee in exchange for a wide assortment of enhanced services through one or more veterinarian services or may utilize an allocation based system whereby pet owner users are given a certain amount of visits to treat their pet. Pet owner users may offer their services to other pet owner users such as if a pet owner user purchases or makes a bulk amount of food they may provide these goods to other pet owner users in the community network or anywhere, thus eliminating the need for multiple trips to the pet store or wasted food.

In a similar fashion to parking services, service providers may offer pet hotel or pet storage locations having a certain amount of designated areas for pets to occupy. The areas may one or more sensors that send sensor data output signals. Data processing module of server may determine from sensor data output signal if an individual area is occupied by a pet as well as how many available unoccupied areas are present which then may be indicated as available for another pet. Data processing module of server also generate a map of the pet storage location, with area availability overlaid on the map for indicating physical location information for each area that may be available to pet storage employee to quickly locate pet or area. Once data processing module determines a pet is no longer occupying an area, the pet owner of the pet may be billed, and the area may show as available.

It is foreseeable that the system and method for smart community system 100, according to one or more embodiments, described in the present description may be beneficial and helpful when applying any type of transaction, communication, or service between one or more users 200. It is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the use contemplated.

1. A smart community system comprising:
one or more databases coupled via a network;
one or more processors coupled to the one or more databases; and
at least one computing device coupled to the one or more processors and the one or more databases via the network;
wherein the one or more processors are configured to:
store a plurality of selectable components, each of the selectable components having one or more associated entities defining attributes of the selectable components and one or more values associated with the one or more entities and the selectable components;
display to a user a first set of potentially selectable components through a user interface;
receive one or more individual selections of the potentially selectable components from the first set by the user to include in a coverage plan associated with said user;
calculate a value of the coverage plan from the one or more values associated with the selectable components selected by the user;
calculate a price of the one or more entities with the coverage plan from the one or more associated values; and
present a coverage policy to the user based on the one or more entities and the coverage plan.

2. The smart community system of claim 1, the selectable components comprising: service provider services, appliances services, real estate services, monitoring services, pest services, and legal services.

3. The smart community system of claim 1, the one or more processors are further configured to:
associate the selectable components with one or more monitoring agents, the one or more monitoring agents assigned to monitor the one or more entities based on the coverage plan selected by the user; and
generate a contract between the one or more monitoring agents and the user, the contract populated with data based on the coverage plan selected by the user.

4. The smart community system of claim 3, the one or more processors are further configured to:
associate one or more service providers with the one or more monitoring agents to provide services to the user based on the coverage plan of the user; and
generate a hierarchical payment system between the one or more service providers with the one or more monitoring agents to provide services based on individual subtasks provided by the one or more service providers for a specific task for the coverage plan of the user; and
transmit a commission to the one or more monitoring agents for the combined income generated from the individual subtasks.

5. The smart community system of claim 4, wherein the processors are further configured to:
generating a rating system for the one or more monitoring agents to provide a rating for the one or more service providers associated with the one or more monitoring agents, the rating presented to the user when selecting the one or more service providers for a service request for the user.

6. The smart community system of claim 5, wherein the one or more processors are further configured to:
generate a private marketplace with a first channel, the first channel supporting the one or more service providers associated with the one or more monitoring agents wherein there are preexisting established guarantees between the one or more monitoring agents and the one or more service providers; and
present the one or more service providers associated with the one or more monitoring agents to the user.

7. The smart community system of claim 6, wherein the one or more processors are further configured to:
generate a second channel in the private marketplace, the second channel associated with one or more users who do not have a coverage plan, the second channel supporting one or more general service providers and soliciting bids of any of the one or more general service providers with a predetermined maximum distance of the one or more users who do not have a coverage plan.

8. The smart community system of claim 6: wherein the private marketplace follows a protocol for communication between the supply-side and demand-side platforms for matching bid requests and bid responses on the first channel in order to connect the one or more users with a subset of the one or more service providers for a service request.

9. The smart community system of claim 4, wherein the processors are further configured to:
receive information pertaining to a service request of the user inputted by the one or more service providers associated with the one or more monitoring agents, the one or more service providers providing service to the user in response to the service request;
present received information to one or more other service providers associated with the one or more monitoring agents, the one or more other service providers providing service to the user in relation to the service request; and
generate a points based system, wherein a point is associated with the account of a first service provider in response to a transmission from a second service provider in response to information provided to the second service provider from the first service responder for the facilitation of services.

10. The smart community system of claim 6, wherein the processors are further configured to:
generate identification codes to the user and the one or more service providers selected for rendering service to the user; the identification code generated for the one or more service providers only when the one or more service providers have been selected to provide service to the user, the identification code for the user unchangeable unless manually altered through email by the user or a request for modification has been received from one or more designated guardians selected by the user;
authenticate the identification codes inputted by the user and the one or more service providers; and
present confirmation that the identification codes have been verified to the user and the one or more service providers.

11. The smart community system of claim 10, wherein the processors are further configured to:
integrate the identification codes of the one or more service providers and the user into a third party platform utilized by the one or more service providers.

12. The smart community system of claim 4, wherein the processors are further configured to:
generate a backing payment system, the backing payment system supporting one or more backers wherein there are established guarantees between the one or more service providers and the one or more backers, the one or more backers receiving commission for providing access to a geographic location where the one or more service providers operate.

13. The smart community system of claim 4, wherein the processors are further configured to:
create a cluster of one or more entities of one or more users based on the location of the one or more entities of the one or more users, wherein the one or more entities are properties;
direct goods delivered by the one or more service providers of the one or more users in the cluster to a single entity, the single entity within a predetermined distance of the other one or more entities in the cluster, and
reduce the price of the goods delivered by the one or more service providers for the one or more users in the cluster.

14. The smart community system of claim 13, wherein the location of the single entity receiving the goods is determined by being the entity in the cluster closest to the average coordinates of the one or more entities of the one or more users in the cluster.

15. The smart community system of claim 1, wherein the processors are further configured to:
retrieve data for the specific geographic area, the data comprising a plurality of entries each for the one or more entities located in the specific geographic area that are listed for sale each entry indicating the price for the one or more entities, and values for each of a plurality of attributes, wherein the one or more entities are properties;
receive attributes of a plurality of entities in the specific geographic area;
generate a score for the specific geographic area at least in part by the values for each of the plurality of attributes;
adjust score if the one or more entities had a previous owner purchase a coverage plan through the smart community system with the one or more entities; and
present determined score for the specific entity in the geographic area to the user for comparison with a determined score of other entities in the geographic area.

16. The smart community system of claim 15, wherein the processors are further configured to:
adjust the score if the one or more entities previously had a coverage plan with a selectable component pertaining to an attribute the user has used in their search criteria.

17. The smart community system of claim 15, wherein the attributes include a commute score based on the estimated time to the work of the user based on traffic, child safety factor, the child safety factored determined by if the amount of vehicles passing over a point within a predetermined distance to the one or more properties passes a predetermined amount, the accommodations for religion, the direction windows of the real estate face, the distance from a retention pond, and the distance from one or more service providers associated with one or more monitoring agents, the one or more monitoring agents associated with the selectable components of the coverage plan of the user.

18. The smart community system of claim 6, wherein the processors are further configured to:
receive, at least one communication indicating a first user as having referred a second user to a service provider of the one or more service providers;
establish a referral commission for the referring second user to the service provider; and
transmit the referral commission to the first user.

19. The smart community system of claim 18, wherein the processors are further configured to:
detect that a specific emergency situation has occurred in relation to the second user;
determine if a service provider who has been recommended by the first user provides services for the specific emergency situation in relation to the second user and is within a predetermined distance of the second user; and
transmit communication to the second user related to a service provider who has been recommended by the first user and does provide services for the specific emergency situation, and is within a predetermined distance of the second user.

20. The smart community system of claim 1, wherein the processors are further configured to:
receive via the user interface, a picture or video of a monitoring area of the one or more entities from the user;
verify, in response to the request from the user, that a monitoring agent is within the predetermined maximum allowable distance to be traveled by the monitoring agent providing services; if the monitoring agent is verified to be within the maximum allowable distance to be traveled by the monitoring agent for providing; present monitoring agent to user; if monitoring agent is not verified to be within maximum allowable distance to be traveled by the monitoring agent for providing the one or more services; add a monitoring restriction, wherein the monitoring restriction prohibits the monitoring agent from being presented to user;
present a user interface to a first user on a computing device, wherein the user interface comprises at least one list of available monitoring agents, for the one or more areas;
receive a request from the first user to accept a monitoring agent; in response to request from the first user;
calculate an acceptable price values for characteristics of user based on data for existing customers in similar users, and set the fixed price and predetermined coverages and coverage limits for the monitoring agents based on said data, the characteristics selected from a combination of two or more of: monitoring location classification, monitoring location size, monitoring location cost;
use the received request, including the time period and one more services to transfer information causing a monitoring contract to be created;
collect monitoring data, including a time period of the monitoring, a type of service of the monitoring, and price of service of the monitoring;
store the monitoring data; and
transfer income to the monitoring agent for service provided.
